(19) United States
(12) Patent Application Publication
(10) Pub. No.: US 2023/0198860 A1
(43) Pub. Date: Jun. 22, 2023

(54) SYSTEMS AND METHODS FOR THE TEMPORAL MONITORING AND VISUALIZATION OF NETWORK HEALTH OF DIRECT INTERCONNECT NETWORKS

(71) Applicant: Rockport Networks Inc., Ottawa (CA)

(72) Inventors: Ian BOTHWELL, Vanier (CA); Huiwen HONG, Ottawa (CA); Creighton KIRKENDALL, Maineville, OH (US); Eric LANDRY, Gatineau (CA); Frederic POULIN, Gatineau (CA); Eric SOUTAR, Ottawa (CA); James THIBAUDEAU, Ottawa (CA)

(21) Appl. No.: 17/928,748

(22) PCT Filed: Jan. 28, 2022
(86) PCT No.: PCT/IB2022/000030

§ 371 Date: Nov. 30, 2022

Related U.S. Application Data
(60) Provisional application No. 63/142,668, filed on Jan. 28, 2021.

(51) Int. Cl. H04L 41/22; H04L 41/12; H04L 43/045; H04L 43/10

(52) U.S. Cl. CPC H04L 41/22; H04L 41/12; H04L 43/045; H04L 43/10

(57) ABSTRACT

The invention provides a method for the temporal monitoring and visualization of the health of a direct interconnect network wherein discovered and configured nodes provide node telemetry data from each node or every port on each node at time interval, and the node telemetry data is stored in a temporal datastore at each time interval with a timestamp for a retention period, such that the temporal datastore contains a temporal history of node telemetry data from each node or every port on each node during the retention period. The node telemetry data is analyzed, alarms are raised as necessary, a health status commensurate with the severity of the node telemetry data is assigned and stored for each node or every port on each node, and a health score is calculated for such nodes and ports based on the assigned health status for use by a user interface. The user interface provides various novel visual representations of the health of nodes and ports based on the calculated health score, and this visual representation may display node and port health for any specific time during the retention period as desired.

### FIELD OF THE INVENTION

The present invention relates to network monitoring. More particularly, the present invention relates to the temporal monitoring and display of the health of computer networks, specifically direct interconnect networks. Direct interconnect networks replace centralized switch architectures with a distributed, high-performance network where the switching function is realized within each device endpoint, whereby the directly connected nodes become the network. The switchless environment presents unique challenges with respect to node discovery, monitoring, health status considerations, and troubleshooting.

### BACKGROUND OF THE INVENTION

Network management involves the administration and management of computer networks, including overseeing issues such as fault analysis and quality of service. Network monitoring is the sub or related process of overseeing or surveilling the health of a computer network and may involve measuring traffic or being alerted to network bottlenecks (network traffic management), monitoring slow or failing nodes, links or components (network tomography), performing route analytics, and the like.

In the current state of network monitoring, network elements are generally tapped or polled by network monitoring applications to collect streamed telemetry (i.e. data from the network, e.g. datasets coming from Ethernet switches), and event data (e.g. outages, failed servers), and to send alarms when necessary (e.g. via SMS, email, etc.) to the sysadmin or automatic failover systems for the repair of any problems. Alternatively, network devices may push network statistics to network management stations, syslog engines, flow collectors, and the like. Regardless, the network monitoring applications then correlate the collected data to the network systems that they affect, and these applications may then display or visualize, in various ways, the current state of the networked elements/devices in isolation or in relation to the connected network. Such visualizations can range from simple navigable lists of issues that need to be addressed to full network topological visualizations showing impacted network systems styled in a manner to highlight the derived state of the system.

Network monitoring systems are thus invaluable to network administrators for allowing them to oversee and manage complex networked systems. Indeed, by having real-time or near real-time ability to inspect the status of a network, in part or as a whole, network administrators can quickly address issues in order to allow them to deliver on service level agreements and system functional requirements.

Traditional network monitoring systems, however, are weak or fail in numerous respects. For one, traditional network monitoring systems are unable to represent the state of network elements, and the entire network topology, temporally (i.e. they are generally only able to operate in the temporal state of “now” in real-time or near real-time). In this respect, because most issues in networking are actually temporal in nature (in that they can vary over time as conditions change), the ability to inspect the network at a given point in time would be key to early triaging and better addressing issues as they occur (or better yet at an early stage of occurrence). Even better would be the ability to inspect and visualize the network at a given point in time as a first-class operation. Indeed, being able to visualize and understand how network health evolves and changes over time in response to various circumstances would provide network administrators and programmers with key insights into how they could increase the performance and health of network elements over time. Traditional network monitoring systems also do not focus on “worst offender” network elements (provide comparative criticality) in an easy to identify manner, nor do they provide useful visualizations that convey the temporal health and other key attributes of nodes and their elements (e.g. node ports).

The present invention seeks to overcome at least some of the above-mentioned shortcomings of traditional network monitoring systems.

### SUMMARY OF THE INVENTION

In one embodiment, the present invention provides a method for the temporal monitoring and visualization of the health of a direct interconnect network comprising the steps of: (i) discovering and configuring nodes interconnected in the direct interconnect network; (ii) determining network topology of the nodes and maintaining and updating a topology database as necessary; (iii) receiving node telemetry data from each of the nodes or every port on each of the nodes at a time interval and storing said node telemetry data in association with a timestamp in a temporal datastore; (iv) raising an alarm if applicable against at least one node or at least one port of said at least one node if any such node telemetry data in respect of the at least one node or the at least one port of said at least one node crosses a node metrics threshold or if there is a change to the network topology in respect of the at least one node or the at least one port of said at least one node during the time interval; (v) assigning an individual health status to each of the nodes or every port on each of the nodes, wherein such health status is commensurate with any alarm raised against the at least one node or the at least one port of said at least one node during the time interval and storing or updating said individual health status for each of the nodes or every port on each of the nodes in association with the timestamp in the temporal datastore; (vi) displaying on a graphical user interface a visual representation of the health of the direct interconnect network for the time interval, said visual representation including, a color representation of nodes or every port on such nodes to reflect the health status of such nodes or ports and to convey a health condition to a network administrator, and wherein such nodes or ports are further scaled in size relative to the health condition to allow for easy identification of nodes that are in a poor health condition and that require attention by the network administrator; (vii) repeating steps (i) to (vi) for further time intervals, and allowing the network administrator to display the visual representation of the health of the direct interconnect network for any time interval in the temporal database.

The step of receiving and storing node telemetry data from each of the nodes or every port on each of the nodes may further comprise preprocessing and aggregating the node telemetry data, and storing said preprocessed and aggregated node telemetry data in association with the timestamp in the temporal datastore.

The step of assigning an individual health status to each of the nodes or every port on each of the nodes may further comprise calculating a health score for each of the nodes or every port on each of the nodes based on the assigned individual health status for the time interval and storing such health score with the timestamp in the temporal database, and wherein the step of displaying a color representation of nodes or every port on such nodes instead reflects the health score of such nodes or ports.

In another embodiment, the present invention provides a method for the temporal monitoring and visualization of the health of a direct interconnect network comprising: discovering and configuring each node in a plurality of nodes interconnected in the direct interconnect network; determining network topology of the plurality of nodes comprising link information to neighbor nodes for each node in the plurality of nodes; querying status information of each node in the plurality of nodes at a first time interval, and storing and updating the status information of each node in the plurality of nodes in a database at each first time interval; receiving node telemetry data from each node or every port on each node in the plurality of nodes at a second time interval, and storing the node telemetry data for each node or every port on each node in a temporal datastore at each second time interval with a timestamp for a retention period, such that the temporal datastore contains a temporal history of node telemetry data from each node or every port on each node during the retention period; analyzing the node telemetry data received from each node or every port on each node in the plurality of nodes and assigning a health status commensurate with the severity of the node telemetry data as analyzed for each node or every port on each node in the plurality of nodes; calculating a health score for each node or every port on each node based on the assigned health status for each node or every port on each node in the plurality of nodes; displaying a visual representation of the health of at least one node or every port on the at least one node in the plurality of nodes on a user interface based on the calculated health score for the at least one node or every port on the at least one node in the plurality of nodes, said visual representation depicting a health state of the at least one node or every port on the at least one node in the plurality of nodes at a specific time during the retention period.

The link information for each node in the plurality of nodes may be maintained and updated in the database such that the database contains only up to date link information, and wherein the link information is also stored with a timestamp in the temporal datastore such that the temporal datastore contains a temporal history of recorded changes to such link information for the retention period.

The first and second time interval may be user configurable and they may be the same value. Storing and updating the status information in the database at each first time interval may comprise updating the database in accordance with any changes to the status information such that the database contains only up to date status information for each node in the plurality of nodes.

Receiving node telemetry data may comprise receiving node telemetry data from a message bus. The node telemetry data received from each node or every port on each node in the plurality of nodes may also be pre-processed, aggregated, and stored in the temporal datastore at each second time interval with the timestamp for the retention period. The node telemetry data may also be published on a message bus so the visual representation can be updated in near real-time.

Analyzing the node telemetry data may comprise raising an alarm if the node telemetry data from at least one node or a port on the at least one node in the plurality of nodes crosses a node metrics threshold, there is a node event, or there is a change to the network topology during the second time interval.

Assigning a health status may comprise assigning a health status commensurate with the severity of any alarm raised against at least one node or a port on the at least one node during the second time interval, and storing such health status in the temporal database.

Calculating a health score may comprise mapping the health status to a numerical value, wherein the larger the numerical value the worse the health of the at least one node or port on the at least one node.

Displaying a visual representation of the health of at least one node or every port on the at least one node in the plurality of nodes on a user interface may comprise including a color representation of the at least one node or every port on the at least one node to convey a health condition to a network administrator.

Displaying a visual representation may further comprise scaling the at least one node or every port on the at least one node in size relative to the health condition to allow for easy identification of nodes that are in a poor health condition and that require attention by the network administrator.

Moreover, displaying a visual representation may further comprise including visual links between nodes to represent node connections and the network topology based on the link information to neighbor nodes.

In yet another embodiment, the present invention provides a method for examining the current and historical health of a switchless direct interconnect network, the method comprising: (a) receiving raw node telemetry data at a time interval from each node in a plurality of nodes in the direct interconnect network, wherein the raw node telemetry data is received into a messaging bus; (b) processing the messaging bus, wherein processing the messaging bus comprises: (i) accumulating raw node telemetry data into accumulated node telemetry data, (ii) preprocessing the accumulated node telemetry data into preprocessed node telemetry data, (iii) aggregating the preprocessed node telemetry data into aggregate node telemetry data, and (iv) storing the aggregate node telemetry data into a temporal database; (c) deriving a health status for each node or every port on each node for each time interval, wherein the health status is based at least in part on the stored aggregate node telemetry data; (d) storing the derived health status for each node or every port on each node for each time interval in the temporal database; and (e) upon request, providing one or both of the aggregate node telemetry data and the derived health status of a particular node for any time interval in the temporal database.

This method may further comprise: (a) prompting a user to select a time interval; and (b) displaying, on a graphical display, the derived health status for each node at the selected time interval.

This method could also further comprise: (a) determining whether the health status for each node for each time interval is outside of a metric range; and (b) in response to determining the health status for a particular node for a particular time interval is outside of the metric range, generating an alarm.

In yet a further embodiment, the present invention provides a method for examining the current and historical health of a switchless direct interconnect network, the method comprising: (a) receiving raw node telemetry data at a time interval from each node in a plurality of nodes in the direct interconnect network, wherein each node comprises a plurality of ports, wherein the raw telemetry data includes telemetry data associated with at least one port in the plurality of ports for the associated node, and wherein the raw node telemetry data is received into a messaging bus; (b) processing the messaging bus, wherein processing the messaging bus comprises: (i) accumulating related raw node telemetry data into accumulated node telemetry data, (ii) removing the accumulated node telemetry data from the messaging bus, (iii) aggregating the accumulated node telemetry data into aggregate node telemetry data, and (iv) storing the aggregate node telemetry data into a temporal database; (c) deriving a health status for each port on each of the nodes for each time interval, wherein the health status is based at least in part on the stored aggregate node telemetry data; (d) storing the derived health status for each port of each node for each time interval in the temporal database; and (e) upon request, providing one or both of the aggregate node telemetry data and the derived health status of a particular node for any time interval in the temporal database.

This method may further comprise: (a) selecting a time interval; and (b) displaying, on a graphical display, the derived health status for each port of each node for the selected time interval.

The method may also further comprise: (a) determining whether the health status for each port of each node for each time interval is outside of a metric range; and (b) in response to determining the health status for a particular port of a particular node for a particular time interval is outside of the metric range, generating an alarm.

Yet another embodiment of the present invention provides a method for examining the current and historical health of a switchless direct interconnect network, the method comprising: (a) receiving raw node telemetry data at a time interval from each node in a plurality of nodes in a direct interconnect network, wherein the raw node telemetry data is received into a messaging bus; (b) processing the messaging bus, wherein processing the messaging bus comprises: (i) accumulating raw node telemetry data into accumulated node telemetry data, (ii) storing the accumulated raw node telemetry data in a temporal database; (iii) aggregating the accumulated node telemetry data into aggregate node telemetry data, (iv) storing the aggregate node telemetry data in the temporal database, and (v) publishing the aggregate node telemetry data on the messaging bus; (c) deriving a health status for each node for each time interval, wherein the health status is based at least in part on the aggregate node telemetry data stored in the temporal database or the aggregate node telemetry data published on the messaging bus; (d) storing the derived health status for each node for each time interval in the temporal database; and (e) displaying, on a graphical display, the derived health status for each port of each node for a selected time interval.

In yet a further embodiment, the present invention provides a system for examining the current and historical health of a switchless direct interconnect network, the system comprising: (a) a direct interconnect network, wherein the switchless direct interconnect network is comprised of a plurality of nodes; (b) a message bus, wherein the message bus is configured to receive raw node telemetry data from each of the plurality of nodes at a time interval; (c) a temporal database; and (d) a network manager, wherein the network manager is configured to: (i) process the message bus and convert raw node telemetry data into aggregate node telemetry data and store the aggregate node telemetry data in the temporal database, (ii) derive a health status for each node for each time interval and store the health status in the temporal database, wherein the health status is based at least in part on aggregate node telemetry data, and (iii) upon request, provide the health status of a particular node for any time interval in the temporal database. The system may further comprise a user interface, wherein the user interface is configured to convey a visual representation of the health status of a particular node for any time interval in the temporal database.

### BRIEF DESCRIPTION OF THE DRAWINGS

The invention will now be described, by way of example, with reference to the accompanying drawings in which:

FIG. 1 is an example display of a Health dashboard from the ANM User Interface (UI);

FIG. 2 is a diagram of the general system overview of the functional blocks that comprise ANM;

FIG. 3 is a diagram of the Node Management functional block of ANM;

FIG. 3a provides a brief description of the communication arrows in FIG. 3;

FIG. 4 is a diagram of the Configuration and Capabilities functional block of ANM;

FIG. 4a provides a brief description of the communication arrows in FIG. 4;

FIG. 5 is a diagram of the Metrics and Temporal Data Services functional block of ANM;

FIG. 5a provides a brief description of the communication arrows in FIG. 5;

FIG. 6 is a diagram of the Northbound API functional block of ANM;

FIG. 6a provides a brief description of the communication arrows in FIG. 6;

FIG. 7 is a diagram of the Events and Alarms functional block of ANM;

FIG. 7a provides a brief description of the communication arrows in FIG. 7;

FIG. 8 is a diagram of the ANM Administration functional block of ANM;

FIG. 8a provides a brief description of the communication arrows in FIG. 8;

FIGS. 9a-9c depict an annotated version of an embodiment of the structure of information stored in a Topology Database;

FIG. 10 is an annotated version of an embodiment of the structure of information stored in a Temporal Datastore;

FIGS. 11a and 11b depict a definition of the information returned by a node status query;

FIG. 12 displays an example 25 node network after the discovered nodes have been configured/enrolled;

FIG. 13 is an example format of a “node metrics” document;

FIG. 14 is a diagram of the message processing pipeline of the Metric and Data Ingestion Service;

FIG. 15 is an example of “node metrics”;

FIG. 16 is an example showing the preprocessing of the metrics shown in FIG. 15;

FIGS. 17a-17c depict an example pipeline configuration;

FIG. 18 shows an example of an index template definition;

FIG. 19 is an example node metrics kafka message in an array format;

FIG. 20 shows aggregated data in a “nested object” format;

FIG. 21 is a description of agent events;

FIG. 22 shows representative depictions of various direct interconnect network topologies;

FIG. 23 is a photo of a Rockport RO6100 Network Card (example node);

FIG. 24 is a line drawing of a Rockport lower level optical SHFL (LS24T);

FIG. 25 is a line drawing of a Rockport upper level optical SHFL (US2T);

FIG. 26 is a line drawing of a Rockport upper level optical SHFL (US3T);

FIG. 27 is a representative depiction of a Rockport lower level optical SHFL (LS24T);

FIG. 28 is a representative depiction of a Rockport lower level optical SHFL (LS24T) connected to a Rockport RO6100 Network Card;

FIG. 29 display a representative 4×3×2 torus configuration;

FIG. 30 is an illustration of how a set of 12 lower level shuffles 100 (LS24T) may be connected in a (4×3×2)×3×2×2 torus configuration for a total of 288 nodes;

FIG. 31 is an illustration of potential connections between a Rockport lower level optical SHFL (LS24T) and Rockport upper level optical SHFLs (US2T and US3T);

FIG. 32 is a graphical representation of ANM installed over 3 servers;

FIG. 33 is a graphical representation of ANM installed over 3 servers in the same rack;

FIG. 34a is an example display of a time window size feature for a timeline on an ANM interface dashboard;

FIG. 34b is an example display of a LIVE/PAUSED feature for a timeline on an ANM interface dashboard;

FIG. 34c is an example display of a timeline positioning feature for a timeline on an ANM interface dashboard;

FIG. 34d is an example display of a date/time feature for a timeline on an ANM interface dashboard;

FIG. 35 is an example display of a Health dashboard from the ANM interface;

FIG. 36 is an example display of a Health dashboard from the ANM interface showing a node with focus;

FIG. 37 is an example display of a Health dashboard from the ANM interface showing a selected node;

FIG. 38 is an example display of a Health dashboard from the ANM interface showing the node name link;

FIG. 39 is an example display of a Health dashboard from the ANM interface showing node size and color;

FIG. 40 is a chart explaining the meaning of node colors and status;

FIG. 41 is a chart explaining the meaning of node and port color coding;

FIG. 42 is an example display of a Health dashboard from the ANM interface showing the node list;

FIG. 43 is an example display of a Health dashboard from the ANM interface showing a node with focus;

FIG. 44a is an example Summary display on a Node dashboard from the ANM interface in graph view mode;

FIG. 44b is an example Summary display on a Node dashboard from the ANM interface in tree view mode;

FIG. 45 is an example Traffic Analysis Rate display on a Node dashboard from the ANM interface;

FIG. 46 is an example Traffic Analysis Range display on a Node dashboard from the ANM interface;

FIG. 47 is an example Traffic Analysis Utilization display on a Node dashboard from the ANM interface;

FIG. 48 is an example Traffic Analysis QOS display on a Node dashboard from the ANM interface;

FIG. 49 is an example Traffic Analysis Profile display on a Node dashboard from the ANM interface;

FIG. 50a is an example chord diagram portion of a Traffic Analysis Profile display on a Node dashboard from the ANM interface when a user hovers over a segment in the outer band;

FIG. 50b is an example chord diagram portion of a Traffic Analysis Profile display on a Node dashboard from the ANM interface when a user hovers over a chord line;

FIG. 51 is an example Traffic Analysis Flow display on a Node dashboard from the ANM interface;

FIG. 52 is an example Packet Analysis Application display on a Node dashboard from the ANM interface;

FIG. 53 is an example Packet Analysis Network display on a Node dashboard from the ANM interface;

FIG. 54 is an example Packet Analysis QOS display on a Node dashboard from the ANM interface;

FIG. 55 is an example Packet Analysis Size display on a Node dashboard from the ANM interface;

FIG. 56 is an example Packet Analysis Type display on a Node dashboard from the ANM interface;

FIG. 57 is an example Alarm dashboard for a selected node from the ANM interface;

FIG. 58 is an example Alarm dashboard for the network as a whole from the ANM interface;

FIG. 59 is an example Alarm dashboard for the network as a whole from the ANM interface focusing on 2 alarms noted;

FIG. 60 is an example display portion showing how a user may Acknowledge an alarm from the ANM interface;

FIG. 61 is a graphical display explaining the nature of threshold crossing alerts;

FIG. 62 is a chart showing example customizable metric alarms;

FIG. 63 is an example Alarm tab on a Settings display showing a customizable High Card Temperature metric alarm from the ANM interface;

FIG. 64 is an example Events dashboard for a selected node from the ANM interface;

FIG. 65 is an example Events dashboard for the network as a whole from the ANM interface;

FIG. 66 is an example Optical dashboard for a selected node from the ANM interface;

FIG. 67 is an example System dashboard for a selected node from the ANM interface;

FIG. 68 is an example Node Compare dashboard from the ANM interface;

FIG. 69 is an example Performance dashboard from the ANM interface;

FIG. 70 shows the Health Dashboard before the cooling system failure in the Example Use Case;

FIG. 71 shows the Health Dashboard when a first node failed during the cooling system failure in the Example Use Case;

FIG. 72 shows another Health Dashboard view when a first node failed during the cooling system failure in the Example Use Case;

FIG. 73 shows the Health Dashboard when several nodes had failed during the cooling system failure in the Example Use Case;

FIG. 74 shows the Health Dashboard when almost all nodes had failed during the cooling system failure in the Example Use Case;

FIG. 75 shows the Node Summary Dashboard of the first node that failed during the cooling system failure in the Example Use Case; and

FIG. 76 shows the Node System Dashboard of the first node that failed during the cooling system failure in the Example Use Case.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION OF THE INVENTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

It will be appreciated that any one or more of the teachings, expressions, versions, examples, etc. described herein may be combined with any one or more of the other teachings, expressions, versions, examples, etc. that are described herein. The following-described teachings, expressions, versions, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

The physical structure of the present invention (referred to herein as the Autonomous Network Manger or “ANM” 1) consists of various software components that form a pipeline through which ingested network node telemetry data is collected, correlated, and analyzed, in order to present a user with a unique visualization of the temporal state, health, and other attributes of direct interconnect network nodes and/or elements thereof and the network topology. This visualization is presented via a computer system GUI (graphical user interface)/UI (user interface), be it a portable/mobile or desktop system. The figures present various depictions of the user interface 6, though it will be understood that the underlying data may be presented in various ways without departing from the spirit of the invention. Further, node 5 may be used interchangeably to refer to either the actual physical node itself or the graphical depiction of the physical node on the user interface 6.

The nodes 5 that are directly interconnected in the network topology may potentially be any number of different devices, including but not limited to processing units, memory modules, I/O modules, PCIe cards, network interface cards (NICs), PCs, laptops, mobile phones, servers (e.g. application servers, database servers, file servers, game servers, web servers, etc.), or any other device that is capable of creating, receiving, or transmitting information over a direct interconnect network. The nodes 5 contain software that implements the switchless network over the network topology (see e.g. the methods of routing packets in U.S. Pat. Nos. 10,142,219 and 10,693,767 to Rockport Networks Inc., the disclosures of which are incorporated in their entirety herein by reference). Although supported ANM features and/or the behavior thereof can differ based on the type of nodes managed, this is preferably dynamically discovered at run-time.

As a high-level introduction to the macro-functionality of ANM 1, network node telemetry data is collected on a Message Bus 10, preferably using a distributed streaming platform such as Kafka®, for instance, and is consumed by a configurable rules engine (“Node Health and Telemetry Aggregator”) 15 which applies configured rules to make an overall determination as to the state classification of the various network nodes 5 and/or elements thereof (e.g. ports) that are interconnected in the direct interconnect network.

More accurately, a Node Health and Telemetry Aggregator 15 is responsible for assessing alarms raised by an Alarm Service 20 against the nodes and their elements (e.g. ports), and assigning a health status to each (e g unknown, ok, warning, error). The ANM user interface (GUI/UI) 6 then calculates a health score based on the health status for use by the UI's visualization component, which visually conveys overall network health to a user.

The correlation of node telemetry data to the resultant health of the network topology is achieved through coordination with a “Network Topology Service” 25 that is responsible in part for maintaining a live view of the network. In the case of both the Node Health and Telemetry Aggregator 15 and Network Topology Service 25, each service produces events back onto the Message Bus 10 with node telemetry data being timestamped and stored in a Temporal Datastore 30, which ultimately allows for the implementation of a walkable timeline of events that can be queried and traversed to recreate the state of topology and health of the network at any given time during a retention period (e.g. 30 days).

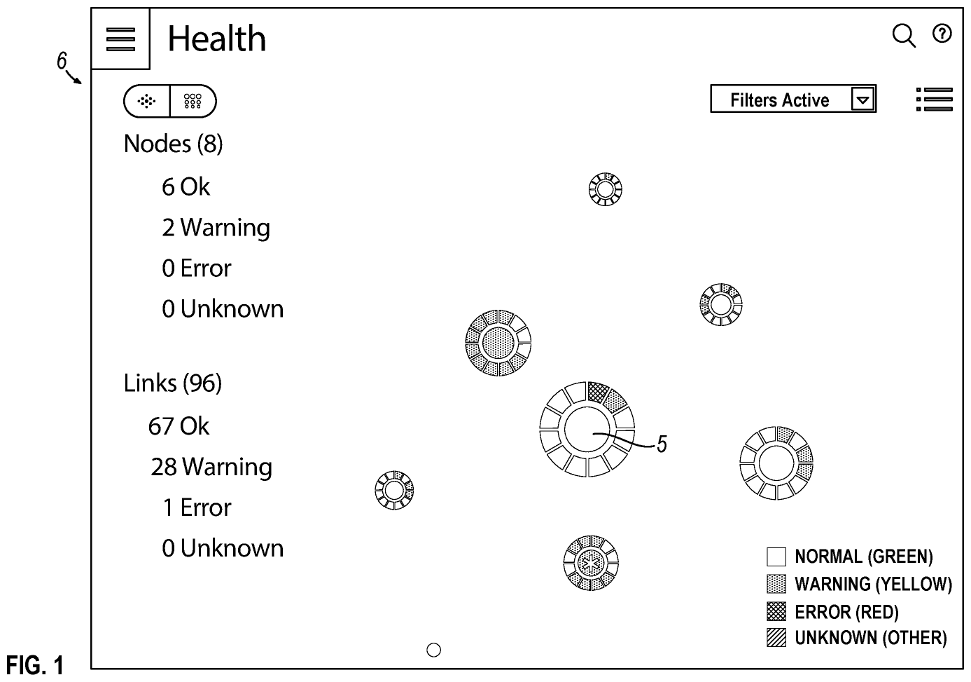

An API layer provides access to querying the topological state and health state to consumers preferably via RESTful services (Representational State Transfer; a stateless, client-server, cacheable communications protocol) for instance. The UI's visualization component leverages the API to display the topology and health of the network at any point in time in various unique, user-friendly ways. More specifically, as an initial example, in one embodiment the scores assigned by the UI 6 based on the status assigned by the Node Health and Telemetry Aggregator 15 for each network node 5 or element thereof may be used by the UI's visualization component to scale network nodes relatively in a GUI visualization to allow for easy identification of those network nodes that are in the worst state and therefore that require the most attention. To compliment the scale, colors may be assigned to each node or each element of the network node 5 visualization based on their individual state in order to better alert the administrator (see e.g. FIG. 1, which shows, for instance, an exemplary user interface 6 depicting an upscaled/enlarged node 5 having one of its twelve ports in an error condition because it is experiencing performance issues (shown in red), and another in a warning state because it is experiencing minor issues that may impact normal operation (shown in yellow), while the remaining ports are in good operational status (shown in green)).

In one embodiment, complementary controls may be provided that allow the user to change the date and time of the topological GUI visualization. Should the user change the time being viewed the visualization will update the visualization in real-time to display the state and configuration of the network topology recorded for that exact moment in time. The user could also configure the timeline to a “live” state wherein the visualization will continually update as new states or changes in topology are detected, giving the user a near real-time window into the operational performance of the network.

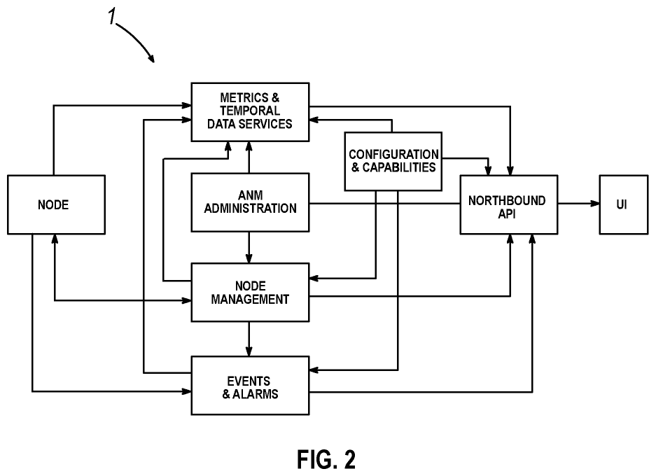

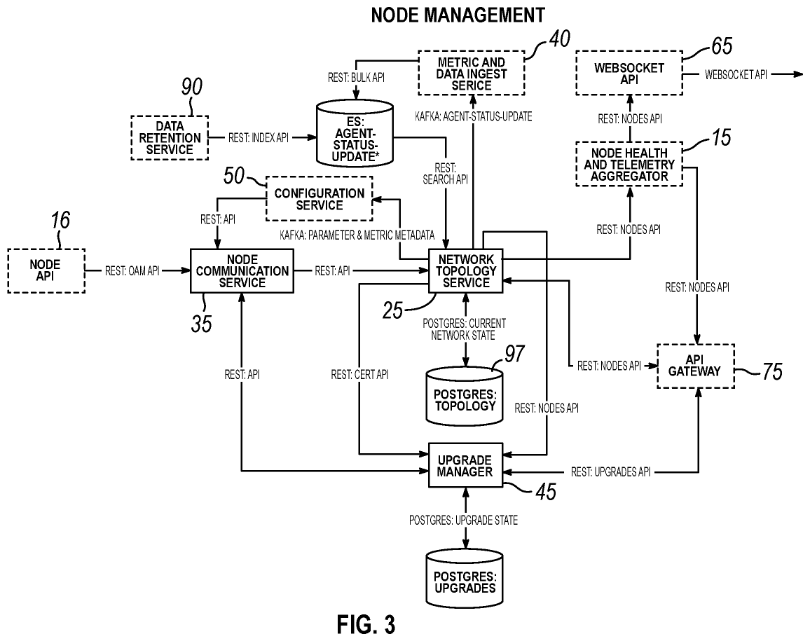

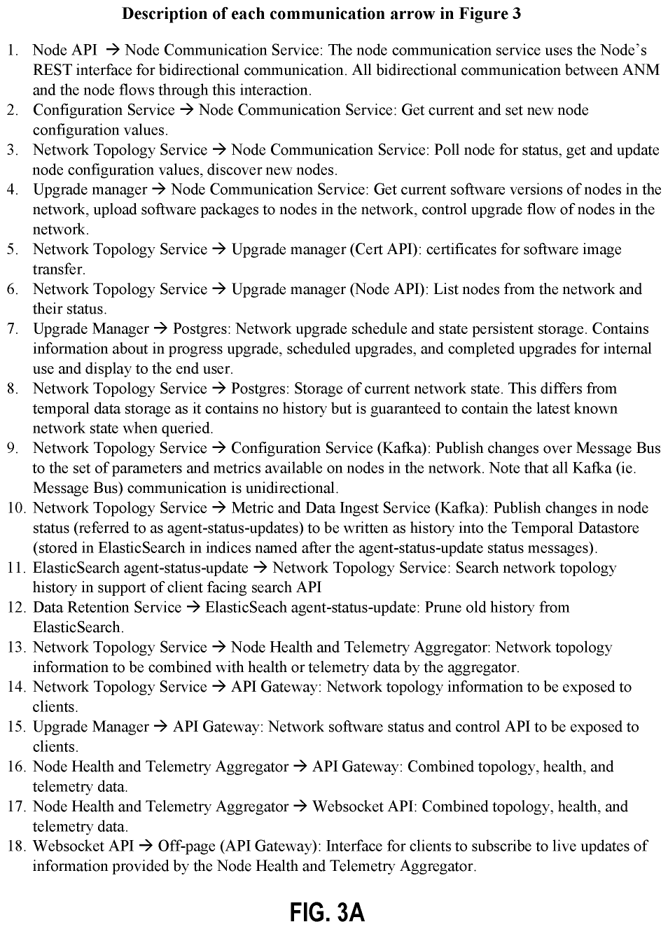

FIG. 2 provides one embodiment of a general system overview of ANM 1 that will assist with an overall understanding of functionality. Each functional block in FIG. 2 is shown in more detail in FIGS. 3 to 8 that follow. The “Node” represents a device (i.e. node 5) that is part of the direct interconnect network under management. All communication from ANM 1 to a node 5 flows through the “Node Management” block. Any other connections between the node and other components/parts of ANM represent unidirectional information flow (generally on the Message Bus 10) from the node to that component. A more detailed overview of the Node Management block is provided at FIGS. 3 and 3a, where it is shown that the major functions covered within this block are the:
1) Node Communication Service 35, which mediates all bidirectional communication between ANM and the nodes in the network using RESTful services;
2) Network Topology Service 25, which is responsible for controlling the discovery and configuration of new nodes, status monitoring of the network, and publishing status data to the Metric and Data Ingest Service 40 for storage in the Temporal Datastore 30 (e.g. Elasticsearch; see “ES: agent-status-update” index in FIG. 3); and
3) Upgrade Manager 45, which is responsible for orchestrating the upgrade of software on nodes in the network.

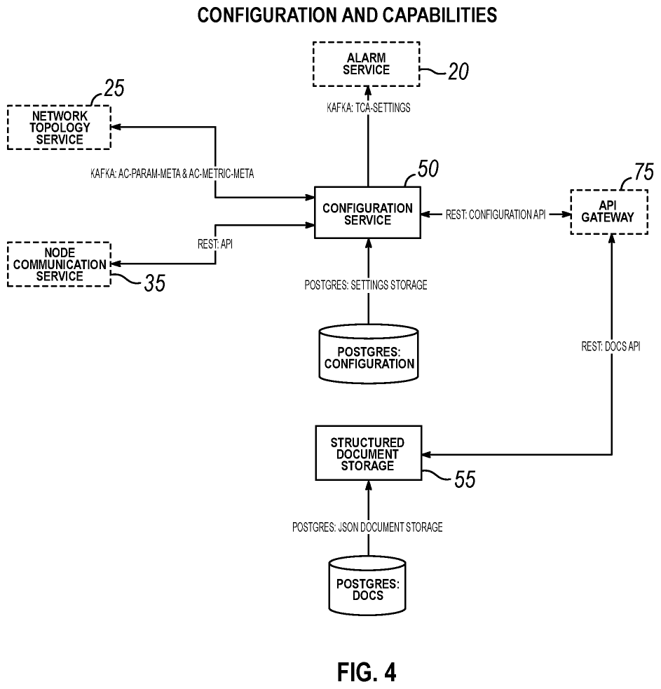

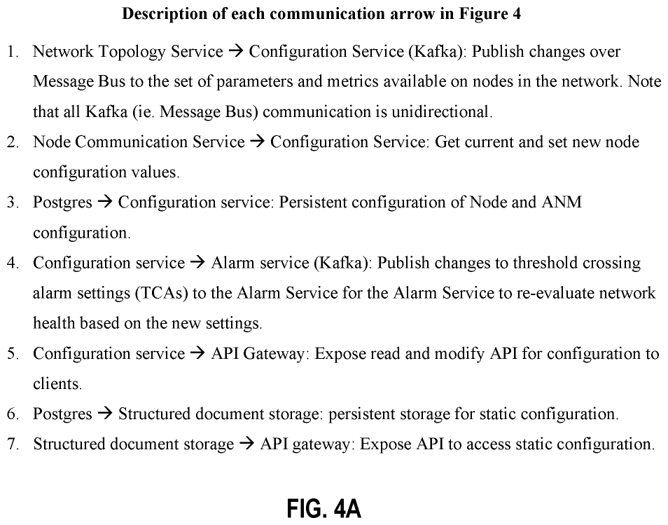

With reference to FIG. 2, the “Configuration and Capabilities” block provides centralized configuration services both for nodes and ANM itself. A more detailed overview of the Configuration and Capabilities block is shown at FIGS. 4 and 4a, where its services include the:
1) Configuration Service 50, which provides storage for both node and ANM configuration that may change over time, and includes mechanisms to modify configuration and notify consumers of those modifications; and
2) Structured Document Storage 55, which provides storage for static configuration, and provides an API for consumers, including the UI, to access that configuration at runtime.

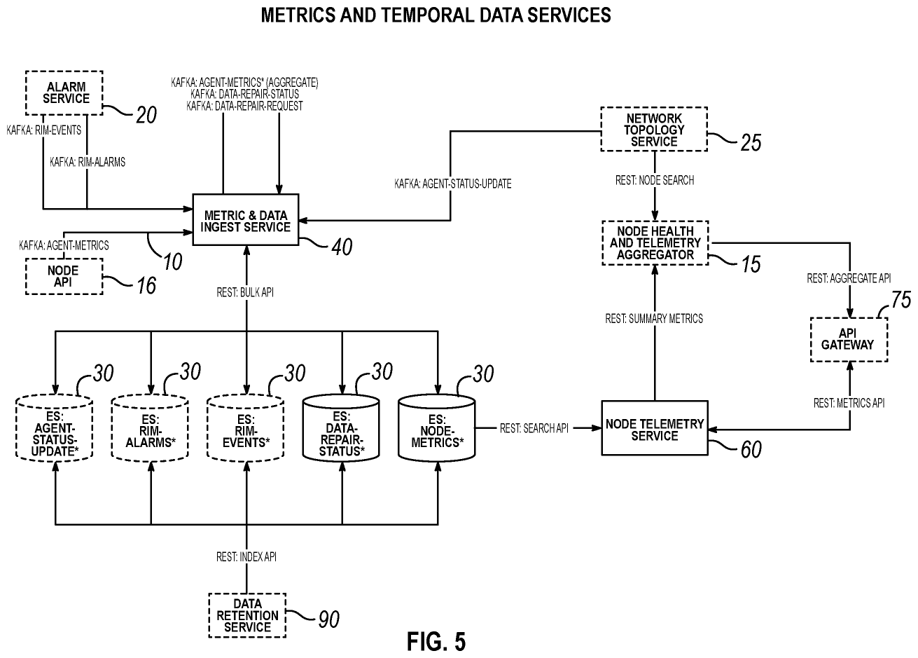

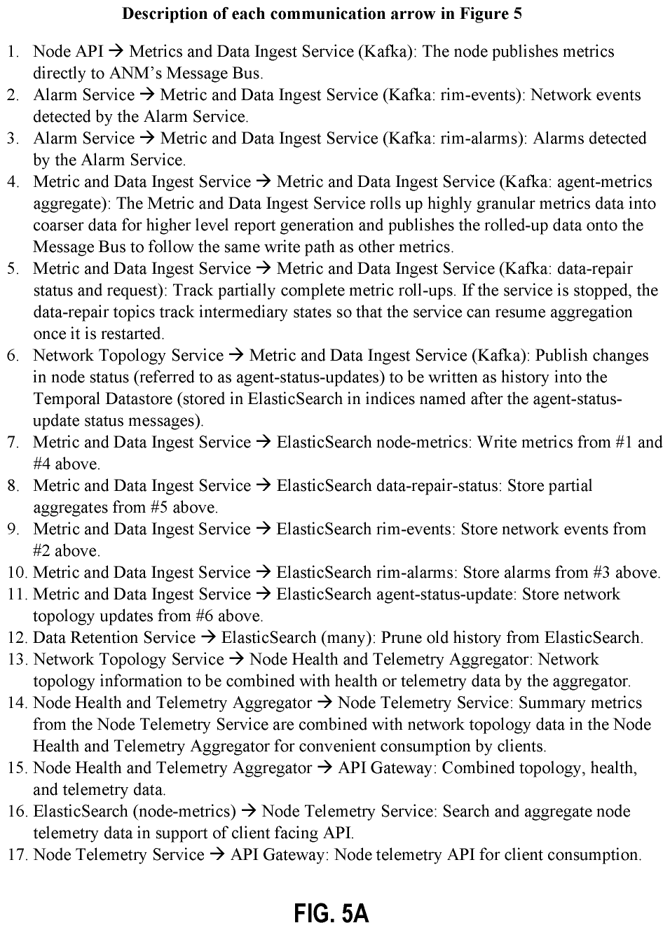

With reference to FIG. 2, the Metrics and Temporal Data Services block encapsulates the node metrics use cases, and with reference to the more detailed overview shown at FIGS. 5 and 5a, it provides two major functions, namely the:
1) Metric and Data Ingest Service 40, which is a high-volume, general-purpose data ingest service that is used in the write path of many of ANM's data repositories. Its reason for existence is the relatively high-volume sets of time series data that must be prepared for storage, and then stored in their respective repositories (e.g. node metrics, temporal history of network topology, network alarm states, network events, etc.); and
2) Node Telemetry Service 60, which provides a read interface into the node metrics repository.

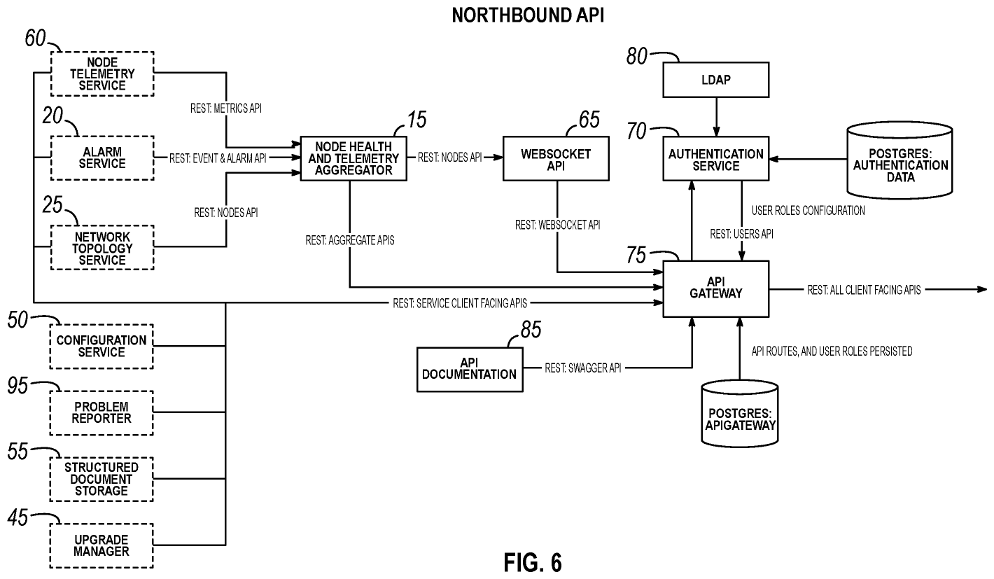

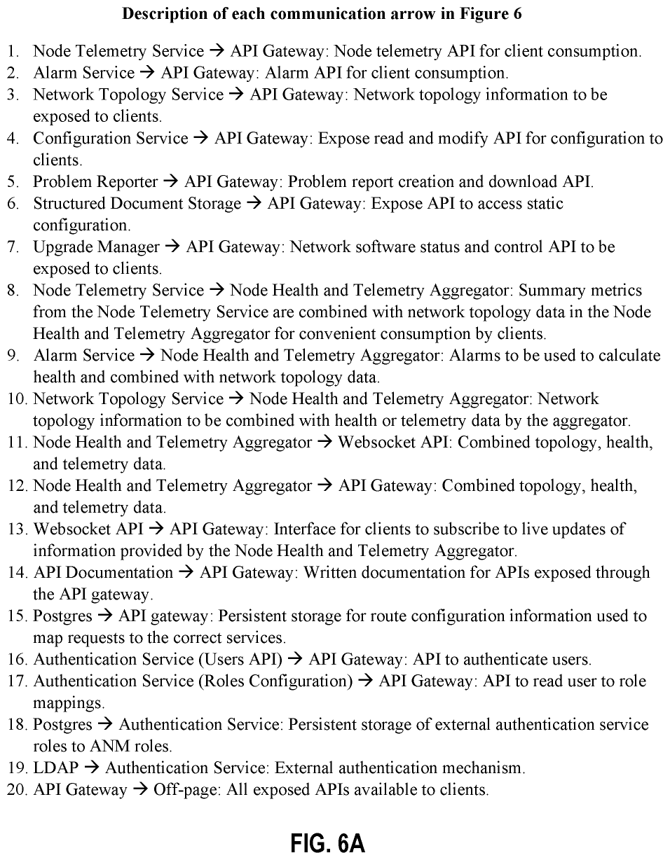

With reference to FIG. 2, the Northbound API block provides externally accessible APIs for all ANM functions. A more detailed overview of the Northbound API block is shown at FIGS. 6 and 6a, where its services include the:
1) Node Health and Telemetry Aggregator 15, which assesses node health and combines data from other services into aggregate responses to simplify API interaction (i.e. the client only needs to make one request to this service rather than making two or three separate requests to other services and combining the results itself);
2) Websocket API 65, which provides a websocket interface, allowing clients to subscribe to live updates of information provided by the Node Health and Telemetry Aggregator
3) Authentication Service 70, which provides integrations between external or internal authentication tools and API Gateway 75 authentication via a LDAP 80 source;
4) API Documentation 85, which provides a formatted version of ANM's API for consumption by API users; and
5) API Gateway 75, which is the only externally accessible endpoint to ANM's underlying APIs (APIs on all other services are inaccessible to API users). The API Gateway 75 routes all requests to their appropriate services and layers middleware over the request infrastructure to uniformly apply functions like authentication.

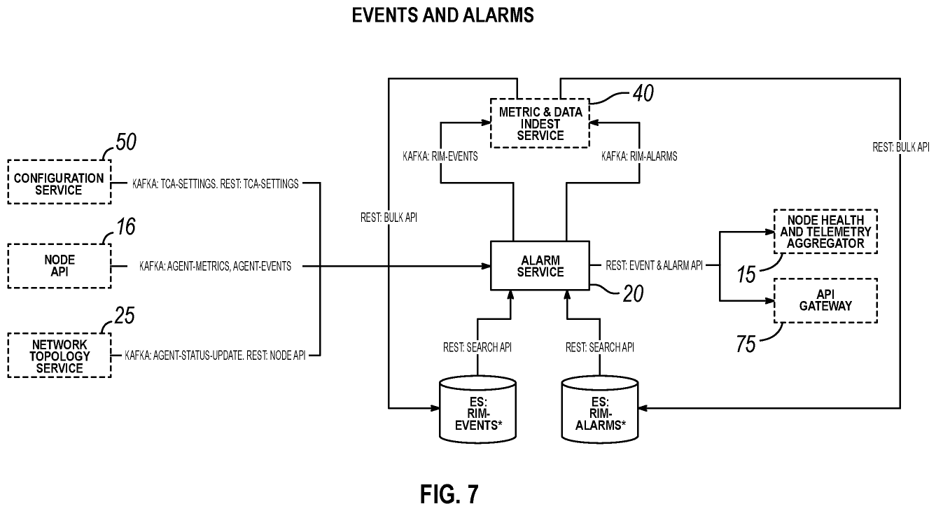

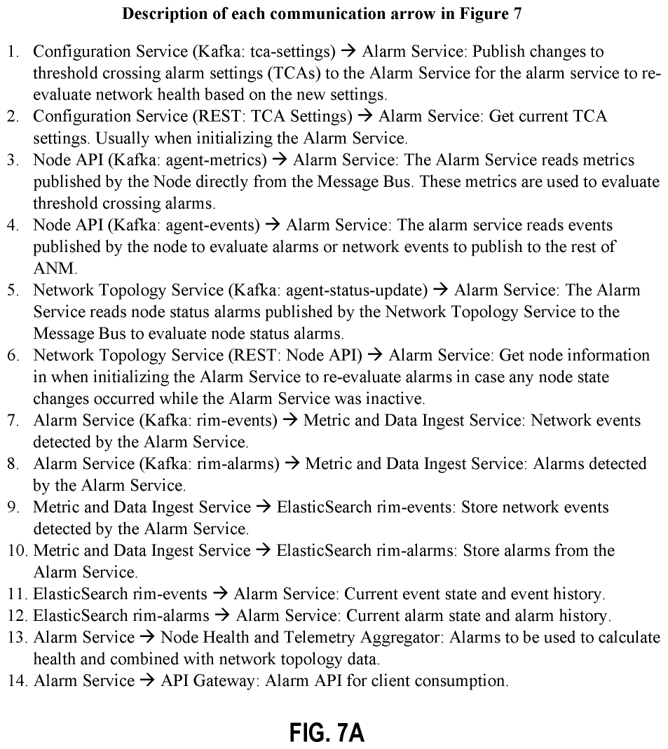

With reference to FIG. 2, the Events and Alarms block (a more detailed overview of which is shown at FIGS. 7 and 7a), generates network events and alarms based on network status information and node metrics. All of this is driven by the Alarm Service 20.

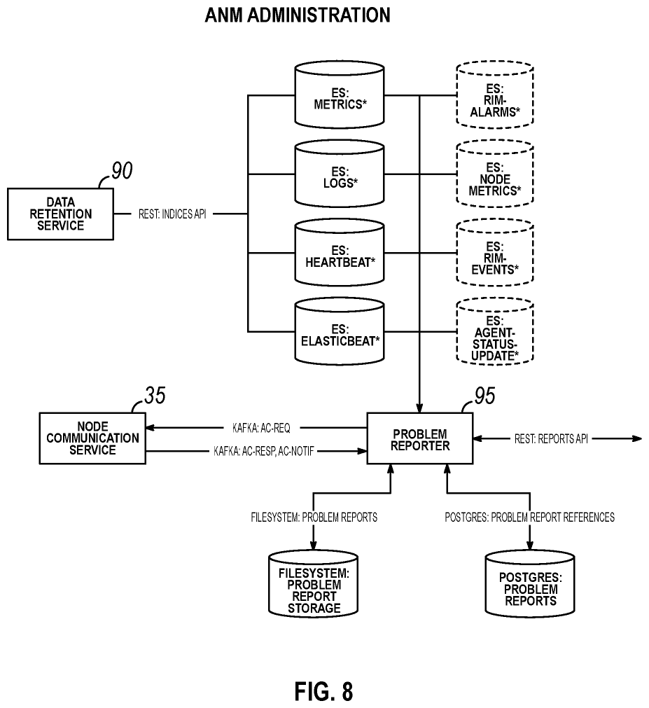

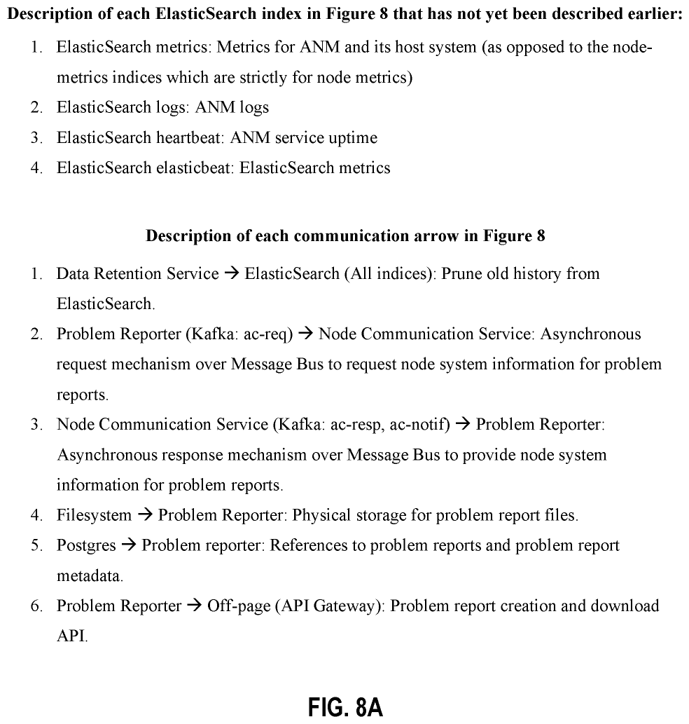

With reference to FIG. 2, the ANM Administration block (as shown in more detail at FIGS. 8 and 8a) provides a few tools, namely the:
1) Data Retention Service 90, which removes data that falls outside of the data retention range (e.g. 30 days); and
2) Problem Reporter 95, which collects data about ANM and the network, and packages it for consumption by technical staff. This allows technical staff to quickly capture key information to diagnose issues without tying up customer staff during any debugging process.

We now herein provide a more detailed disclosure of functionality and steps involved in implementing an embodiment that encapsulates a system capable of the temporal monitoring and visualization of the health of a direct interconnect network. This will allow the skilled person to fully understand the functionality of the key components involved in the functional blocks shown in FIGS. 2 to 8, and how to make and work ANM. The steps described herein are not necessarily performed sequentially, and instead certain steps may be continuously running or performed simultaneous with, prior to or subsequent to other steps.

Nodes are initially functional at the data plane level, and ANM is not required for the initialization of the data plane. However, each node added to the interconnect network must first be discovered and configured before it can be managed and monitored by ANM. For discovery purposes, nodes have attributes that can be used to identify them, and they can be identified at many levels—on the data plane, within a topology, or inside an enclosure, for instance. At the data plane, for example, nodes may be identified using Node ID, but Node ID's are transient which makes them insufficient for ANM node identification (at the management plane). ANM may therefore uniquely identify a node in the context of an enclosure. On a standard configuration NIC, the node identifier could, for example, be a composite of the NIC's serial number and the motherboard's Universally Unique Identifier (UUID). On a storage configuration NIC, the node identifier could, for instance, be the NIC's serial number. This identifier would be assigned a Node UUID in ANM. ANM would then send the Node UUID and a list of Kafka® Brokers (e.g. IPv6 link local addresses based on MAC addresses) to a node during the configuration stage.

Discovery and configuration workflow is controlled by the Network Topology Service 25 (see FIG. 3), which is a key component of the Node Management system of ANM as shown in FIG. 2. To commence discovery, the Network Topology Service 25 starts with one node that it can communicate with. In this respect, in a preferred embodiment, the Network Topology Service 25 assumes that there is a node installed on the server that ANM is running on, and communication is initiated with this first (ie. “primary”) node. Bidirectional communication between nodes and various services is handled by the Node Communication Service 35, which essentially proxies requests from other services to the nodes via an API layer using RESTful services (Representational State Transfer; a stateless, client-server, cacheable communications protocol) for instance (see e.g. “REST: OAM API” in FIG. 3 from the Node API 16 to the Node Communication Service 35). During the discovery and configuration process, the Network Topology Service 25 will also be determining the overall network topology, and maintaining and updating the Topology Database 97 accordingly (e.g. PostgreSQL; see “Postgres: topology” in FIG. 3), which includes link information to neighbor nodes (discussed more below).

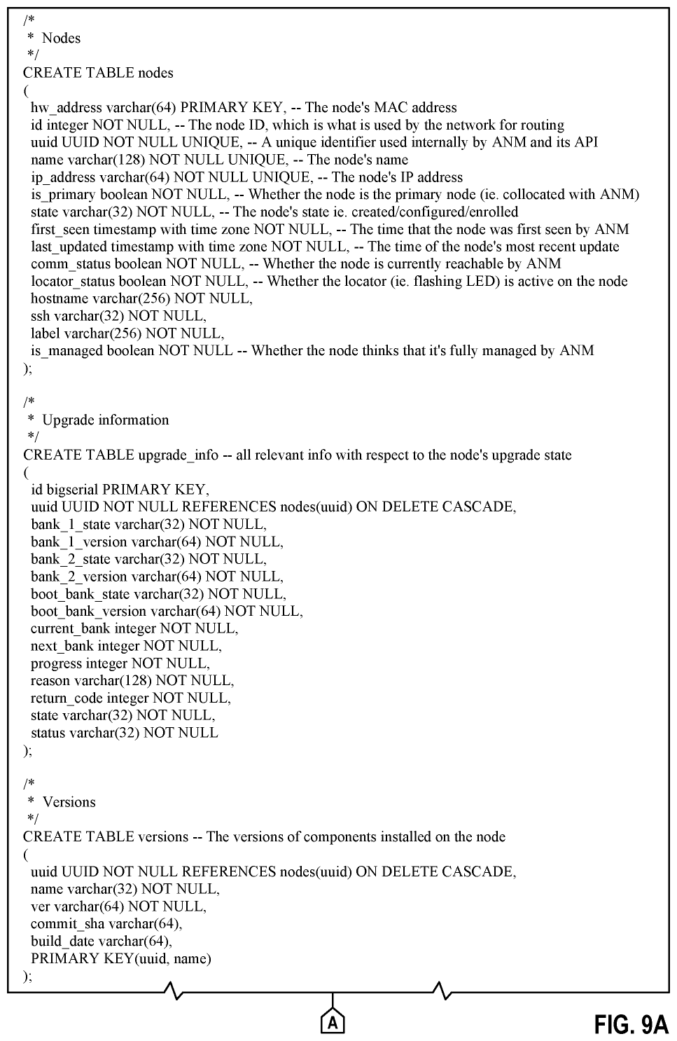

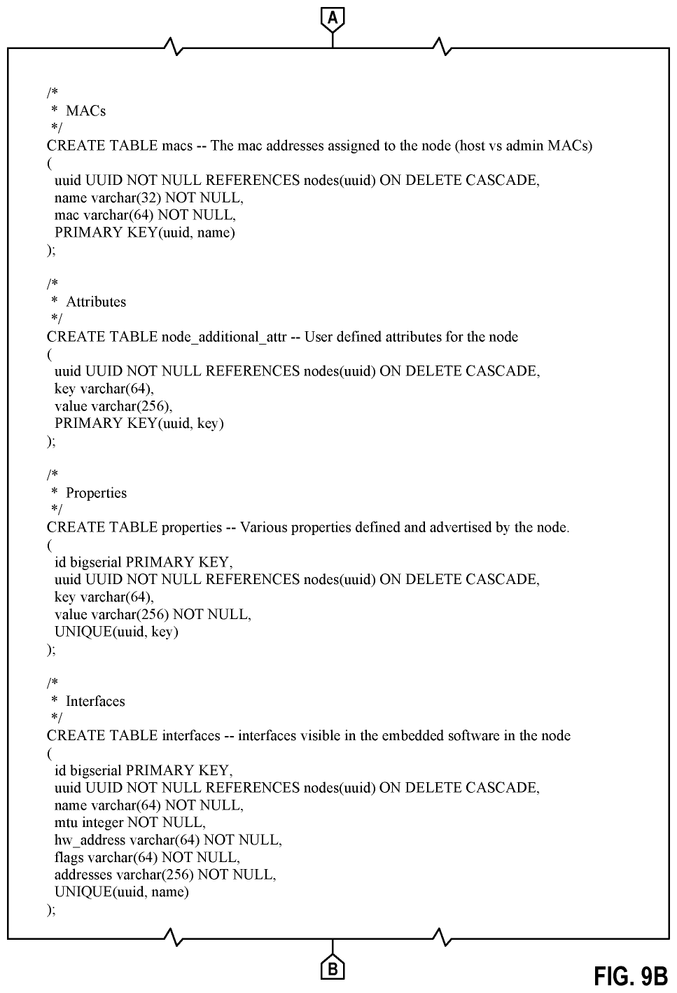

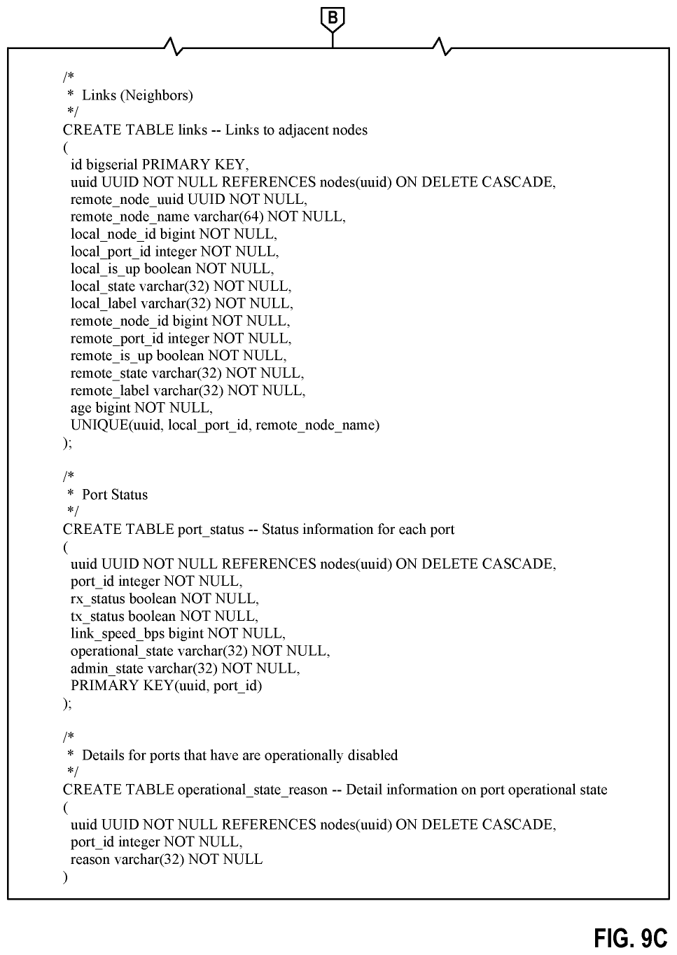

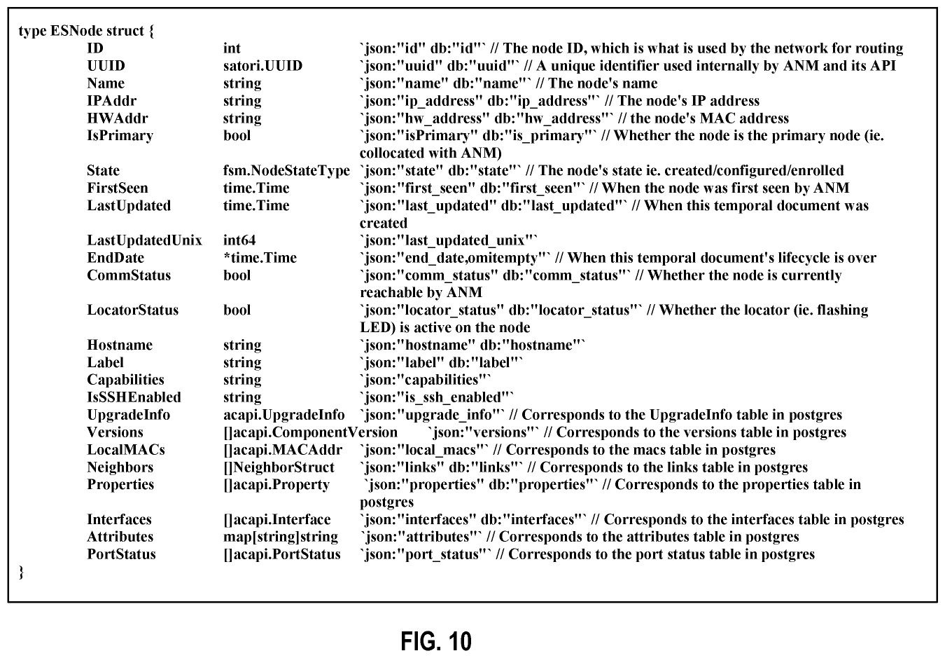

As noted above, immediately after discovery, the “primary” node (and each subsequently discovered node) has to be configured before they can commence sending raw telemetry data or “node metrics” to the Message Bus 10 (e.g. Kafka) for subsequent processing. In this respect, the Network Topology Service 25 requests node configuration information from the Configuration Service 50 via its REST API, then updates each node's configuration upon discovery (see FIG. 4). The Configuration Service 50 is a part of the Configuration & Capabilities system of ANM as shown in FIG. 2, and it queries its persistent data store (see “Postgres: configuration” in FIG. 4) to determine the appropriate configuration for the node software version of the node in question, and then passes the configuration retrieved from its persistent data store back to the Network Topology Service 25, which in turn sends it to the node via RESTful services. The Network Topology Service 25 persists all current node state information in the Topology Database 97 (e.g. PostgreSQL; see “Postgres: topology” in FIG. 3). An annotated version of an embodiment of the structure of information stored in a Topology Database 97 is located at FIG. 9a-c. The Network Topology Service 25 also stores all node state history within the Temporal Datastore 30 (e.g. Elasticsearch; see “ES:agent-status-update” in FIG. 3) via the Message Bus 10 (e.g. Kafka: agent-status-update). In this respect, writes to the Temporal Datastore 30 are actually handled by the Metric and Data Ingest Service 40 (see “ES: agent-status-update”, “ES: rim-alarms”, etc. in FIG. 5), discussed more below. An annotated version of an embodiment of the structure of information stored in a Temporal Datastore 30 is located at FIG. 10. The Temporal Datastore 30 contains node telemetry data for the duration of data retention (see e.g. “Data Retention Service” in FIGS. 5 and 8), which is preferably customizable per deployment (e.g. 30 days). Whenever something changes on a node, a new document representing the then current state of the node is saved in the Temporal Datastore 30 (along with the previously saved information), which enables the functionality of ANM's walkable timeline.

A node completes its enrollment at the management plane during the configuration process. During the enrollment process, the Network Topology Service 25 provides a TLS certificate to a newly enrolled node. Once enrolled, the node should preferably only respond to management traffic secured with that certificate. The entire network topology and route information should be automatically updated after each node enrollment.

After configuration and enrolment of the “primary” node (and each subsequently discovered node), the Network Topology Service 25 will query the node asking for addresses to its direct neighbours. Those addresses are returned in terms of MAC addresses. The Network Topology Service 25 uses those MAC addresses to construct link local IPv6 addresses, which are used to configure each neighbouring node one at a time. Immediately after each node is configured, it is queried for its direct neighbours. This process continues until there are no new nodes discovered, and at this point the full network topology is known.

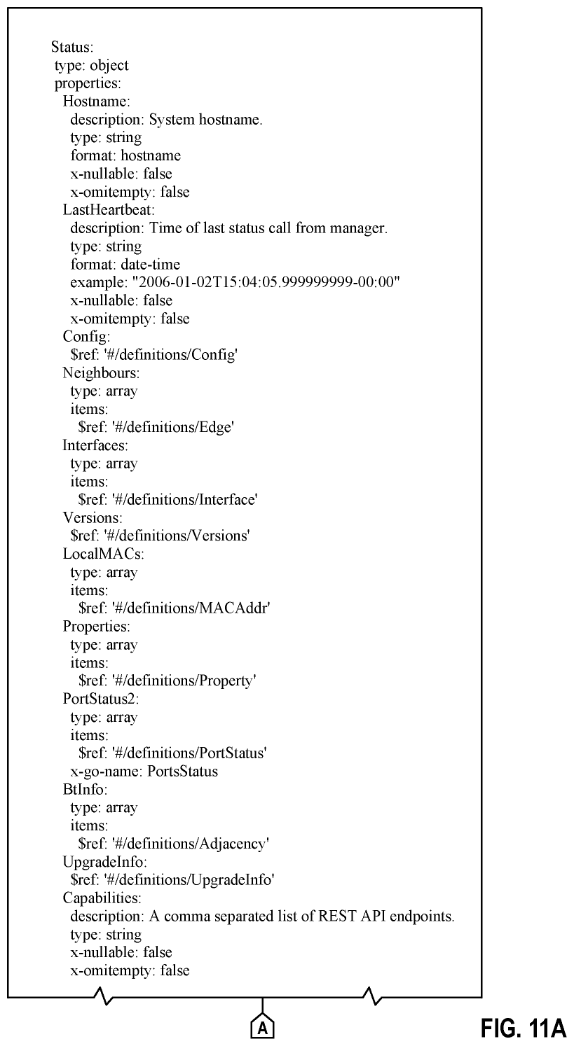

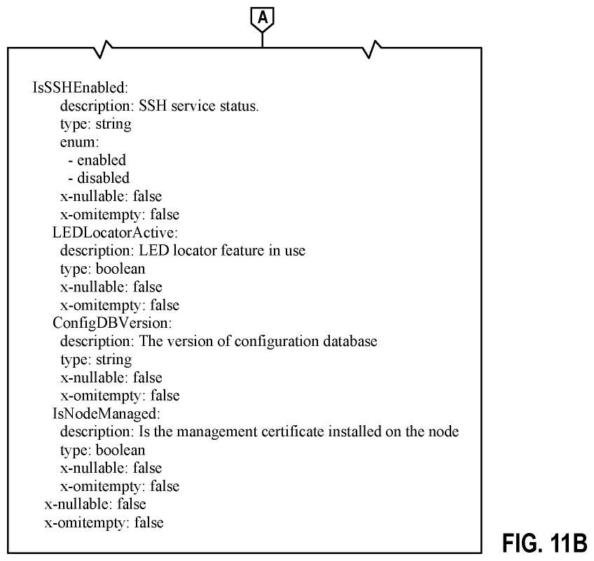

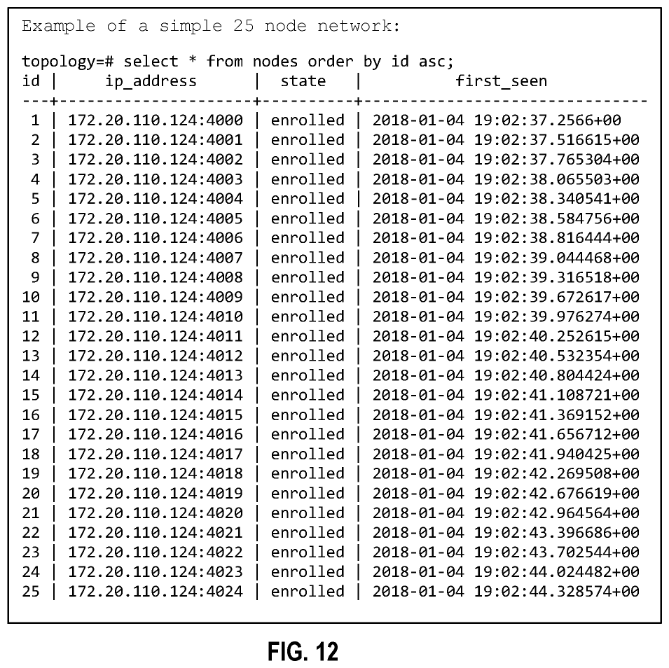

Discovered and configured nodes will thereafter regularly share their status with the Network Topology Service 25, which includes neighbour information that is used in discovery. If a new node is attached to an existing network, it will be detected when the node's status is shared with the Network Topology Service 25 and discovered in the same manner as described above. A preferred complete definition of the information returned by a node status query is provided at FIG. 11a-b. FIG. 12 displays an example 25 node network after the discovered nodes have been configured/enrolled.

After the nodes are fully configured and enrolled, the Metric and Data Ingest Service 40 will receive node telemetry data from each of the nodes or every port on each of the nodes at a time interval in order to begin temporally tracking the state of the nodes in the topology. All configured nodes communicate raw telemetry data or “node metrics” to the Metric and Data Ingest Service 40 via the Message Bus 10 (see “Kafka agent-metrics” in FIG. 5). In this respect, information (like node metrics) placed on the Message Bus 10 does not have a destination address attached; information is simply broadcast to any consumer/component/service that cares to read it off the applicable message topic. As such, some of the information read by the Metric and Data Ingest Service 40 is also read by other services elsewhere in ANM for their own purposes.

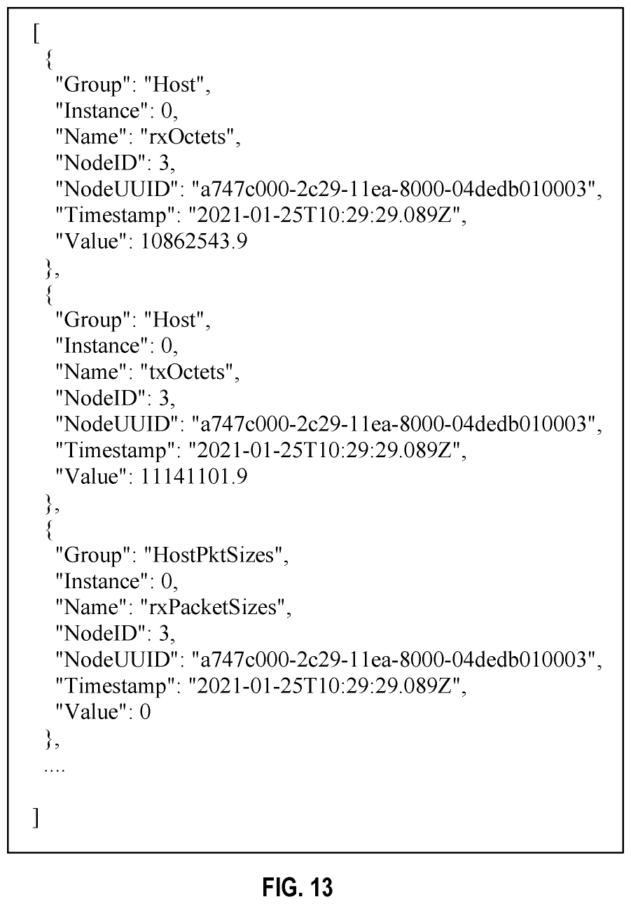

Each “node metrics” document preferably has a format like that shown at FIG. 13. This raw telemetry data is then stored as a telemetry timeseries in the Temporal Datastore 30 by the Metric and Data Ingest Service 40 (see e.g. “ES: node-metrics” in FIG. 5).

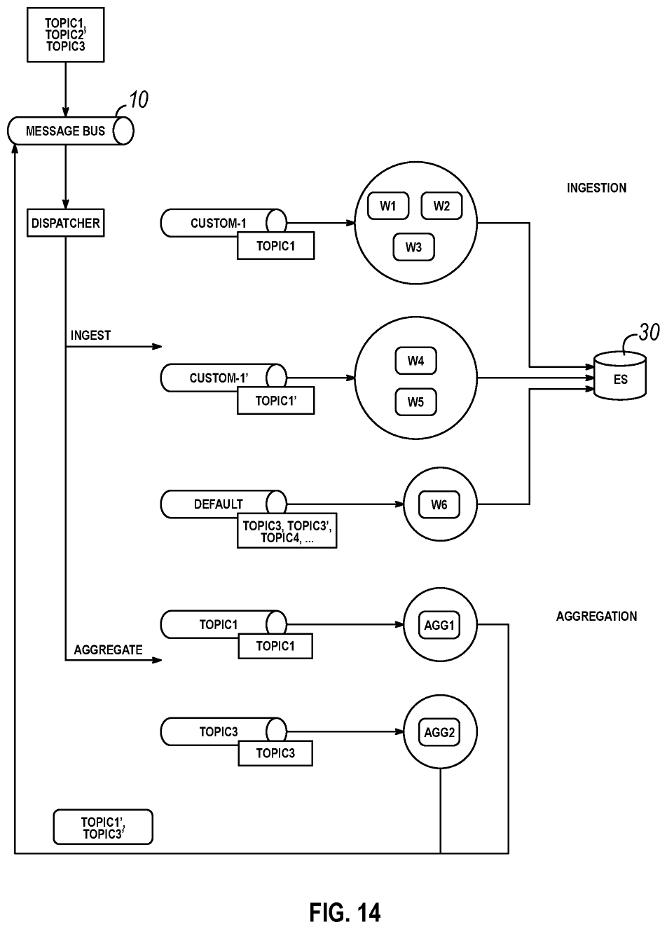

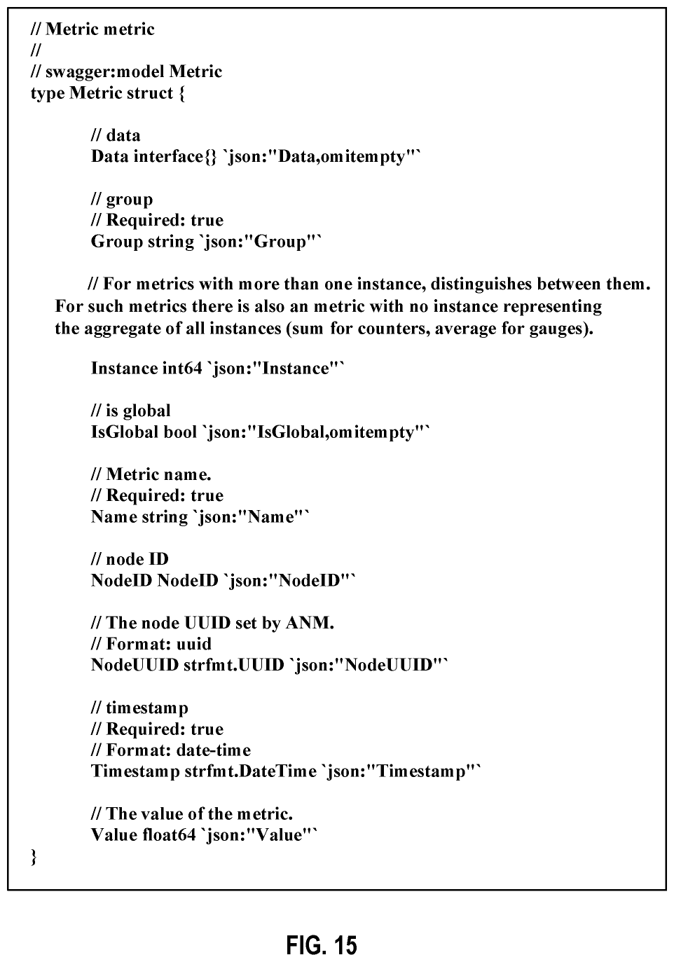

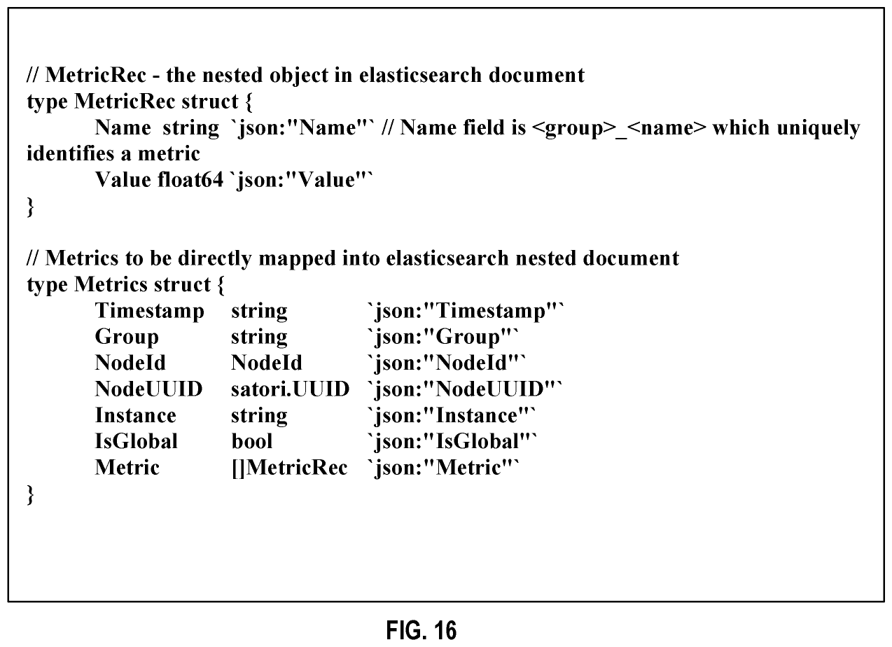

The Metric and Data Ingestion Service 40 is essentially a message processing pipeline comprising at least one kafka message bus consumer and dispatcher, supports at least one default pipeline/message channel and any number of custom pipelines/message channels, and may consume telemetry timeseries, temporal topology data, alarm data, and the like. Preferably, the default pipeline can handle multiple kafka topics, while a custom pipeline may typically be used to handle one topic having large volumes of data (e.g. node metrics) that requires extra resources (see e.g. FIG. 14). However, while all raw telemetry data is saved in the Temporal Datastore 30 so that consumers may examine it at the finest granularity available if desired, the Temporal Datastore 30 also saves aggregated telemetry data for higher level report generation purposes. In this respect, raw node telemetry is also down sampled by the Metric and Data Ingest Service 40 for efficient retrieval of data over larger time windows (see e.g. aggregation box in FIG. 14). Thus, while the Metric and Data Ingest Service 40 is mostly a passthrough on the way to the Temporal Datastore 30 (e.g. Elasticsearch) for topology and alarm data, it performs data aggregation as well as data transformation on telemetry data that it receives. The data is dispatched to the appropriate aggregator or ingestor as depicted in FIG. 14. Any necessary data transformation on raw telemetry data is done in the data ingest threads. In this respect, after receipt, the pipeline “worker” threads pre-process the data. Preprocessing is a data mapping that transforms metrics from that shown in FIG. 15 to the form shown in FIG. 16, for instance, adds it to Elasticsearch bulk and bulk-loads this into Elasticsearch once the batch size reaches the configured “batchNum”, or the “batchDelay” timeout.

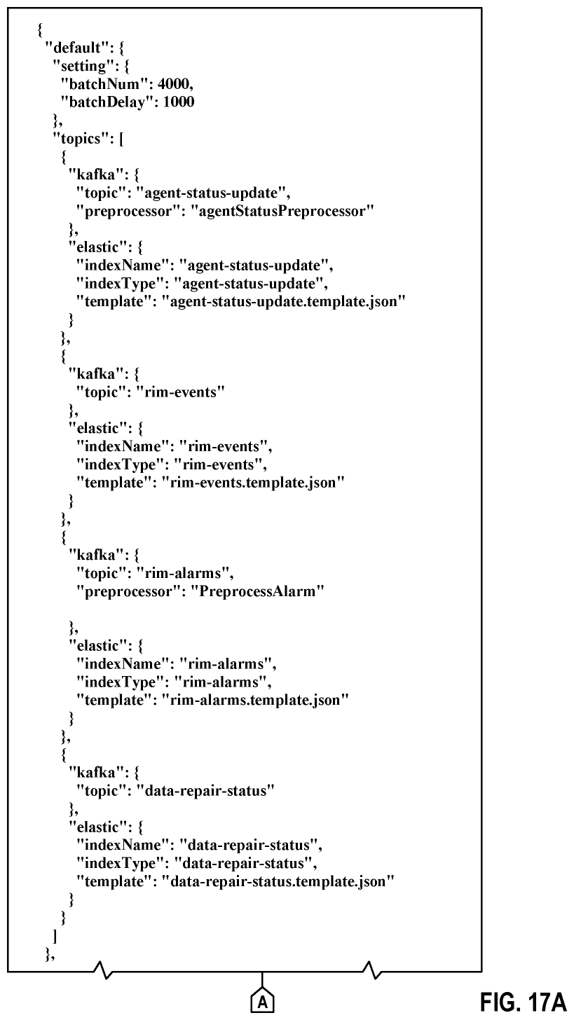

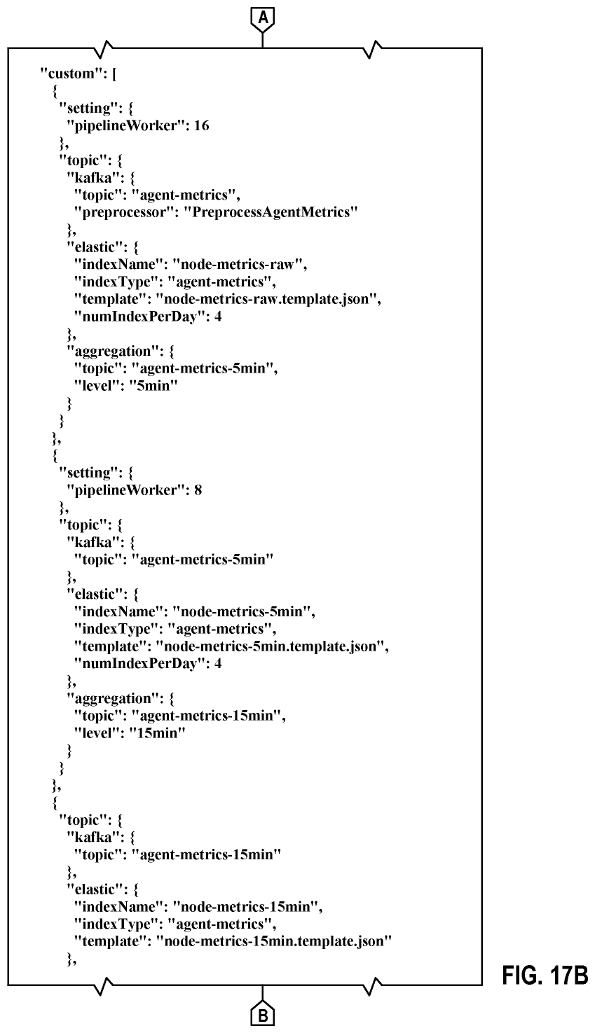

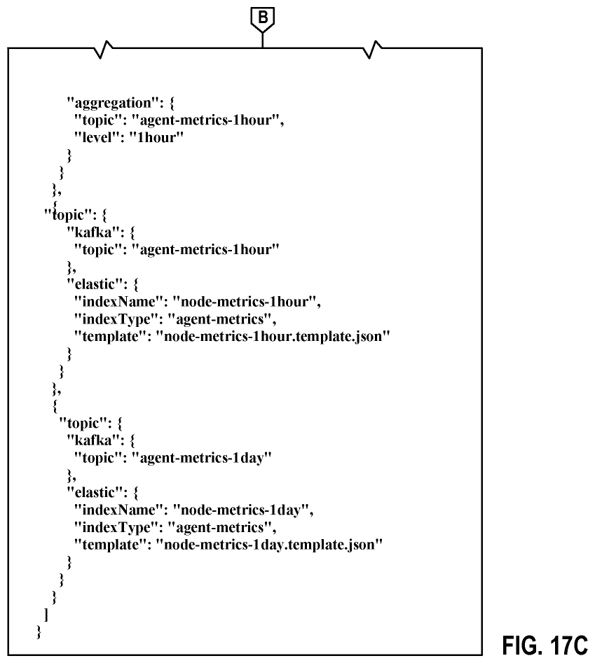

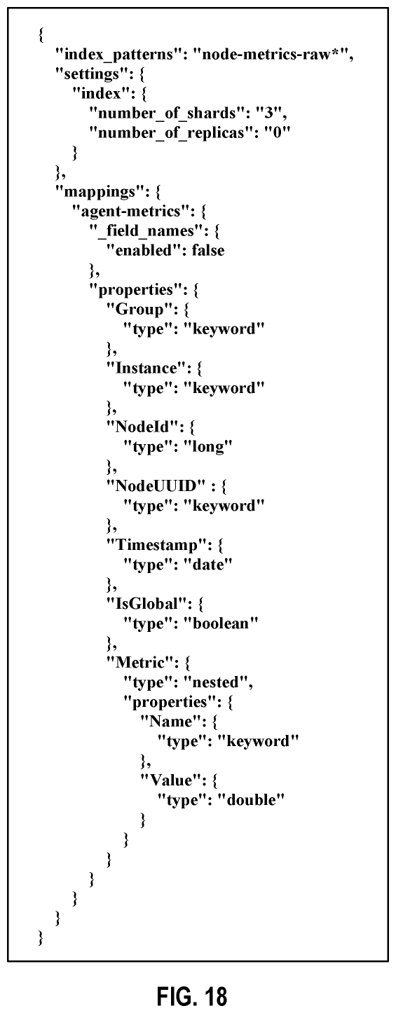

The Metric and Data Ingest Service 40 processing pipeline is preferably designed in a generic manner, such that it is completely configuration driven. To ingest new kafka (Message Bus) topics, the only changes required are pipeline configuration and Elasticsearch index template definitions. An example pipeline configuration is provided at FIG. 17a-c, and an example of an index template definition is provided at FIG. 18.

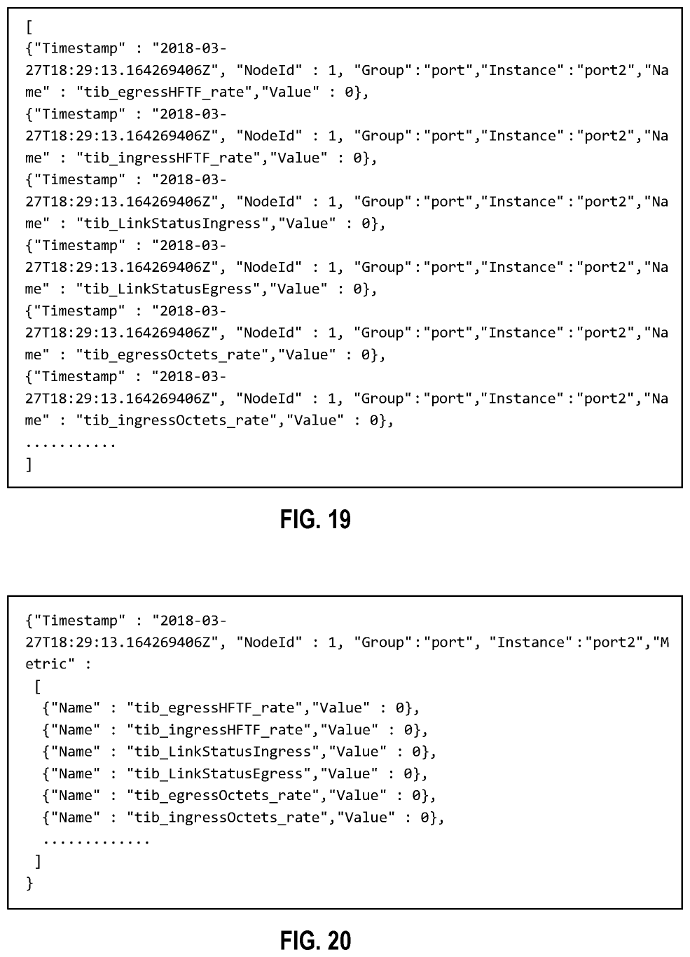

Thus, as noted above, the Metric and Data Ingest Service 40 can transform the node metrics (e.g. to a data-interchange format of the current view (e.g. JSON version)) and index them (i.e. with a timestamp) in the Temporal Datastore 30 (e.g. Elasticsearch). Specifically, the Elasticsearch data format is defined in template files, and in some cases there may be a one-to-one mapping between kafka message format to the Elasticsearch data format. A user can simply define and implement a “preprocessor” to transform the data as needed. As another example, a node metrics kafka message may consist of an array in the form shown at FIG. 19. This data, however, is very repetitive, and to store this directly into Elasticsearch would use up a significant amount of storage resources. By consolidating the data into a “nested object” format supported by Elasticsearch (see e.g. FIG. 20), a significant reduction in storage space usage can be realized. Querying data in a nested object format is also generally more efficient.

Storage of data in the Temporal Datastore 30 (e.g. Elasticsearch) is what enables ANM to recall network health in a temporal manner. In particular, if a user wishes to view the state of node(s) and topology at a particular time in the past, the Node Health and Telemetry Aggregator 15 may query the Network Topology Service 25, Alarm Service 20, and Node Telemetry Service 60 (which provides a query interface into the node metrics repository in Elasticsearch; see e.g. FIG. 5), which are all backed up by the Temporal Datastore 30 at a particular timestamp, and this historical node status and topology information can be relayed to the user through a UI via the API Gateway 75 (see FIG. 6), discussed in more detail below.

As the Metric and Data Ingest Service 40 continues to ingest real time node metrics at a given time interval (which may preferably be set by a user), any updated/change in status or topology event for a node is published to the Topology Database 97 and Temporal Datastore 30 as discussed above (i.e. the information in these databases is updated as needed), and the event is also published to the Message Bus 10 so that the GUI visualization can be updated in near real-time accordingly (discussed more in detail below). In this respect, the API Gateway 75 maintains an open connection with Websocket API 65 (see FIG. 6) to receive updates pushed up by the Websocket API 65. Websocket API 65 preferably has two important mechanisms of note. The first is a polling mechanism: every 10 seconds, for instance, the Websocket API 65 will poll the Node Health and Telemetry Aggregator 15, check if the results have changed since last time, and push any changes up to the API Gateway 75. Secondly, the Websocket API 65 may read events from the Message Bus 10, filter out those that are not relevant to the UI's search query, then push them up to the API Gateway 75. This second method scales better for network expansion and provides a more responsive experience to clients of the Websocket API 65, as the Websocket API 65 then only needs to act when there are changes actually published by the Network Topology Service 25.

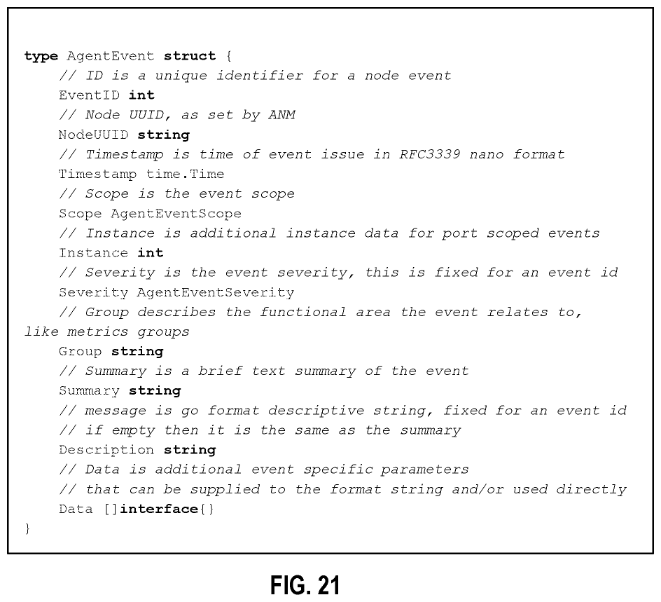

In terms of the health status of nodes and their ports, the Alarm Service 20 will raise an alarm if any node telemetry data crosses a node metrics threshold (e.g. network card temperature reading), or if there is an event or change to the network topology during a time interval, for instance. The Alarm Service 20 reads raw telemetry published by nodes over the Message Bus 10 (agent-metrics kafka topic) from the Node API 16 (see FIG. 7). This telemetry is used to track thresholds and raise threshold crossing alarms if certain configured conditions are met (discussed below). The Alarm Service 20 also reads events published by nodes over the Message Bus 10 (agent-events kafka topic; see FIG. 7) and can raise alarms if configured to do so when a given event is published by the node (e.g. node restart). Agent events are more particularly described at FIG. 21, and are differentiated on the Message Bus 10 because they are broadcast on different topics, and services can assume that they will only find agent events on the agent-event topic. Alarms raised based on node events will be cleared after a configurable duration if the event is not repeated. The Alarm Service 20 further reads topology changes over the Message Bus 10 (agent-status-update kafka topic) from the Network Topology Service 25, where alarms are raised for some topology changes, such as port disconnections, loss of communication, or new nodes joining the network.

The basic design is for the Alarm Service 20 to keep an in-memory cache of the current status for all nodes. The Alarm Service 20 will listen to the agent-metrics stream on the Message Bus 10 from the Node API 16 and run its “rules” to determine if the status for the node in question has changed for itself or any of its links. These “rules” (otherwise known as threshold crossing alarms, or TCAs) are stored by the Configuration Service 50. Each time a status changes for a given node an event is published on the Message Bus 10 for that change (see Kafka: rim-events in FIG. 7) and a new status plus description is pushed to the Temporal Datastore 30 (e.g. Elasticsearch) with the timestamp associated to the metric causing the change (see FIG. 11). Status documents in Elasticsearch are preferably per node.

Any raised alarms are also pushed to the Node Health and Telemetry Aggregator 15 and API Gateway 75 (see REST: Event & Alarm API in FIG. 7). When queried by a client, the Node Health and Telemetry Aggregator 15 will accordingly assign a new health status commensurate with the alarm for the node or every port on the node for the time interval and reply to the query with the node's health status. It is thus the Node Health and Telemetry Aggregator 15 (see FIGS. 6 and 7) that is responsible for assessing node and port health and does so on demand at query time. The Node Health and Telemetry Aggregator 15 also receives network topology data from the Network Topology Service 25 (see FIG. 5). The health status is combined with the network topology data at query time and returned to the client via the API Gateway 75. This is what allows the GUI to display those nodes for which a health issue has been raised, along with nodes to which they are linked (i.e. neighbour nodes). A client may request a snapshot of network topology and health data at a specified point in the past, or it may use the Websocket API 65 (see FIG. 6) to subscribe to periodic updates to the state of the network and its health.

In terms of node health, the health status of any node or port in the network is preferably determined by the alarms currently active/open against that node or port. A simple mapping calculation is applied to map the severity and number of alarms to make a health determination. Alarm severities may include, for instance: critical; major; minor; and info. Health statuses may include, for instance: error; warning; ok; or unknown (when node state is not “enrolled” or “maintenance”).

Health status (intentionally) does not map one-to-one with alarm severities, and the following mapping may, as an example, be applied to derive the health status of a node:
One or more Critical alarms results in an Error health status
One or more Major alarms results in an Error health status
One or more Minor alarms results in a Warning health status
Five or more Minor alarms results in an Error health status

The preferred AMN model has an ownership/parent-child relationship—nodes own ports. Therefore, any health status of a child (port) will bubble up to the parent (node) using a simple set of rules. The health of a node is represented by the highest/worst health status of the node and may be determined by the above-noted health mapping or the following health bubbling.

Health bubbling rules may include:
If <50% of ports have non-ok health status the node is assigned a “Normal” health status as determined by the alarms currently active on that node.
If >=50% of ports have a non-ok health status the node is assigned a health status of “Warning” or the health status as determined by alarms on the node (whichever is worse).
If 100% of ports have non-ok health status the node is assigned as “Error”.

The Node Health and Telemetry Aggregator 15 or UI will then calculate a health score for each of the nodes or every port on each of the nodes based on the assigned health status for the time interval. The health calculation can be straightforward. For each node and port the associated health state/status may be mapped to a numerical value. The sum of the values can represent the “scale” (i.e. size) of the node as presented. The higher the sum the more “unhealthy” the node is determined to be. An exception to this may be if node state/health status is “unknown” then a high scale may be assigned regardless to indicate that it is of concern and equivalent to a node which is in a major error condition. Example numeric conversion from health state/status could be, for instance: ok is 1, warning is 5, error 10, and unknown is 10. The numerical increments are intended to ensure that each progressive level of health degradation is much more pronounced from the previous in cumulation (i.e. it would, for instance, take 2 ports of a node in a warning state to be equal to a single port in error state to be “equivalently” comparable in priority).

Of course, the skilled person would understand that UI visualizations could potentially be based simply on alarm severities, health status, health scores, or the like, in order to convey health condition under various implementations and the needs of network administrators.

Based on the health scores received from the Node Health and Telemetry Aggregator 15 via the API Gateway 75, the UI will determine what the visualization should look like, and will then display on a graphical user interface a visual representation of the health of the direct interconnect network for the time interval. The visual representation could include a color representation of nodes or every port on such nodes to reflect the health score of such nodes or ports and to convey a health condition to a network administrator. The nodes or ports may be further scaled in size relative to the health condition to allow for easy identification of nodes that are in a poor health condition and that require attention by the network administrator, and may further include visual links between nodes to represent node connections and the network topology. Examples of this are provided later in the detailed disclosure.

More particularly, a query is made by the UI reflecting the desired temporal snapshot requested by the user. A response from the Node Health and Telemetry Aggregator 15 will provide all the node health and connectivity information required for the UI to render the graph visualization. Using the health score as calculated, the UI will leverage WebGL/SVG rendering libraries to “draw” the nodes and network as desired, and as described by the data that has been provided. The use of WebGL/SVG rendering libraries to present a GUI visualization is well known to persons skilled in the art. However, the specific visual representations drawn by ANM to depict network/node health, as shown in later Figures, are novel.

In terms of deployment, the various software components that comprise ANM 1 may be contained on one or more nodes 5 within the direct interconnect network. Thus, as an example, in one embodiment the ANM system of the present invention may be used in association with a direct interconnect network implemented in accordance with U.S. Pat. Nos. 9,965,429 and 10,303,640 to Rockport Networks Inc., the disclosures of which are incorporated in their entirety herein by reference. U.S. Pat. Nos. 9,965,429 and 10,303,640 describe systems that provide for the easy deployment of direct interconnect network topologies and disclose a novel method for managing the wiring and growth of direct interconnect networks implemented on torus or higher radix interconnect structures.

The systems of U.S. Pat. Nos. 9,965,429 and 10,303,640 involve the use of a passive patch panel having connectors that are internally interconnected (e.g. in a mesh) within the passive patch panel. In order to provide the ability to easily grow the network structure, the connectors are initially populated by interconnect plugs to initially close the ring connections. By simply removing and replacing an interconnect plug with a connection to a node 5, the node is discovered and added to the network structure. If a person skilled in the art of network architecture desired to interconnect all the nodes 5 in such a passive patch panel at once, there are no restrictions—the nodes can be added in random fashion. This approach greatly simplifies deployment, as nodes are added/connected to connectors without any special connectivity rules, and the integrity of the torus structure is maintained. The ANM 1 could be located within one or more nodes 5 in such a network.

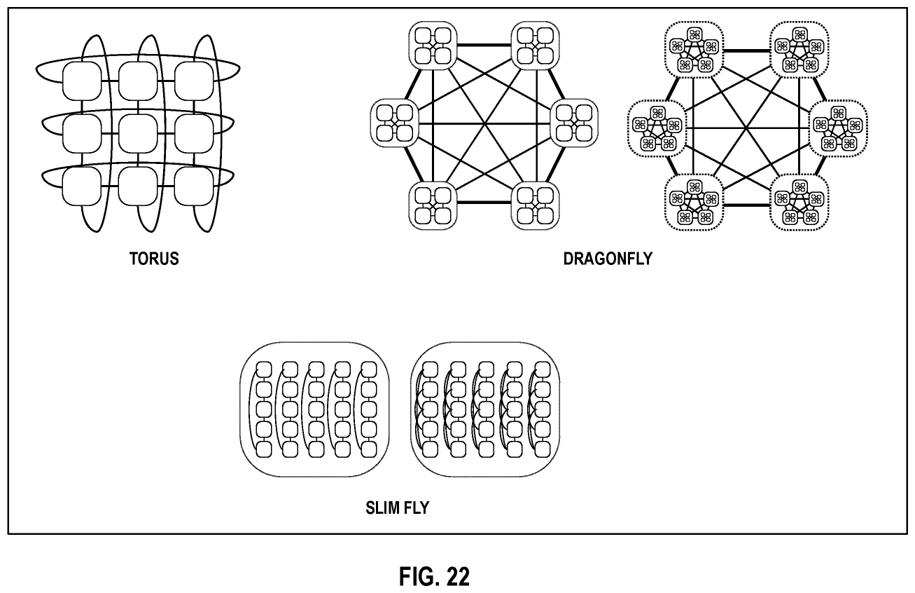

In a more preferred embodiment, the ANM system of the present invention may be used in association with devices that interconnect nodes in a direct interconnect network (i.e. shuffles) as described in International PCT application no. PCT/IB2021/000753 to Rockport Networks Inc., the disclosure of which is incorporated in its entirety herein by reference. The shuffles described therein are novel optical interconnect devices capable of providing the direct interconnection of nodes 5 in various topologies as desired (including torus, dragonfly, slim fly, and other higher radix topologies for instance; see example topology representations at FIG. 22) by connecting fiber paths from a node(s) to fiber paths of other node(s) within an enclosure to create optical channels between the nodes 5. This assists in optimizing networks by moving the switching function to the endpoints. The optical paths in the shuffles of International PCT application no. PCT/IB2021/000753 are pre-determined to create the direct interconnect structure of choice, and the internal connections are preferably optimized such that when nodes 5 are connected to a shuffle in a predetermined manner an optimal direct interconnect network is created during build-out.

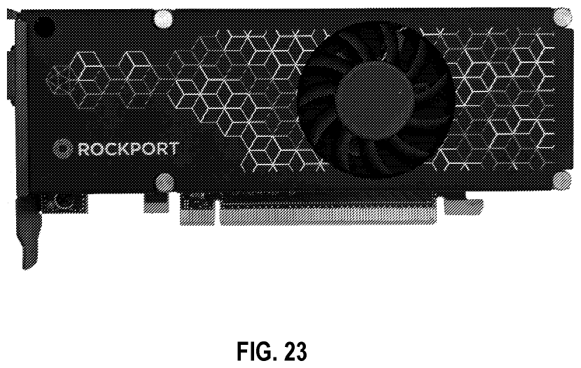

The nodes 5, as previously discussed, may potentially be any number of different devices, including but not limited to processing units, memory modules, I/O modules, PCIe cards, network interface cards (NICs), PCs, laptops, mobile phones, servers (e.g. application servers, database servers, file servers, game servers, web servers, etc.), or any other device that is capable of creating, receiving, or transmitting information over a network. As an example, in one preferred embodiment, the node may be a network card, such as the Rockport RO6100 Network Card, a photo of which is provided at FIG. 23. Such network cards are installed in servers, but use no server resources (CPU, memory, and storage) other than power, and appear to be an industry-standard Ethernet NIC to the Linux operating system. Each Rockport RO6100 Network Card supports an embedded 400 Gbps switch (twelve 25 Gbps network links; 100 Gbps host bandwidth) and contains software that implements the switchless network over the shuffle topology (see e.g. the methods of routing packets in U.S. Pat. Nos. 10,142,219 and 10,693,767 to Rockport Networks Inc., the disclosures of which are incorporated in their entirety herein by reference).

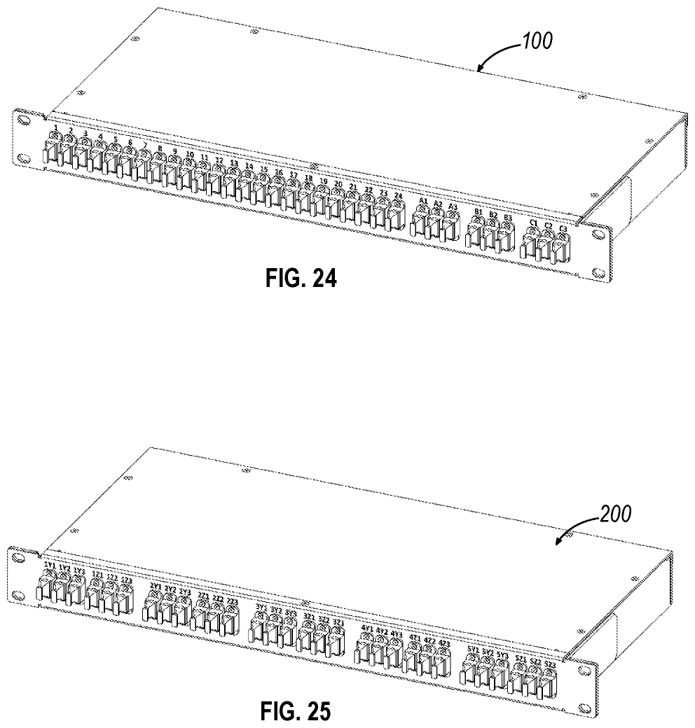

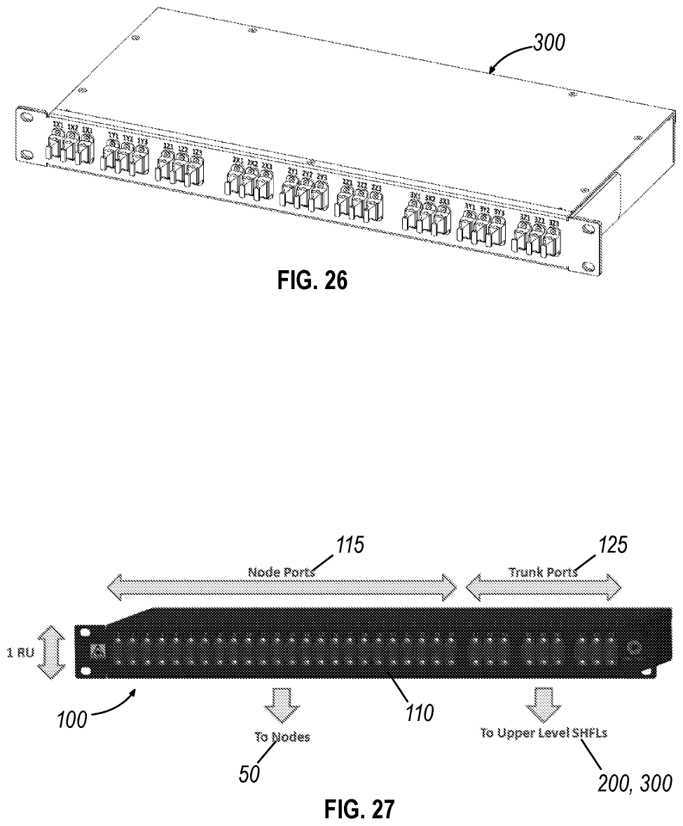

An example lower level shuffle 100 (LS24T), as fully disclosed in International PCT application no. PCT/IB2021/000753 to Rockport Networks Inc., is shown at FIG. 24. The LS24T lower level shuffle 100 embodiment implements a 3-dimensional torus-like structure in a 4×3×2 configuration when 24 nodes are connected to the shuffle 100. Dimensions 1, 2, and 3 are thereby closed within the shuffle 100, and dimensions 4, 5, and 6 are made available via connection to upper level shuffles (see e.g. US2T 200 (FIG. 25) or US3T 300 (FIG. 26)). More specifically, with reference to FIG. 27, externally the LS24T lower level shuffle 100 has a faceplate 110 that exposes 24 node ports 115 and 9 trunk ports 125. The 24 node ports 115 are either externally connected to nodes 5 that will be interconnected within the shuffle (e.g. network cards such as Rockport RO6100 Network Cards) or are otherwise populated by first-type or primary R-keys (not shown) that maintain inline connections. Nodes 5 (e.g. Rockport RO6100 Network Cards) may connect to a lower level shuffle 100 at node ports 115 via, for example, an optical MTP® (Multi-fiber Pull Off) connector (24-fiber) through an OM4, low loss, polarity A cable, with female ends. This 24-fiber cable supports links and 6 dimensions. The 9 trunk ports 125 are either externally connected to upper level shuffles (e.g. 200, 300) for network or dimension expansion (and not to nodes 5 or other lower level shuffles 100) or may otherwise preferably be populated by second-type or secondary R-keys (not shown) that provide “enhanced connectivity”—cut through paths or short cut links within the fabric by creating offset rings. The ports 115, 125 are connected on the internal side of faceplate 110 to internal fiber shuffle cables (not shown) that are fiber cross connected preferably using a fiber management solution, wherein individual fibers from each incoming port 115, 125 are routed to outgoing fibers to implement the desired interconnect topology. Thus, when nodes 5 are connected to node ports 115, it is essentially the fiber cross connections of the internal fiber shuffle cables that directly interconnects the nodes 5 to one another in the pre-defined network topology.

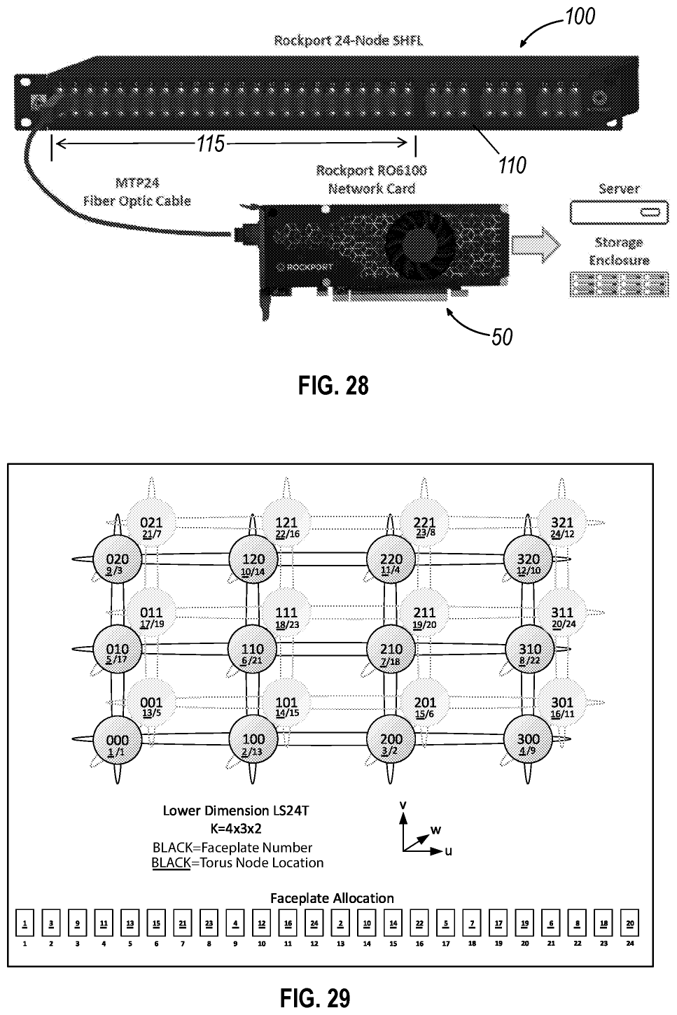

In order to build out the direct interconnect network (when shuffle 100 has a preferred internal wiring design), a user will simply populate the node ports 115 in a pre-determined manner, e.g. from left to right across the faceplate 110, with connections to nodes 5 as shown in FIG. 28, removing the first-type or primary R-keys (not shown) as they progress (i.e. the primary R-keys remain in place in the node ports 115 of lower level shuffle 100 unless and until a node 5 is to be added to the network in a sequential manner). This allows the torus structure (in this example) to be built in an optimal manner, ensuring that as the torus is built up it is done with a minimum/optimal set of optical connections between nodes 5 and no/minimal open fiber gaps between nodes 5 (to maximize performance). Specifically, connecting nodes 5 from left to right across the faceplate 110 builds the example torus logically from a 2×2×2 configuration to a 3×3×2 configuration to a 4×3×2 configuration. There is no practical minimal limit on how many nodes 5 are required to create an interconnect, but 8 nodes are required to create a 2×2×2 torus configuration.

Such an optimal build out can be explained with reference to FIG. 29, which displays a representative 4×3×2 torus configuration (having u,v,w coordinates). The numbers below the boxes in the “Faceplate Allocation” represent the 24 node ports 115 numbered sequentially on the faceplate 110 of LS24T lower level shuffle 100, while the numbers within the boxes represent the node location within the notional torus structure as depicted. Thus, when the primary R-key (not shown) at node port #1 of node ports 115 is replaced with a connection to a node 5, the node 5 is added to node location #1 (0,0,0) within the torus structure. When the primary R-key (not shown) at node port #2 of node ports 115 is replaced with a connection to another node 5, the node 5 is added to node location #3 (2,0,0) within the torus structure. When the primary R-key (not shown) at node port #3 of node ports 115 is replaced with a connection to yet another node 5, the node 5 is added to node location #9 (0,2,0) within the torus structure, etc. This process may continue in accordance with FIG. 29 until all 24 node ports 115 are sequentially connected from left to right across the faceplate 110 with connections to nodes 5. As each node 5 is added to each node port 115, the internal wiring of the shuffle 100 ensures that it is placed at an optimal location within the torus to maximize the performance of the resulting topology. For a torus, a balanced topology with each dimension having the same number of nodes provides maximum performance. Thus, the LS24T lower level shuffle 100 is wired to create a topology that is as close to balanced as possible for the number of nodes 5 connected to the shuffle. It is thus the desired build out of the direct interconnect structure as nodes 5 are added to the network that dictates how the shuffle 100 should be internally wired to interconnect the nodes 5.

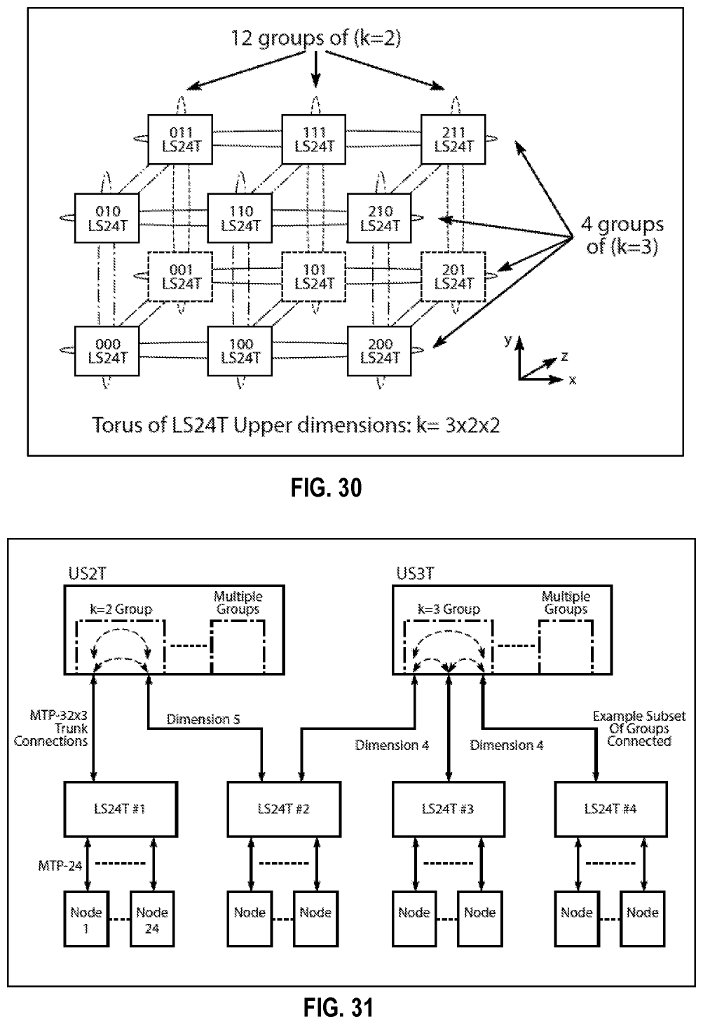

Each of the upper level shuffles 200, 300 provides a number of independent groups of connections for creating k=n torus single dimension loops, where n is 2, 3, or more. In the non-limiting examples, an upper level shuffle 200 (US2T) contains 5 groups and an upper level shuffle 300 (US3T) provides 3 groups, respectively. FIG. 30 illustrates how a set of 12 lower level shuffles 100 (LS24T) may be connected in a (4×3×2)×3×2×2 torus configuration for a total of 288 nodes. This illustration shows the torus comprises 12 edge loops (groups) of k=2 and 4 groups of k=3. Each of these groups is formed by connecting trunk ports 125 of a lower level shuffle 100 (LS24T) for a single dimension to an upper shuffle group. FIG. 31 illustrates that an upper level shuffle 200 group (US2T) may be used to form a k=2 loop between lower level shuffles 100 (e.g. LS24T #1 and #2) using one set of upper dimension trunk connections, while an upper level shuffle 300 group (US3T) is used to form a k=3 loop between lower level shuffles 100 (e.g. LS24T #2, #3 and #4) using another set of trunk connections for a different dimension.

A single node deployment for the ANM 1 is possible by, for instance, incorporating the ANM 1 on a node 5 connected to a node port 115 on a lower level shuffle 100 in the direct interconnect network as described in International PCT application no. PCT/IB2021/000753. In such a deployment, in some network topologies it may be advisable to locate the ANM 1 on a node 5 that is more centralized within the direct interconnect network structure to minimize average overall hop counts. With the example LS24T lower level shuffle 100, and with reference to FIG. 29, it may thus be advisable for instance, in certain circumstances, to locate the ANM 1 on a node 5 connected to one of node ports #18, 20, 21, or 23 of node ports 115, which corresponds to the notional torus node locations #7, 19, 6, or 18 within the torus structure. This could provide a minimum average hop count from the node 5 hosting ANM 1 to other nodes 5 within the example direct interconnect structure, particularly if some node ports 115 are not populated by nodes.

Of course, the location of ANM 1 on a node 5 depends on the design of the shuffle(s) used and the network topology created by the optical connections therein. Based on the detailed teachings in International PCT application no. PCT/IB2021/000753 to Rockport Networks Inc., a person skilled in the art would be able to implement any number of different embodiments or configurations of shuffles that are capable of supporting a smaller or much larger number of interconnected nodes in various topologies, whatever such nodes may be, as desired. As such, the skilled person would understand how to create shuffles that implement topologies other than a torus mesh, such as dragonfly, slim fly, and other higher radix topologies. Moreover, a skilled person would understand how to create shuffles that internally interconnect differing numbers of nodes or clients as desired for a particular implementation, e.g. shuffles that can interconnect 8, 16, 24, 48, 96, etc. nodes, in any number of different dimensions etc. as desired. The skilled person would accordingly be able to determine the optimal node(s) 5 for locating ANM 1.

For a higher-availability deployment, ANM 1 could possibly instead, for example, be deployed across a 3-node cluster, which would enable ANM 1 to provide for reasonable recovery from node loss or for the loss of individual services. From an operational perspective, ANM 1 could be designed to survive the failure of one of the three clustered nodes. ANM 1 could also support a deployment model whereby key components are replicated across the nodes 5 of the ANM cluster. Such key components could include, for example, a Kafka® messaging bus, and an ANM data ingestion micro service, among others.

All other ANM microservices could continue to operate as a single instance service where, if a node 5 containing such service fails or if the service itself fails, a service orchestration tool (e.g. Kubernetes/OpenShift) could recreate the service(s) on one of the remaining nodes 5. During the period of failure detection and service re-creation, the specific functions of the service would be unavailable, however no data loss would have to occur in the overall system. If an entire ANM node failed within the cluster, there could be defined procedures and Ansible scripts (that automates software provisioning, configuration management, and application deployment), for instance, which would enable the cluster administrator to commission a new ANM node within the cluster. The newly established node would have the same configuration as the failed node, and would have the same IP address as the failed node.

It should be noted that in the case of a failure of the front-side network, or in the case of the Ethernet interface on a single node failing and isolating that node from the management network, the isolated node(s) of the ANM could potentially continue to process any incoming metrics or events received from the network nodes. Once communications with the front side network is re-established, the nodes could potentially reconcile data as required to ensure the ANM operation and historical data may be restored.

For WebSocket requests, the subscription requests could be, for example, round-robin balanced across the nodes in the ANM cluster based on when the request is received. If an instance of the WebSockets service on a given node failed, the TCP connection to the client would be closed, and the client would be responsible for reinitiating the WebSocket request to the cluster. Upon receiving a new request, that request could be load-balanced (e.g. in a round-robin manner) to one of the remaining WebSocket service instances. This would result in a worst-case scenario of the client receiving the full payload of the subscribed service again during the subscription period. In all other regards, the failure of an instance of the WebSocket service would be transparent to the client and the end user.

To ensure key services, such as the Network Topology Service 25, function correctly in a highly available ANM configuration, ANM 1 could have a monitoring service which ensures that the preferred card for the given ANM node 5 is functional. If this service determines that the network card is not functional or is unable to send/receive properly, this service could cause the Network Topology Service 25 to move to a different node 5 in the ANM cluster. Having the Network Topology Service 25 moved would be viewed as a change of “Primary Node” to the network, and would result in a message to the network advertising that the “Primary Node” has changed, and that it is now the node to which the service has moved. It is important to note that the service responsible for monitoring the health of the card should have special security permissions in e.g. an OpenShift environment, for instance, since it must be able to directly access the Ethernet interface in Linux, which represents the card.

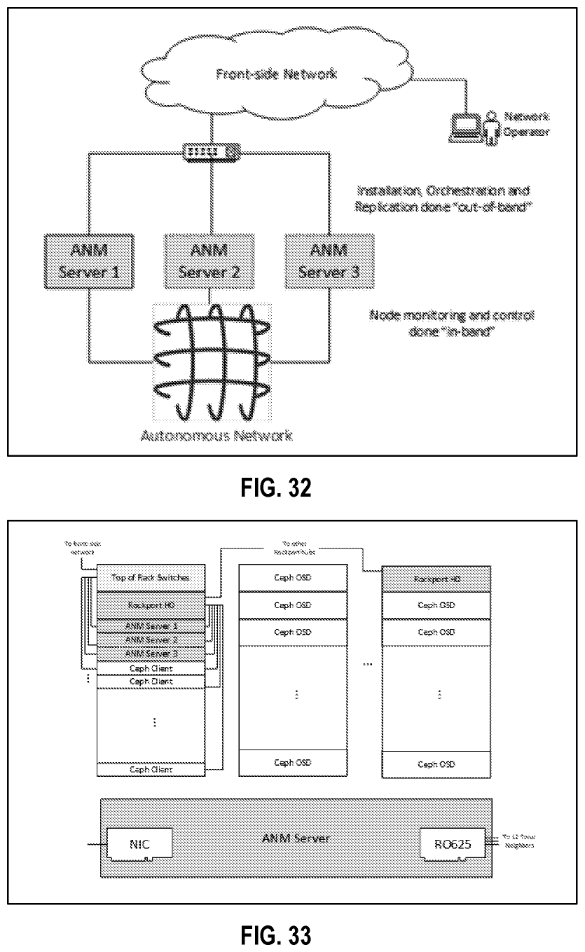

In order to implement the higher-availability deployment, the ANM servers could use a separate network for the replication and orchestration traffic, as depicted in FIGS. 32 and 33, which would allow for the installation of ANM over 3 servers without the need to separately bootstrap the cluster (or require a 2 phase ANM installation/deployment). With reference to the example provided at FIG. 33, the server(s) running ANM 1 (shown in the first rack) may be connected to both the fabric (e.g. through a card) and also, using a separate 1 GbE+ NIC for instance, to a separate management network providing access to the management capabilities of the ANM 1. In this respect, a person skilled in the art may appreciate that there may be some benefit to having the ANM servers collocated in the same rack to make them close to the Top of Rack (TOR) switches that provide front-side connectivity. However, there might also be reasons to distribute the location of the ANM servers to reduce the average round-trip between “regular” nodes and ANM nodes.

When accessing the ANM cluster this way, there are preferably two mechanisms leveraged, each serving a specific purpose. To access service tool operations and management functionality, for instance, a single Virtual IP address may be configured which floats amongst the three nodes. When accessing the operations and management interface, the Virtual IP address could be used to address one of the three nodes, and a service tool could ensure any configuration/changes/etc. are propagated to the other nodes in the cluster. A Linux application, such as Keepalived (routing software for load balancing and high-availability), may be installed across all three nodes, and would act to ensure the operations and management interface, via the Virtual IP address, is served from one of the nodes in the cluster. The second mechanism is the function interface, by which the ANM functionality itself is addressed/provided (here you could require 3 dedicated static IP addresses (one for each ANM node)). For routing all requests into ANM 1 from the management network, a hostname (e.g. management.anm01.net) may be mapped in the local DNS server to an SRV record which contains the 3 dedicated IP addresses (one for each ANM server “Front Side” interface). This hostname could then be used for UI and API calls to provide a single interface mechanism by which administrators and auditors are able to access the ANM 1.

The rare case of the simultaneous failure of multiple nodes within a cluster could lead to operational failure and data loss. To aid in mitigating the occurrence of an undetected node 5 failure, ANM 1 could potentially employ a “Cluster Health” interface which would allow an administrator to determine the status of each node within the ANM cluster (i.e. whether the node is running, healthy, and its performance), as well as determine the status of the services that compose ANM. For example, the administrator could be able to determine whether the Authentication Service 70 is running and which node it is on, or if the service is not running A “Cluster Health” view could potentially be made available from within the ANM UI, or as a simplified view as a separate interface.

Now that we have disclosed how the skilled person may implement the key functional components of an ANM system of the present invention (namely how to retrieve, store, analyze and act on node telemetry and status data), as well as how to deploy ANM within a direct interconnect network, we will provide examples of novel UI visualizations of the temporal state, health, topology and other attributes of the direct interconnect network nodes and/or elements thereof, in various temporally relevant dashboard formats. These UI visualizations are made possible because of the novel manner in which ANM collects, temporally stores, and analyzes the health of nodes and/or their ports. The ANM 1 dashboards preferably incorporate a timeline that controls the time window for the data that populates the dashboards. By default, the interface would show a real-time view of network information.

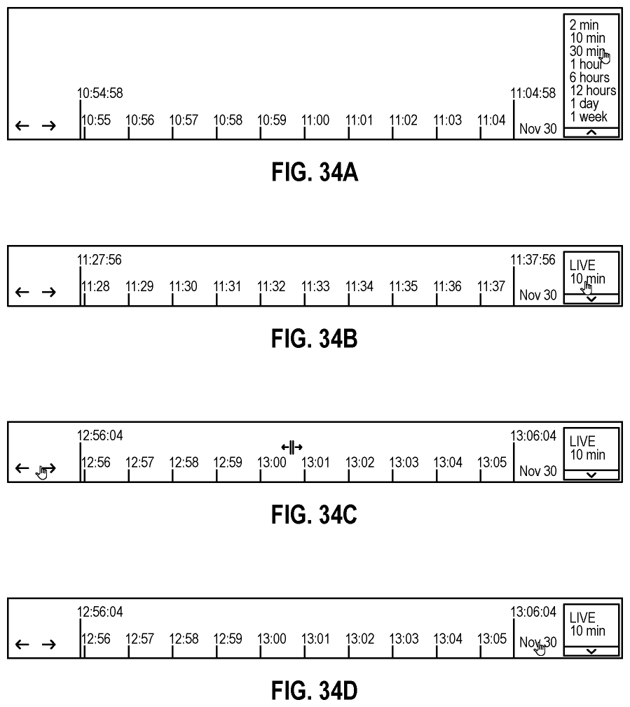

The timeline is helpful when you are investigating an issue with node(s) in the network. It lets you see the overall network topology at the time that the issue first occurred. In the case of a node failure, you can drag the timeline forwards and backwards in time (within the data retention period, e.g. 30 days) to see traffic and performance information for the node and neighboring nodes before/after the event. A variety of controls preferably allow a user to adjust the selected timeframe. For instance, the user may change the size of the time window (the granularity of the time scale) by selecting an increment (2 min, 10 min, 30 min, 1 hour, 6 hours, 12 hours, 1 day; see e.g. FIG. 34a). The displayed data reflects the time position at the right edge of the time window. The window may also provide a LIVE/PAUSED view (see e.g. FIG. 34b), where clicking LIVE freezes the time window to stop real-time updates (the button will now read PAUSED), and clicking PAUSED will return the time window to the current time and enable real-time updates (the button will now read LIVE). Preferably, the user may also drag the timeline left or right to focus on a period of historical interest (see e.g. FIG. 34c). The arrowhead buttons may be clicked to move forward and backward in the timeline by a time window increment. In addition, a user should preferably be able to jump to a specific date and time for which to see information (see e.g. FIG. 34d).

The following provides examples of how the ANM interface may appear and be operated by a network administrator given the temporal node telemetry data obtained and analyzed in a preferred embodiment of the present invention. The timeline as shown in FIGS. 34a-d may not be shown in certain Figures for ease of illustration.

Preferably the ANM interface has several dashboards to provide the network administrator with high-value information of the direct interconnect network. Example dashboards in a preferred embodiment include a Health dashboard, Node dashboard, Alarms dashboard, Events dashboard, Node Compare page, and Performance dashboard (each of which will be explained below).

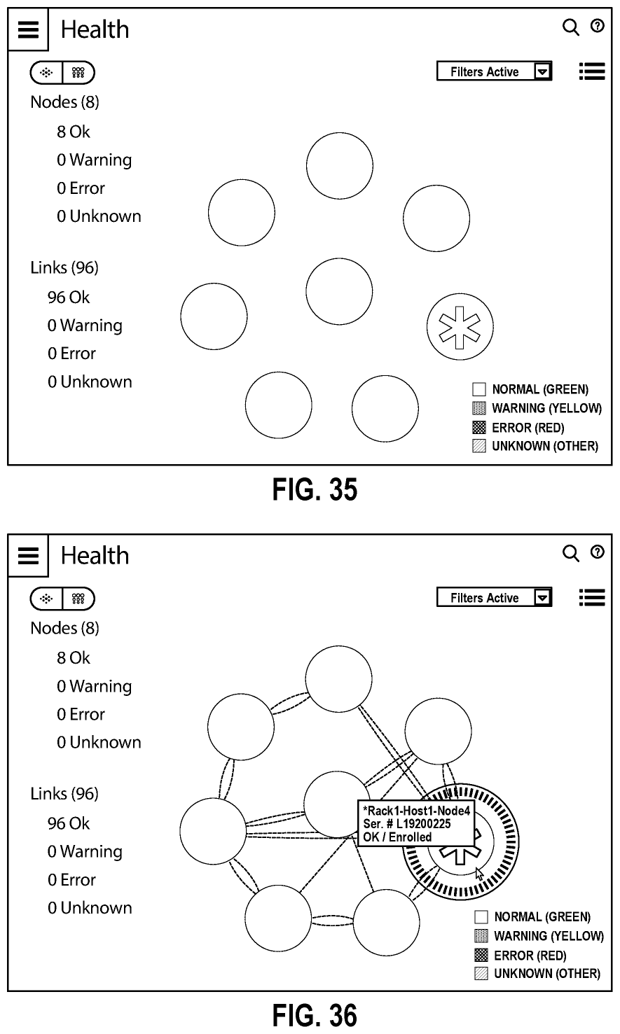

In one embodiment, the ANM interface provides a Health dashboard (see e.g. FIG. 35), which essentially identifies network issues and displays overall health status. Each of the 8 circles at FIG. 35 represents a node 5 (e.g. a Rockport RO6100 Network Card) that has been discovered and configured in the example direct interconnect network. In this example, the nodes are shown in green because they are in a normal/healthy state (more on the significance of color below). The node that is hosting and running ANM 1, referred to as the Primary Node, is denoted by the asterisk (*). The statistics on the left indicate the number of nodes 5 in the network and the number of links in the network. In this example, there are 96 links (8 nodes, each with 12 links). From this view, the administrator simply has to focus a mouse pointer on a particular node (hover over a node) to display the node's name, serial number, and status (as shown at FIG. 36). The lines indicate the links between the ports on the node to other nodes.

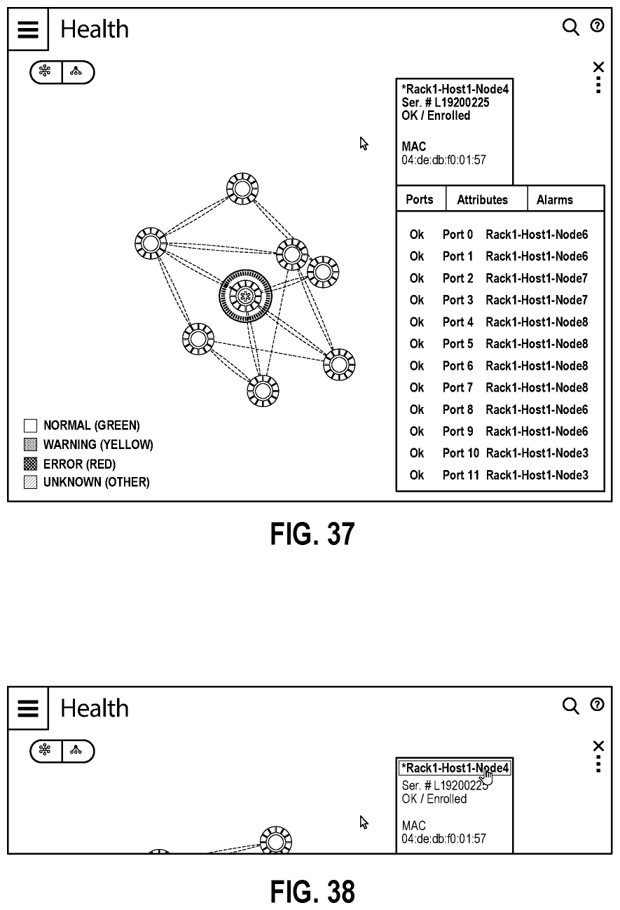

Selecting a node by clicking it provides more detail as shown in FIG. 37. More particularly, selecting a node moves it to the center of the screen with the visualization focusing on it and its neighbors (first and second degrees). The node inspection sidebar appears to the right of the topology. The sidebar contains basic properties for inspection and provides three information tabs: Ports, Attributes, and Alarms. The Ports tab provides information about the node ports and links. Hovering over any port row will highlight on the visualization the local and report port. The Attributes tab displays more detailed properties of the node, along with any custom attributes assigned to that node (e.g. inventory data, installation information such as a rack or shelf location, or whether the node was moved or upgraded). The Alarms tab displays alarms (discussed below) that are (or were) open for that node for the period of time being viewed. The number of segments in the band immediately around the central node circle represents the number of ports (links) for that node; in this case, twelve.

The administrator may also click on the node name in the properties sidebar (see e.g. FIG. 38) to open the Node dashboard (discussed in more detail below) to review more detailed information about the selected node (including metrics, link information, alarms, events, and more).

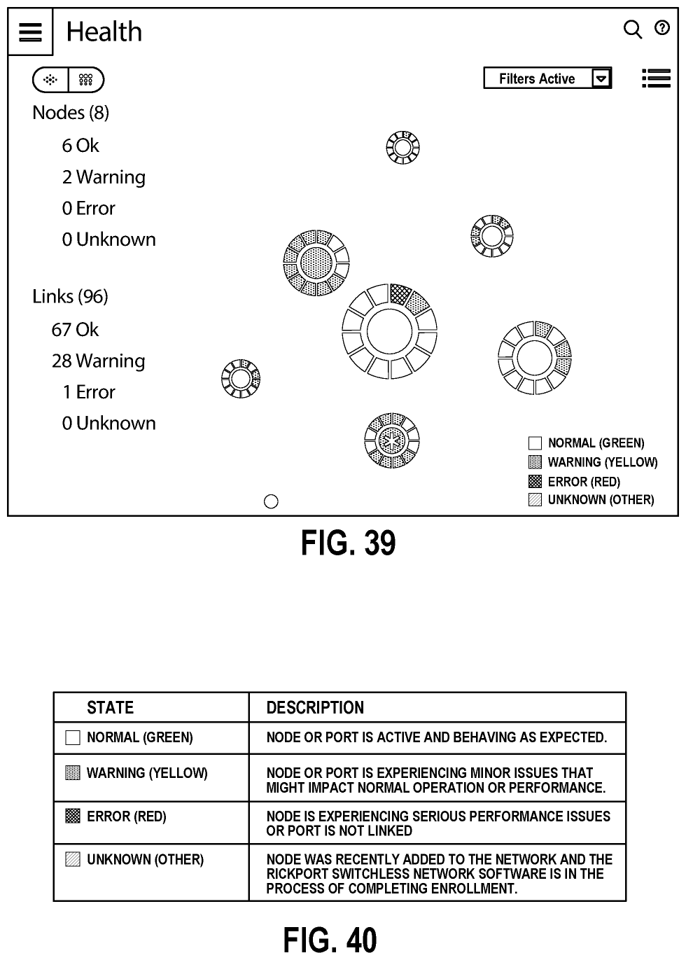

The color and size of the nodes in the Health dashboard is determined by the health of the node and its ports at the chosen time (see e.g. FIG. 39 which shows an 8-node network). More particularly, to assist in the identification of issues or problems, nodes with no identified health issues are visualized as solid green circles and those with health issues are expanded to display the node health (the inner circle) along with the health of each port on the node (the outer ring segments). Health issues on the node and ports are indicated by the assigned color. Nodes are also sized relative to the criticality of their health status. The larger nodes are deemed to have worse health than smaller nodes. The table at FIG. 40 summarizes the colors used and what each represents.

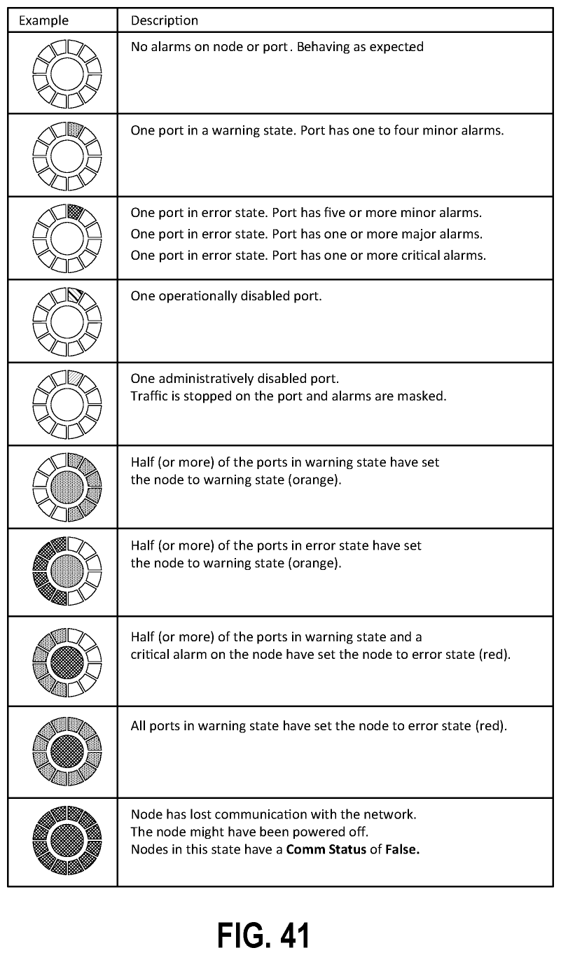

To aid in maintaining optimal network performance, alarms are raised when node issues occur. The alarm state determines health status and determines the colors that are displayed in the Health dashboard. The table at FIG. 41 provides examples and explanations of node and port color coding that may be used.

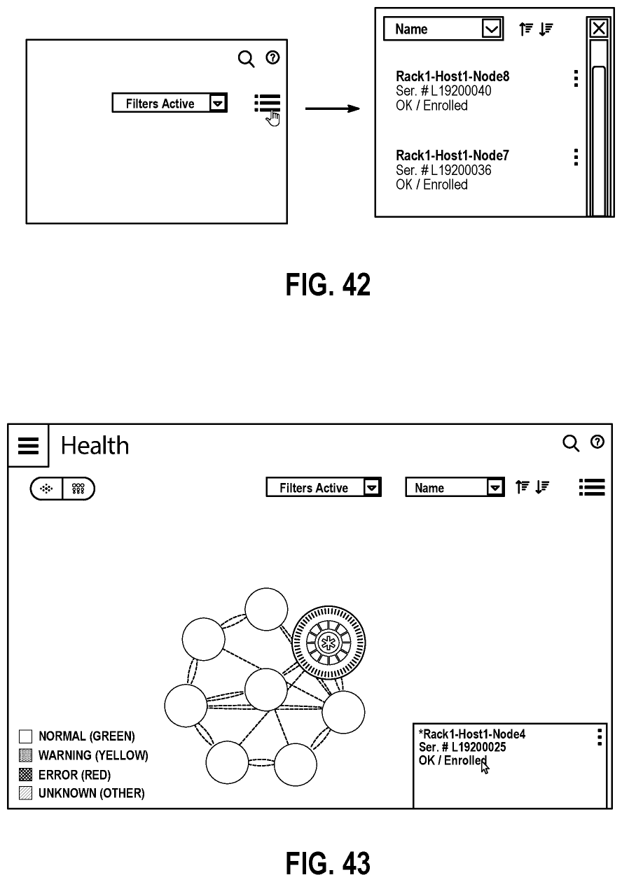

Clicking on a Node List button on the Health dashboard should preferably display the list of nodes matching any current search and filter criteria in the direct interconnect network (see e.g. FIG. 42). Hovering the mouse pointer over one of the nodes in the list should give the node focus; that node and nodes that it is linked to (neighbors) are highlighted in the live node topology chart (see e.g. FIG. 43).

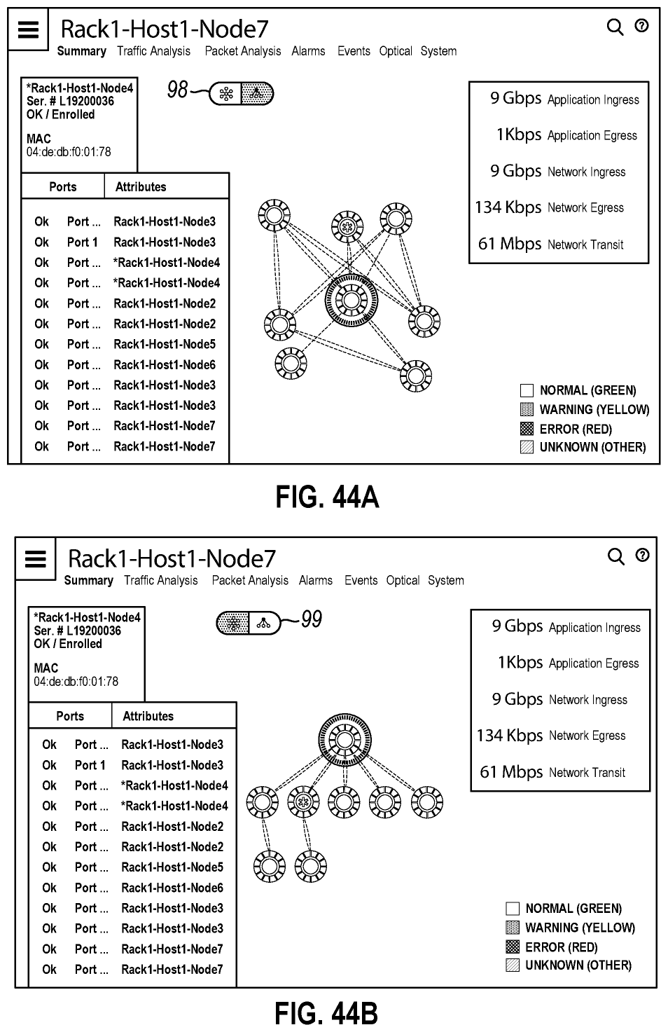

The Node dashboard provides an overview of a particular node's status, properties, port connectivity, traffic flow, and more. The visualization can be toggled between a graph view by way of a graph view button 98, wherein the node in focus is centered, and neighbors are displayed in a graph that spreads out from the selected node (see e.g. FIG. 44a), and a tree view by way of a tree view button 99, wherein the node in focus is at the top of a tree structure, and its first degree neighbors appear directly below, with the second degree neighbors at the bottom (see e.g. FIG. 44b). The Node dashboards preferably provide several sub-dashboards for a selected node in a preferred embodiment, including Summary, Traffic Analysis, Packet Analysis, Alarms, Events, Optical, and System sub-dashboards (described below).

The Summary sub-dashboard provides detailed health, statistics, telemetry, and attributes for a selected node. It includes the topology/health visualization for the node in focus (see e.g. FIGS. 44a and b).

The Traffic Analysis sub-dashboard provides several graphical views of the application ingress and egress traffic, and network ingress and egress traffic, including traffic rates, traffic drops, and distribution. Application traffic refers to traffic generated/received by a host (e.g. a server with a Rockport RO6100 Network Card installed) and sent/received from the direct interconnect network. Application ingress is traffic received from the network (ultimately another host) and delivered to the host interface. Application egress is traffic received from the host interface destined for another host in the network. Network traffic refers to traffic injected into and received from within the direct interconnect network. This traffic could have originated from another host and not actually be destined for the host being monitored (proxied traffic). Network ingress is traffic received from one or more network ports. Network egress is traffic sent out on one of the network ports. Proxied network traffic refers to traffic received on a network port and forwarded out a different network port (that is, traffic that originates on another host and is ultimately destined for a different host). Six Traffic Analysis sub-dashboards are preferably provided, including a Rate, Range, Utilization, QOS, Profile, and Flow dashboard.

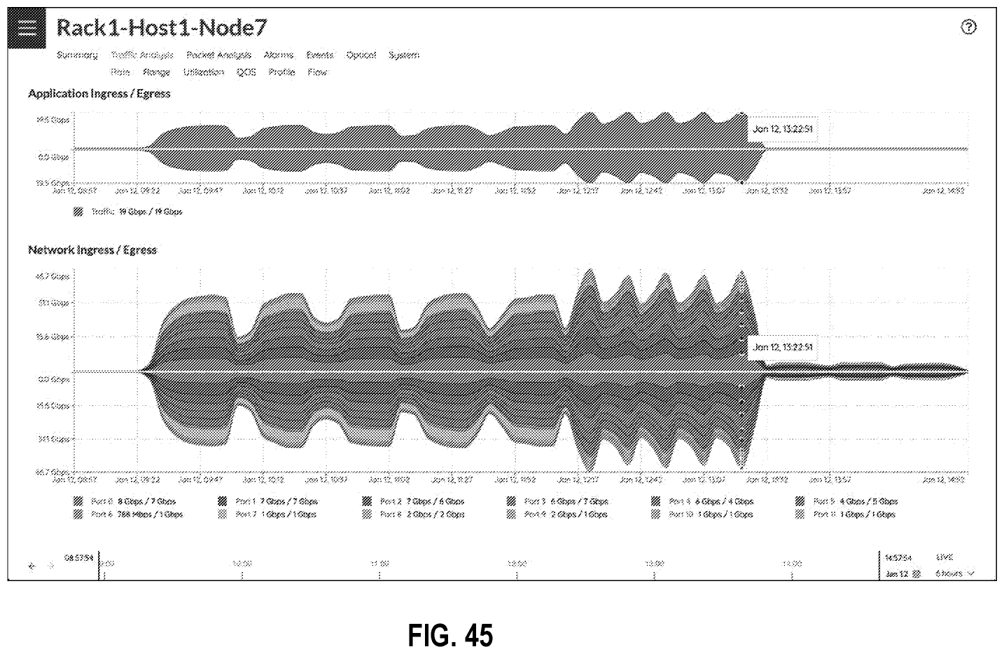

The Rate sub-dashboard visualizes the rates of traffic. Egress and ingress traffic are broken down by application and network (see e.g. FIG. 45).

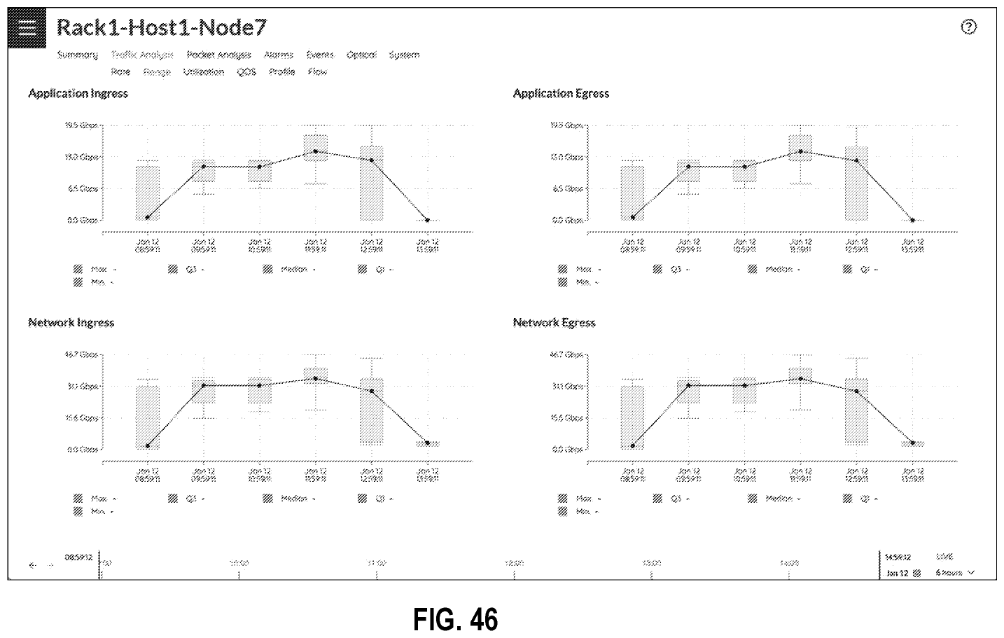

The Range sub-dashboard visualizes the aggregate range of traffic rates over the time period being viewed (see e.g. FIG. 46). Egress and ingress traffic is broken down by application and network. It shows the volume of traffic on the node facilitated by application traffic and network traffic through the node. This data is presented using box plot charts. Box plots return five statistics for each time bucket (minimum, maximum, median, first, or lower quartile, and third or upper quartile).

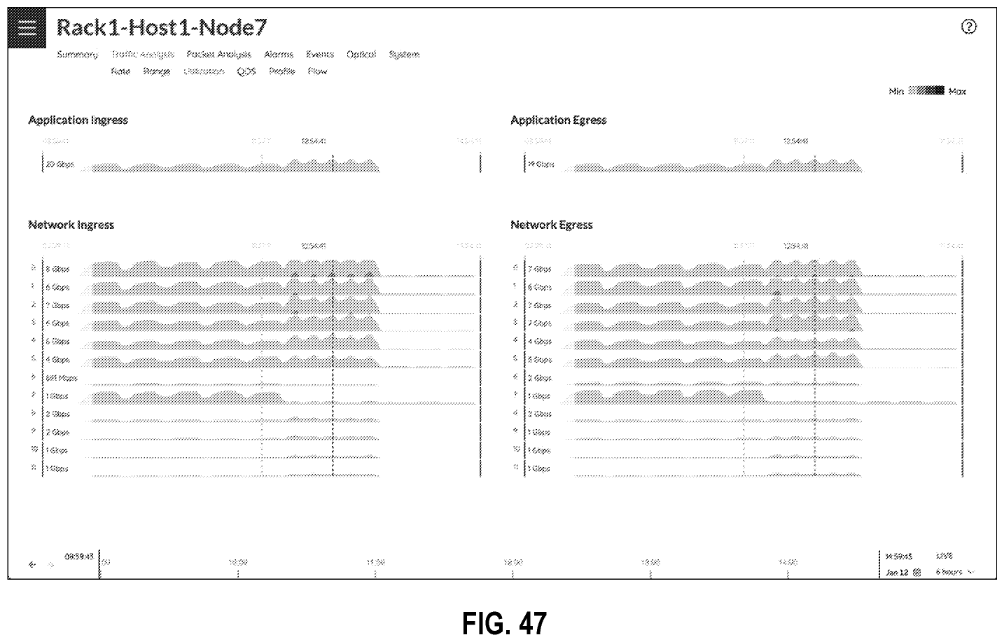

The Utilization sub-dashboard visualizes the volume of traffic against the maximum possible (see e.g. FIG. 47). Egress and ingress traffic is broken down by application and network. It shows the volume of traffic received and produced by the server (application ingress and application egress) and, respectively, the same at the network port level.

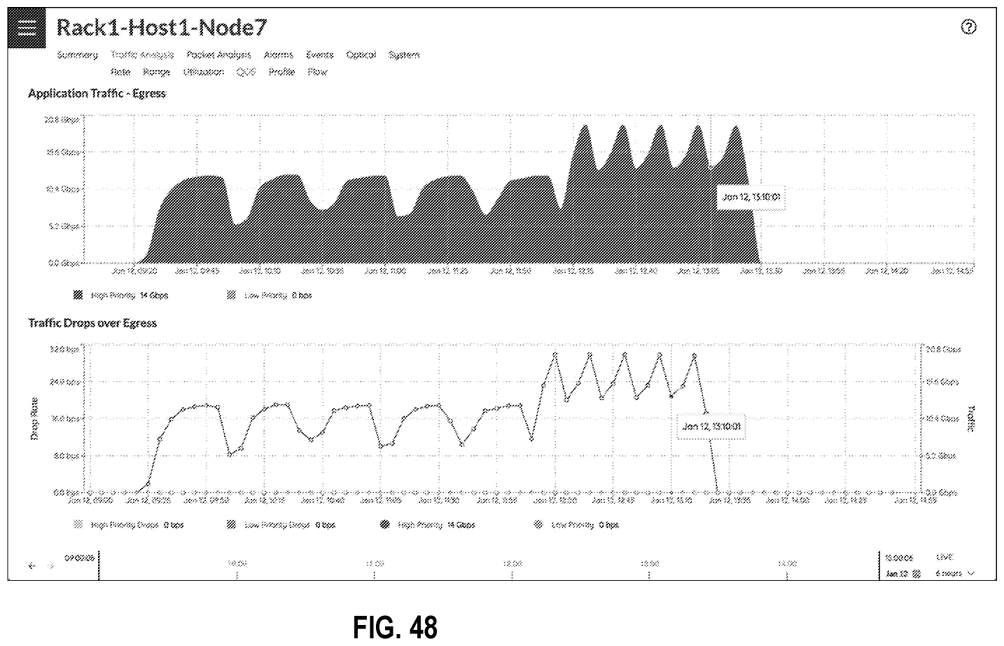

The QOS sub-dashboard visualizes the application egress traffic and its distribution between high priority and low priority traffic (see e.g. FIG. 48).

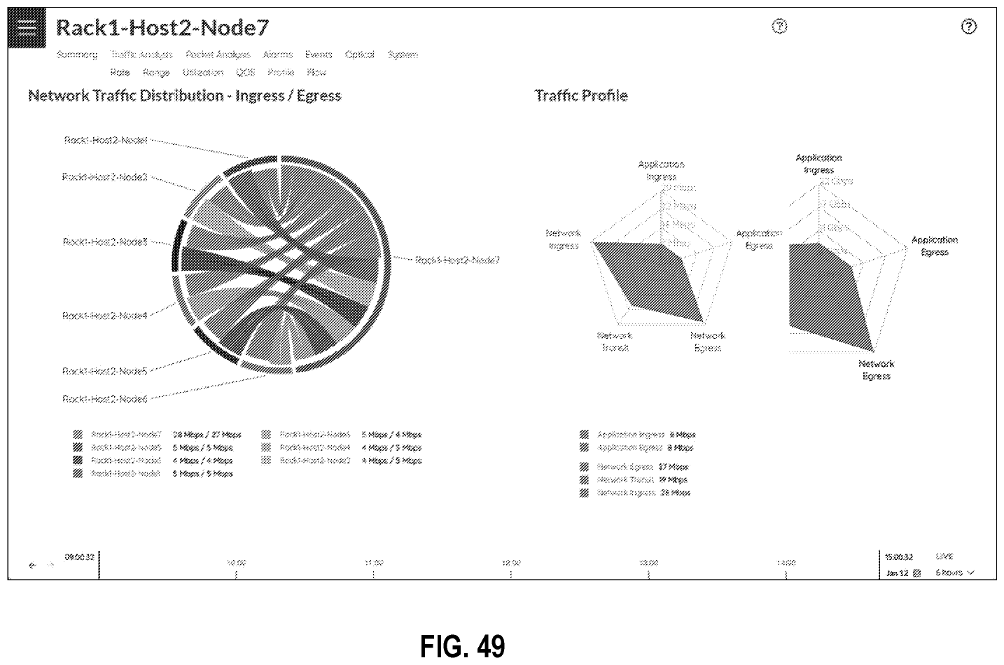

The Profile sub-dashboard visualizes the aggregate distribution of traffic across all network ports and the current traffic profile for the node. The visualizations are based on the average value for the currently viewed time window (see e.g. FIG. 49). The visualization on the left is a chord diagram. The outer ring is broken into segments for each node exchanging data in the network. The size of the node segment is relative to the total egress (outbound) traffic for the given node. The visualization on the right provides a summary aggregation which displays the current traffic profile of the node for the same time window.

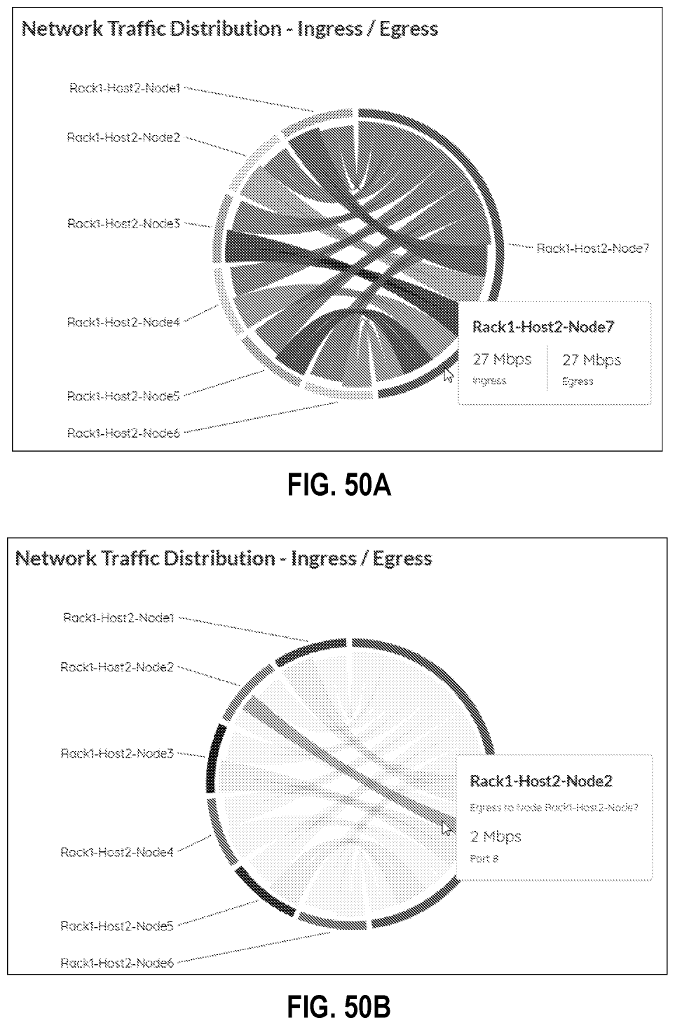

Regarding the chord diagram, the chords (ribbons) for egress traffic are closer to (and the same color as) the node's outer band. The chords for the ingress traffic are farther from the node's outer band and are different colors. An administrator can hover over a chord to see detailed traffic information for the node pair (see e.g. FIG. 50a), or the administrator can hover over a chord line to see detailed traffic information for the node pair (see e.g. FIG. 50b).

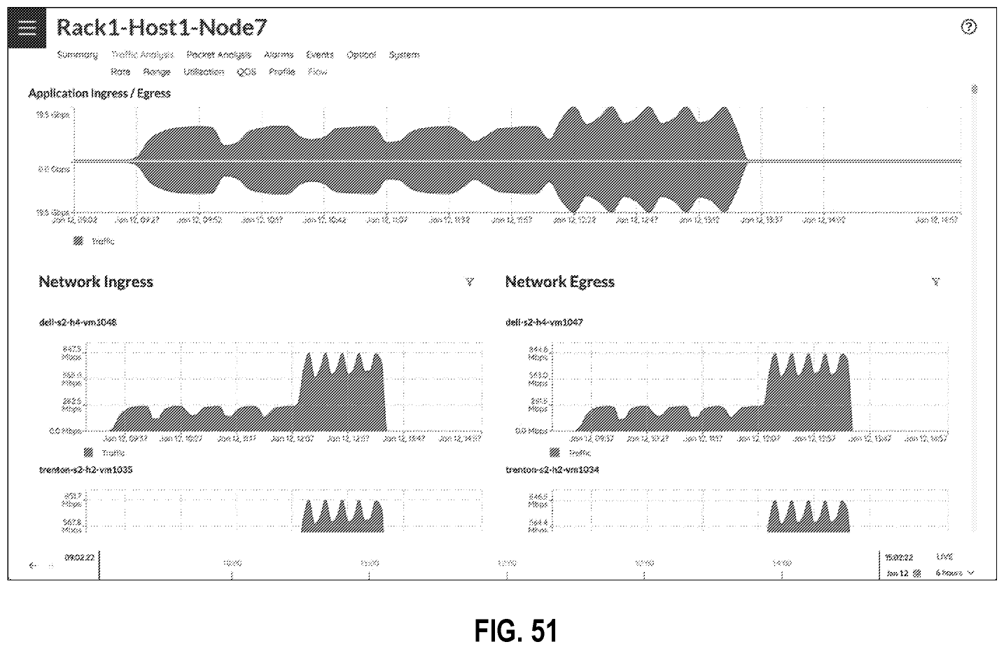

The Flow sub-dashboard visualizes each of the top 100 traffic destinations and sources (those the node is sending to and receiving from) for the currently selected time window (see e.g. FIG. 51).

The Packet Analysis dashboard provides several graphical views of the packet rates for application ingress and egress traffic, including packet counts, drop rates, and packet size. Five Packet Analysis sub-dashboards are preferably provided, including an Application, Network, QOS, Size, and Type dashboard (discussed below).

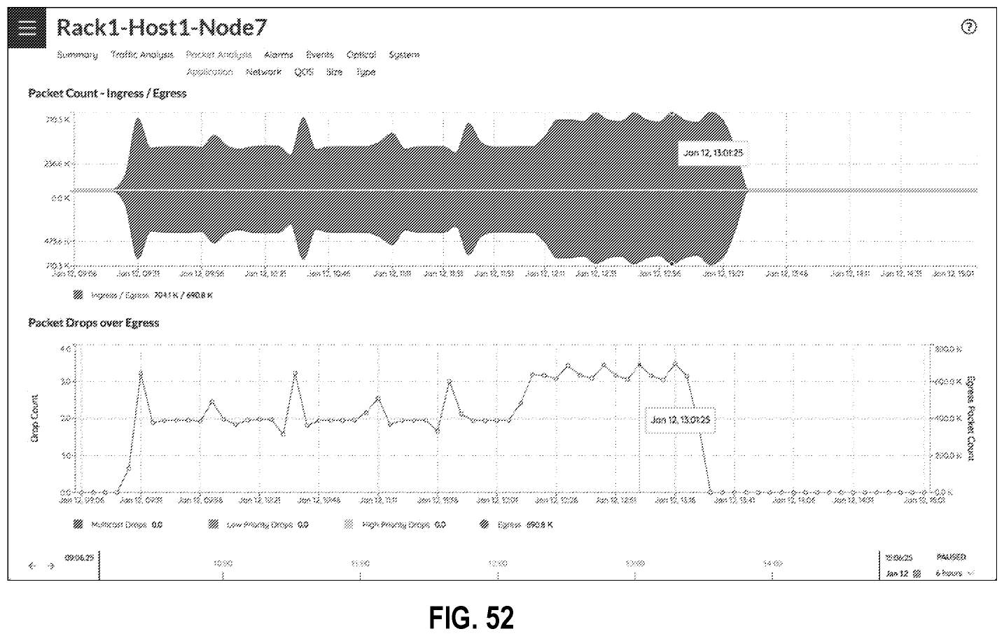

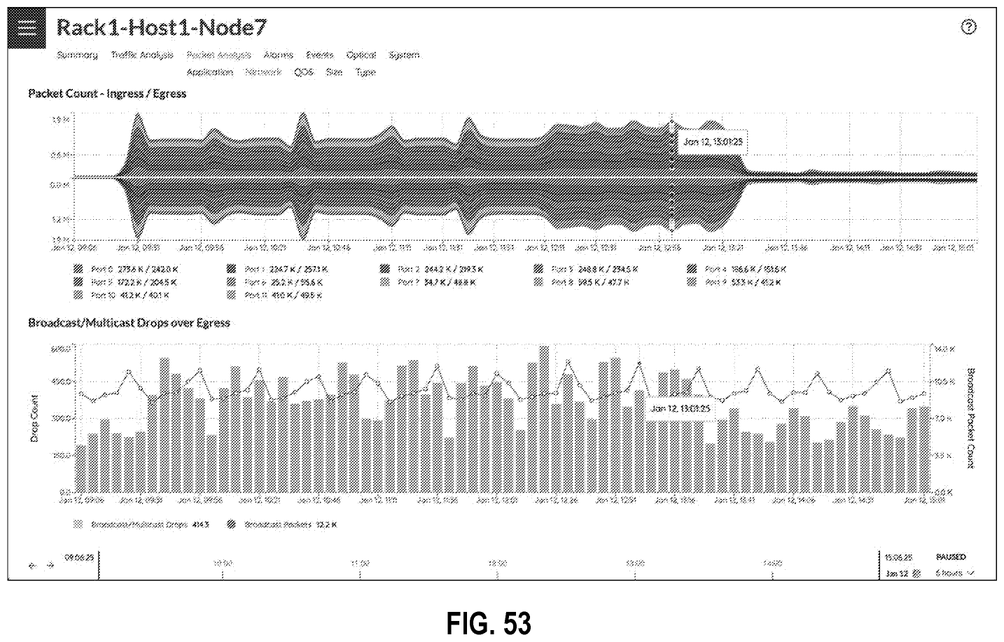

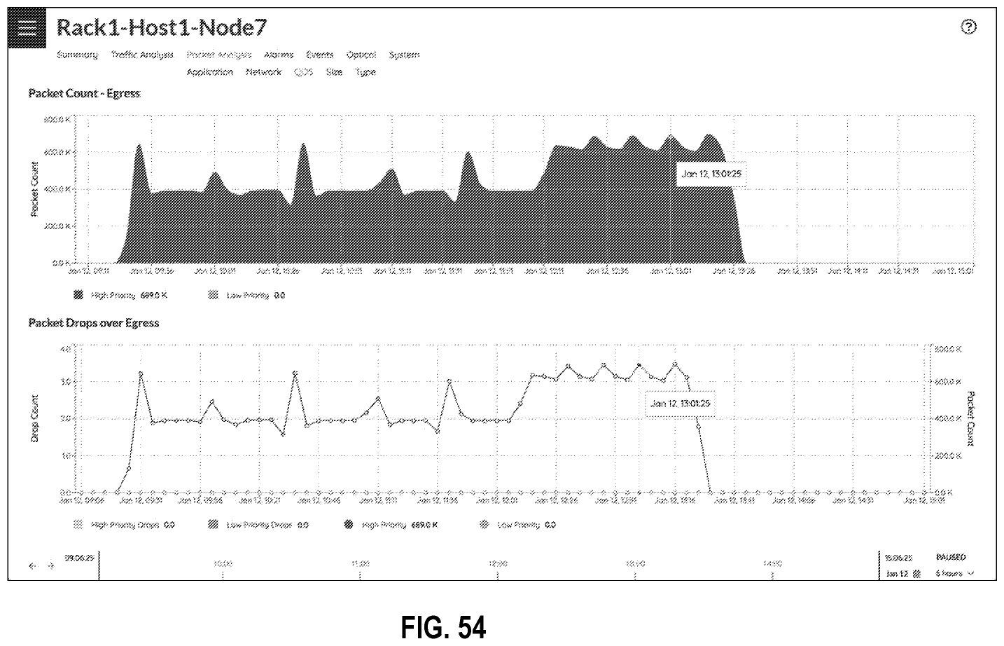

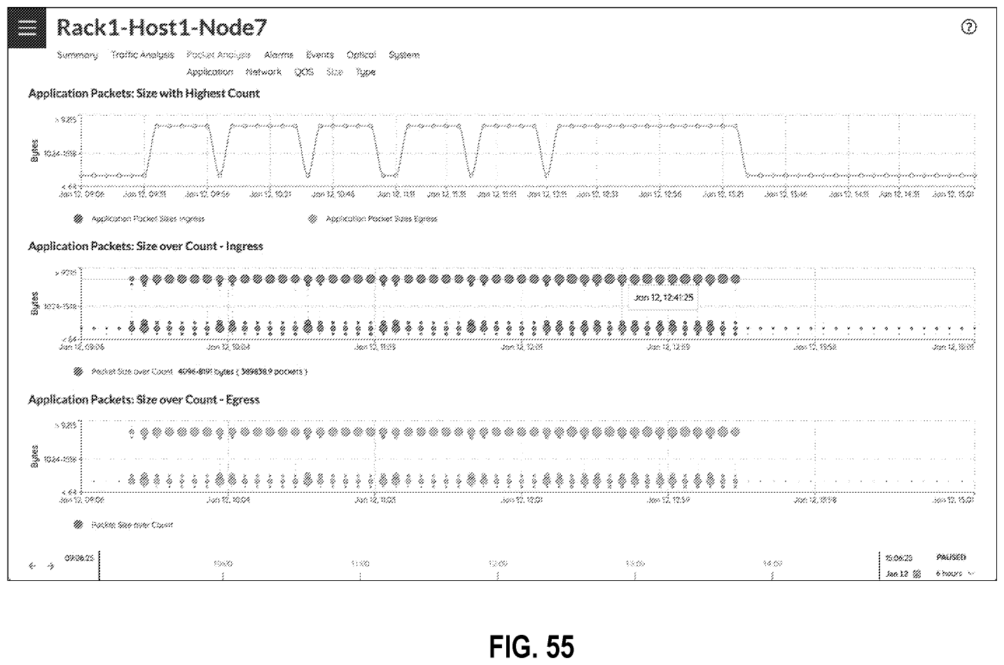

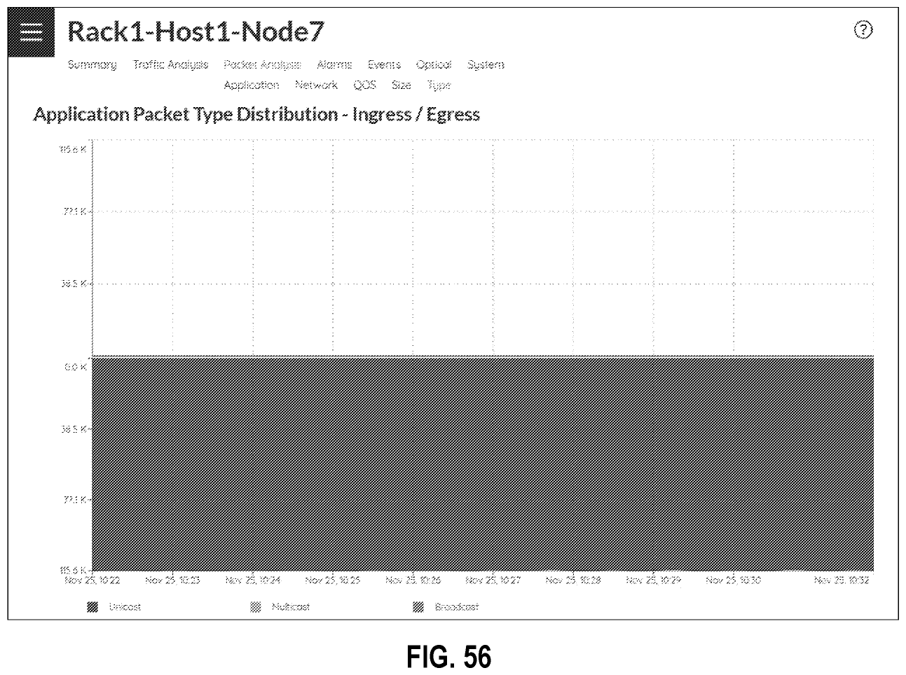

The Application sub-dashboard visualizes the packet rates for egress and ingress application traffic (see e.g. FIG. 52). The Network sub-dashboard visualizes the packet rates for both egress and ingress network traffic (see e.g. FIG. 53). The QOS sub-dashboard visualizes the packet rates for application egress broken down by high and low priority traffic (see e.g. FIG. 54). The Size sub-dashboard visualizes packet size distribution for application egress and ingress traffic (see e.g. FIG. 55). The Type sub-dashboard (see e.g. FIG. 56) visualizes packet type distribution: unicast (a form of network communication where data (Ethernet frames) is transmitted to a single receiver on the network), multicast (a form of network communication where data (Ethernet frames) is transmitted to a group of destination computers simultaneously), and broadcast (a form of network communication where data (Ethernet frames) is transmitted to all receivers on the network).

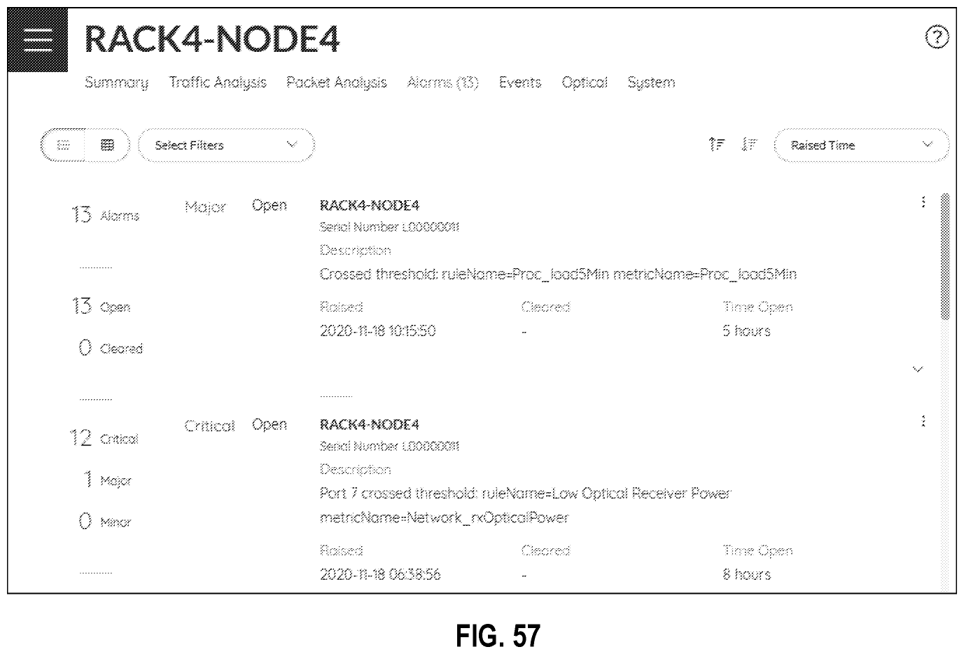

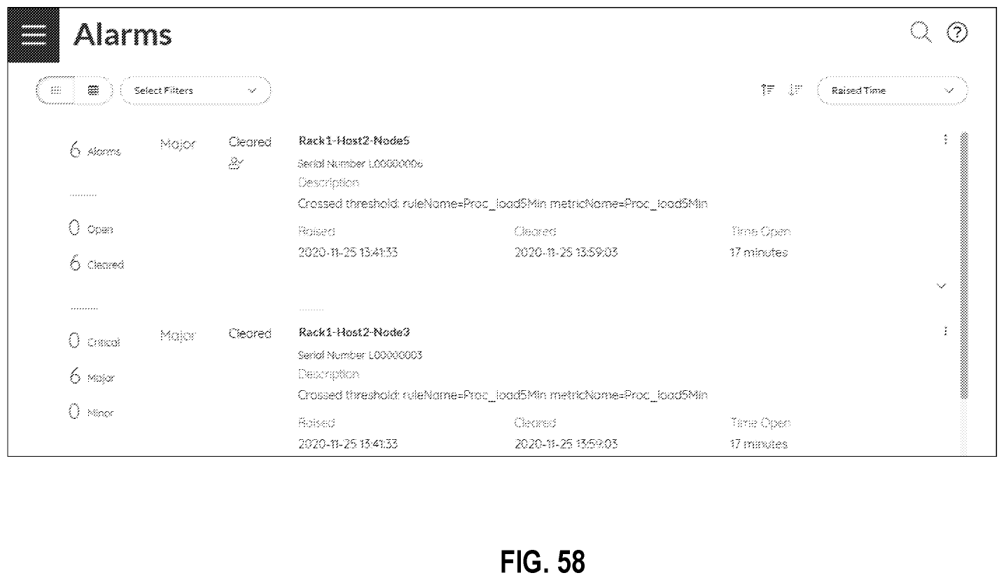

Alarms help an administrator monitor the status of the network and detect issues as they arise. Using alarms, an administrator can recover from network issues more quickly and limit their impact. Alarms are raised when issues arise while monitoring a node, and remain open until a predefined clear condition has been detected. A node-level Alarms dashboard may be viewed to manage individual alarms affecting a single node (see e.g. FIG. 57), while you can use the network-wide Alarms dashboard to review alarms across the entire network (instead of a single node) (see e.g. FIG. 58).

The ANM 1 preferably supports at least two types of alarms: Topology (which includes changes in topology, such as ports or nodes going down, or a loss of communication with a node); and Metric (involving monitoring of network metrics that can result in threshold crossing alerts (TCA)).

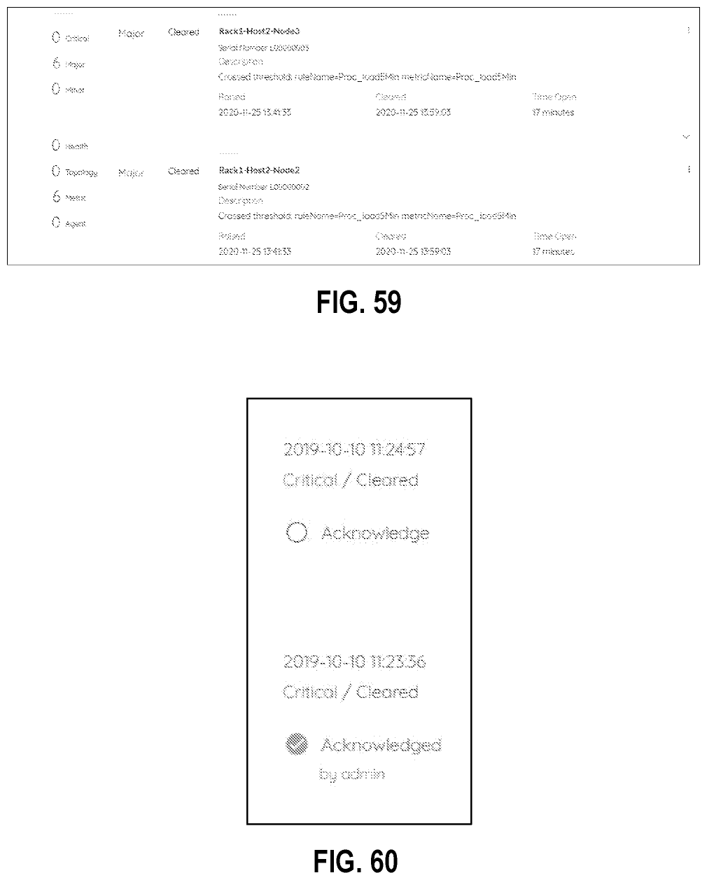

When a topology or metric alarm is triggered, it is listed on the Alarms dashboard. FIG. 59 provides a dashboard example showing two triggered alarms. Each alarm notes the node name, node serial number, alarm time, alarm description, and more. In this example, both nodes have a Major level severity alarm. A Critical and Minor severity category should also preferably be employed.

Alarms can be in one of two states: Open (the alarm has been raised; for example, a port link has been lost, or a monitored threshold (such the network card temperature) has been crossed); and Cleared (the alarm has been cleared; for example, a port link has been re-established or a monitored threshold has been cleared).

Administrators can preferably acknowledge an alarm to let other users know that they are aware of the alarm and are addressing the issue. Alarms have two acknowledgment states: Acknowledged (see e.g. FIG. 60, where the second alarm was acknowledged by an administrator by clicking Acknowledge on the node card menu); and Unacknowledged (see e.g. FIG. 60, where the first alarm is unacknowledged as an administrator has not clicked Acknowledge on the node card menu).

Metric alarms notify you when a monitored setting exceeds a specified threshold value. For example, an administrator can be notified when a node (e.g. the Rockport RO6100 Network Card), its fabric, or optical temperature go past a certain value to notify that they are becoming too hot for proper or safe operation.

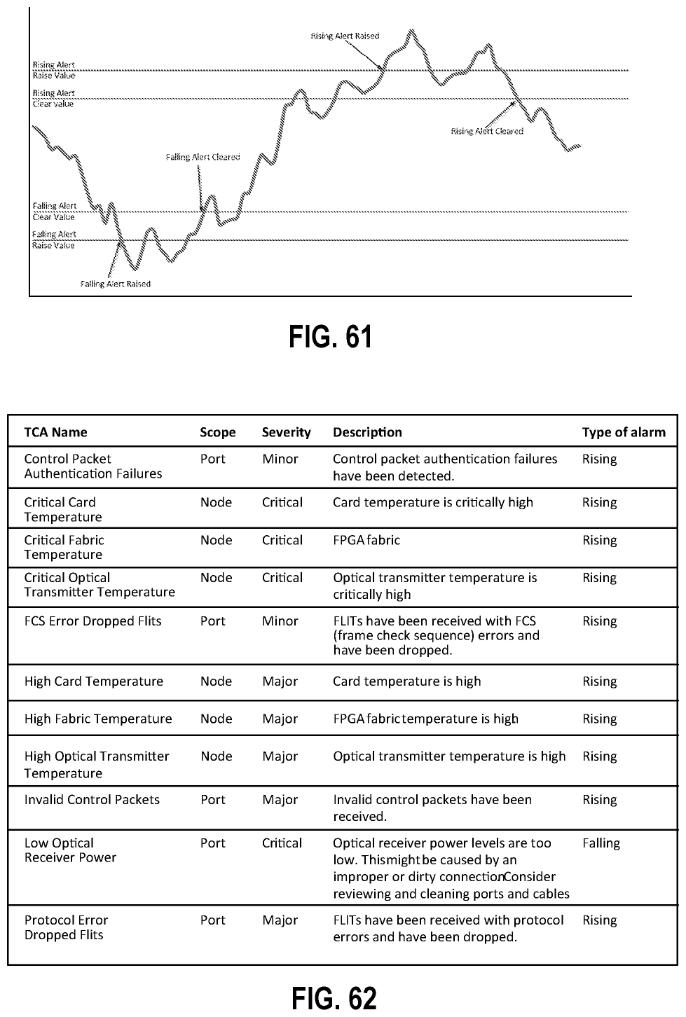

Rising and falling TCAs are preferably supported. Each TCA has a value that raises an alarm and another value that clears it. Rising TCAs open (trigger) alarms when they rise above a specified threshold, and can be cleared when they fall below the same or different threshold. Falling TCAs open (trigger) alarms when they fall below a specified threshold, and can be cleared when they rise above the same or different threshold. FIG. 61 shows a monitored value (green line) and demonstrates the properties of falling and rising TCAs. Notice that the monitored green line falls below the Falling Alert Raise Value threshold (red line). At this point an alarm is opened. It remains open until the monitored green line rises above the Falling Alert Clear Value threshold (blue line). As the green line moves along the timeline, notice that it rises above the Rising Alert Raise Value threshold (red line). At this point an alarm is opened. It remains open until the monitored green line falls below the Rising Alert Clear Value threshold (blue line).

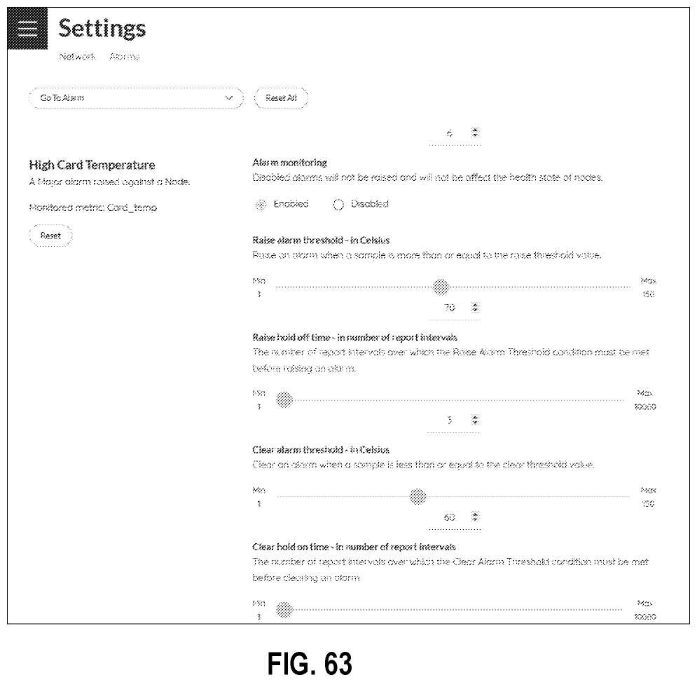

The ANM should preferably include many predefined, customizable metric alarms for nodes and ports (see e.g. FIG. 62). FIG. 63 shows an example of an alarm that an administrator can configure (High Card Temperature) and its settings.

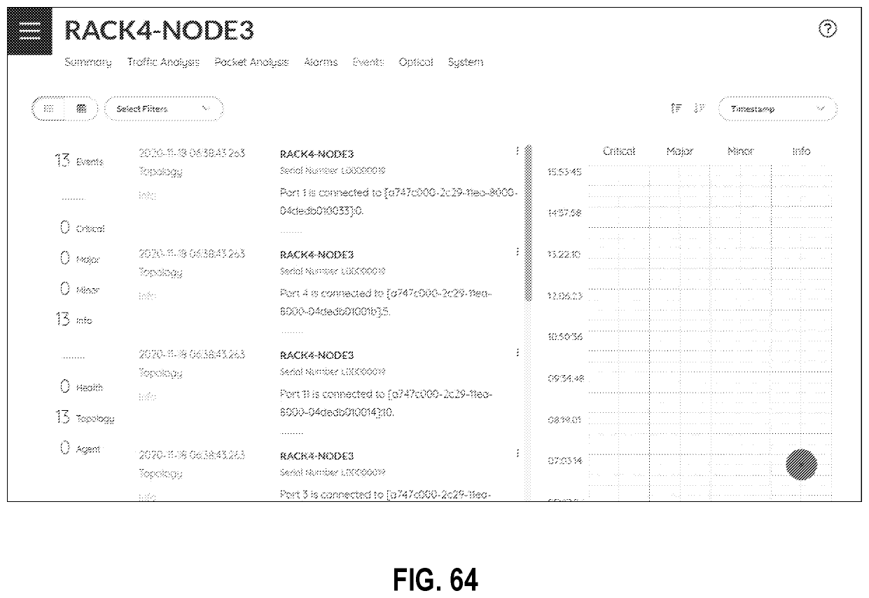

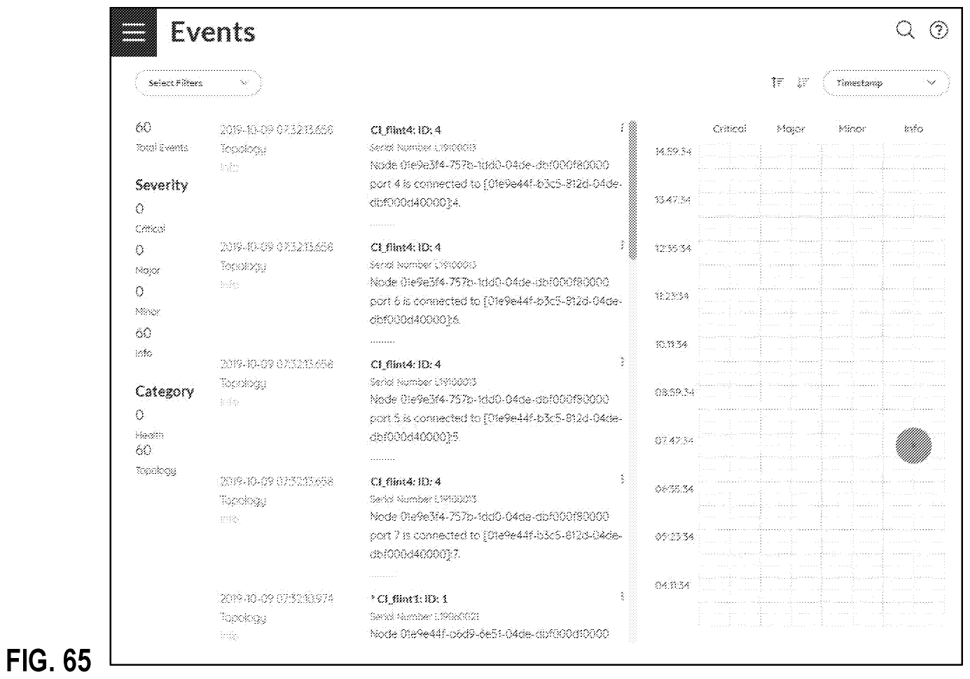

The Events dashboard can be used to provide a summary of events for a selected node (see e.g. FIG. 64) or across the entire network (see e.g. FIG. 65). Events include network and status changes to nodes and ports, and a timeline chart provides visual cues as to when the issues occurred. Events are preferably grouped into at least two categories (Topology (changes in the network topology) and Health (changes in the status of nodes and ports)), and are preferably grouped into four severity levels: Critical (red; examples include a node that is down, losing communication with a node, and node traffic exceeding a system-defined threshold); Major (orange; examples include lost network links, low memory on a node, and communication with a link timing out); Minor (blue; examples include CPU and memory usage spikes, and node name changes); and Info (gray; examples include nodes being added and removed, a node's health status, and configuration changes to a node).

The Events dashboard includes three areas of information (from left to right): Statistics (summarizes the total events along with Severity and Category statistics); Events (lists each event along with its type, node identification, and date and time); and Timeline (lists event markers in a tabular format). Multiple events that occur in the same time bucket are grouped.

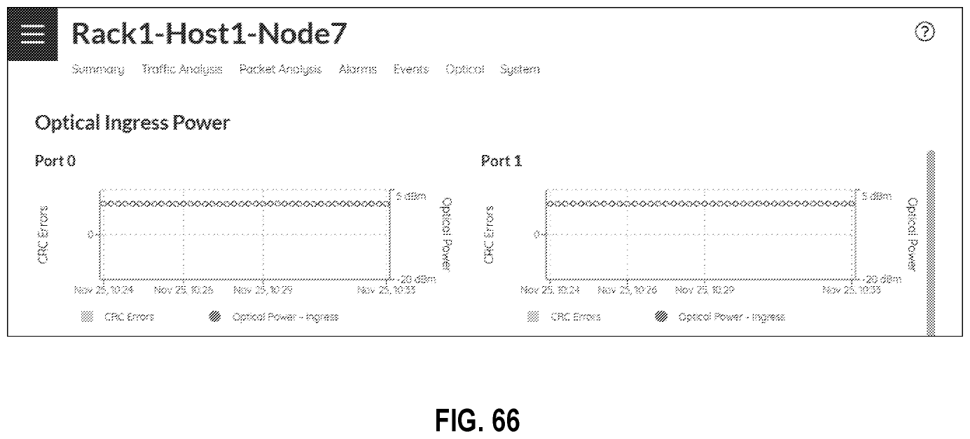

The Optical Dashboard (a sub-dashboard of the Node dashboard) displays power levels detected on received traffic over the current window of time at the port level (see e.g. FIG. 66).

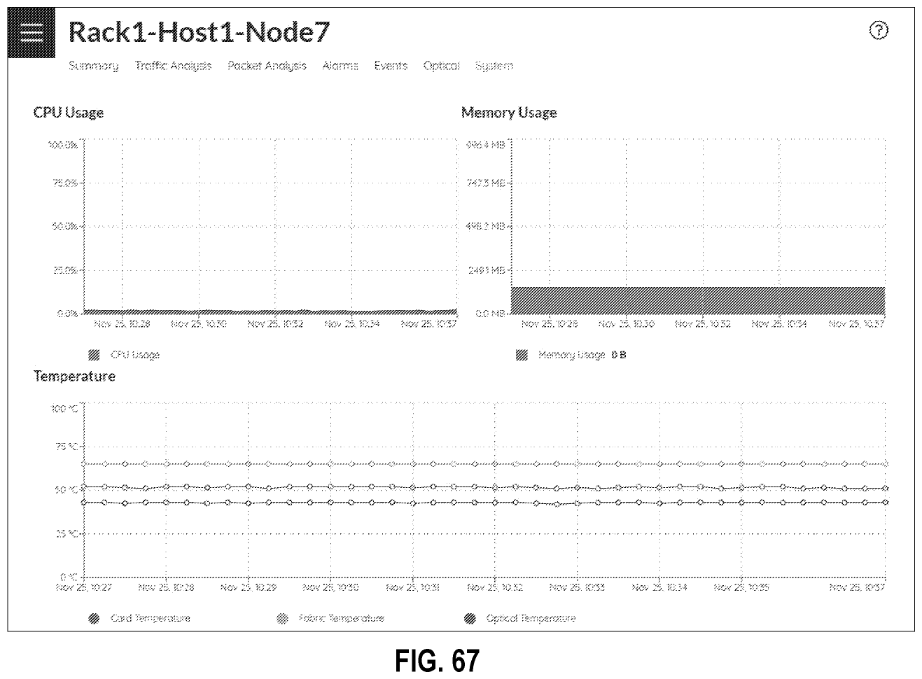

The System dashboard (a sub-dashboard of the Node dashboard) provides charts that summarize the node's CPU usage, memory usage, and card/fabric/optical assembly temperature over time (see e.g. FIG. 67). An alert will be sent if the card, fabric, or optical temperature goes past the configured threshold.

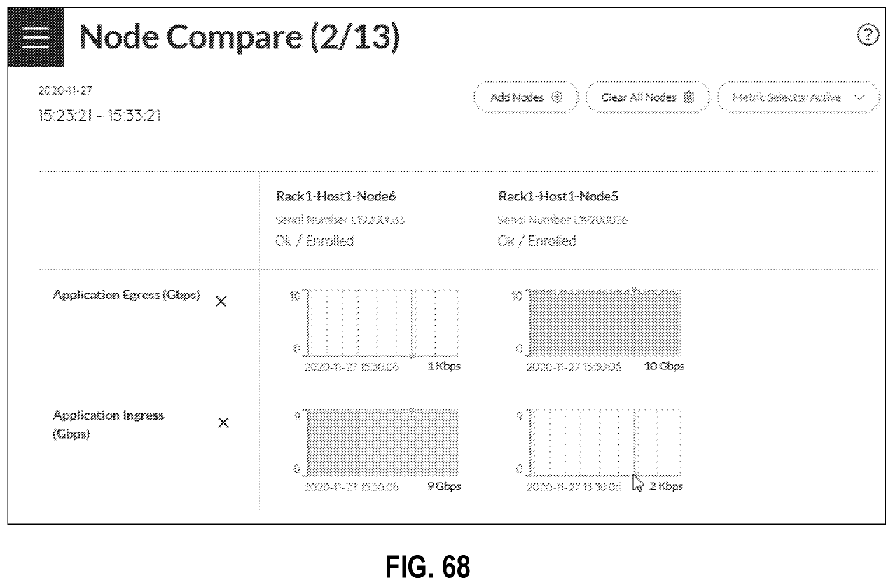

A Node Compare dashboard can be used to compare the recorded metrics from two or more nodes in the network (see e.g. FIG. 68). This can be useful if an administrator has encountered an issue and wants to see the impact to the other nodes in the network. For example, if a node has lost connection, you can see how the flow of traffic was impacted by comparing the traffic statistics with other nearby nodes. This can help an administrator determine when to address the issue. The following comparison metrics, for example, may be available: Application Egress; Application Ingress; Network Ingress; Network Egress; CPU Utilization; Card Temperature; Fabric Temperature; and Optical Temperature.

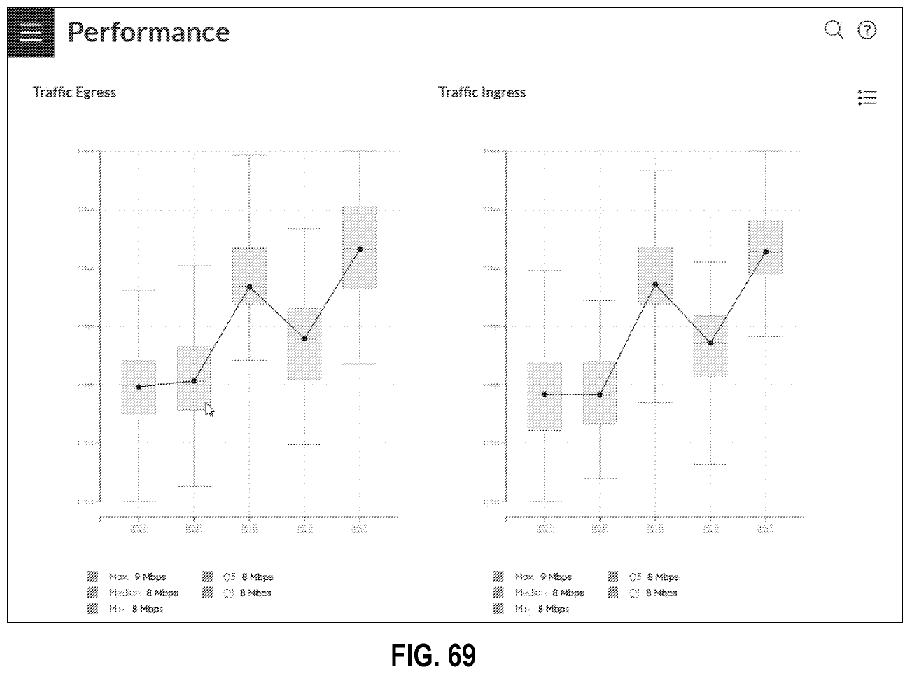

A Performance dashboard can be used to visualizes the flow of application traffic through the network using box plot charts. Traffic is visualized in two ways: egress and ingress (see e.g. FIG. 69). Box plots return five statistics for each time bucket (minimum, maximum, median, first or lower quartile, and third or upper quartile).

### Example Use Case

The following provides an example use case of the quality and value of temporal information conveyed by ANM 1. Rockport Networks Inc. was in the process of installing a cluster of 288 nodes (Rockport RO6100 Network Cards) in a shuffle configuration to implement a direct interconnect network as disclosed in International PCT Application No. PCT/IB2021/000753. ANM was installed as a single deployment, and an air conditioning system was newly installed to keep all hardware within operational environmental parameters.

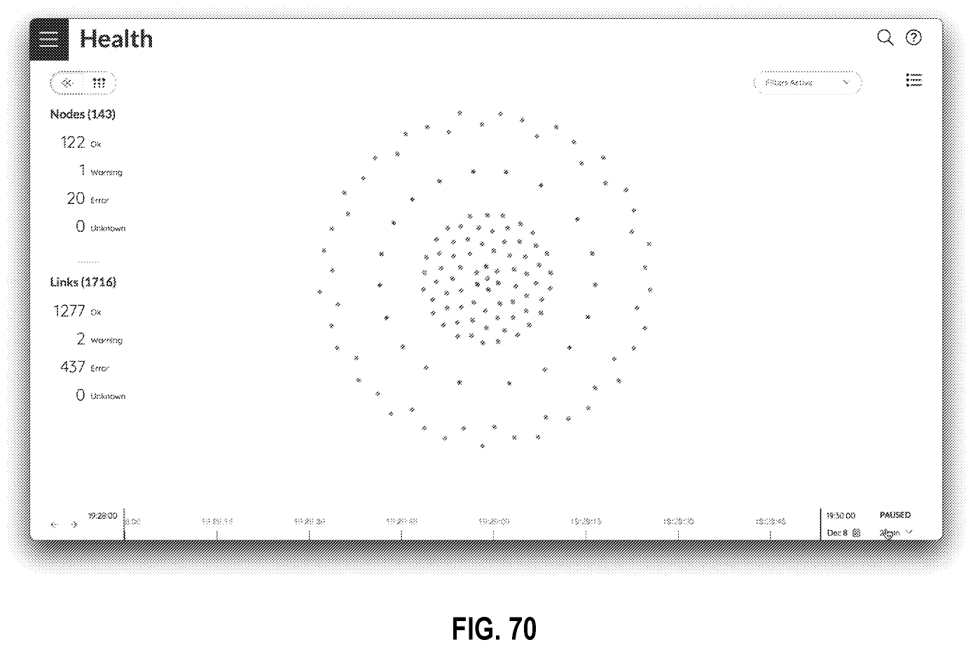

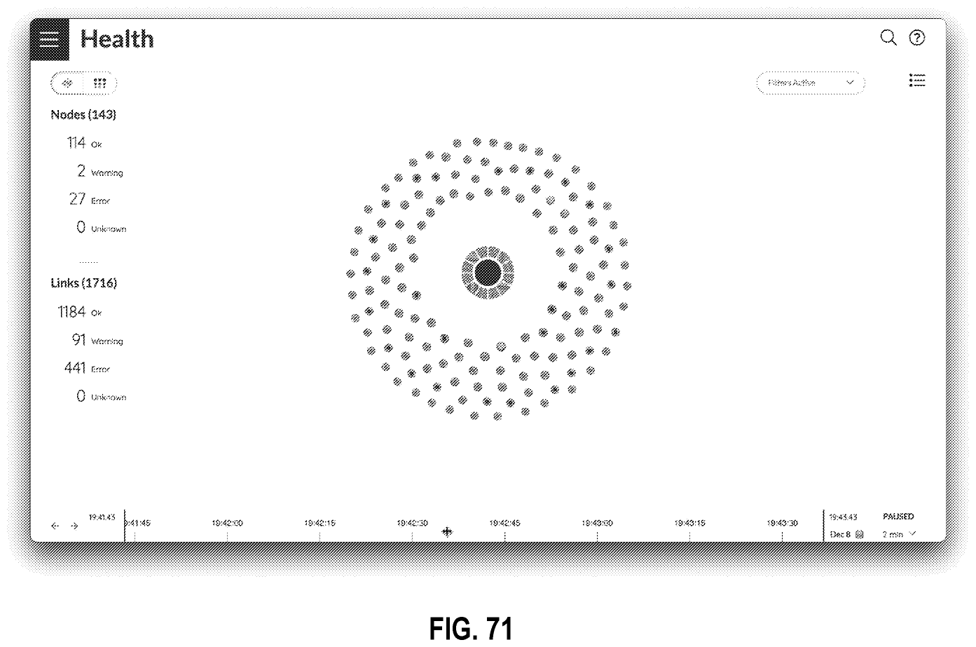

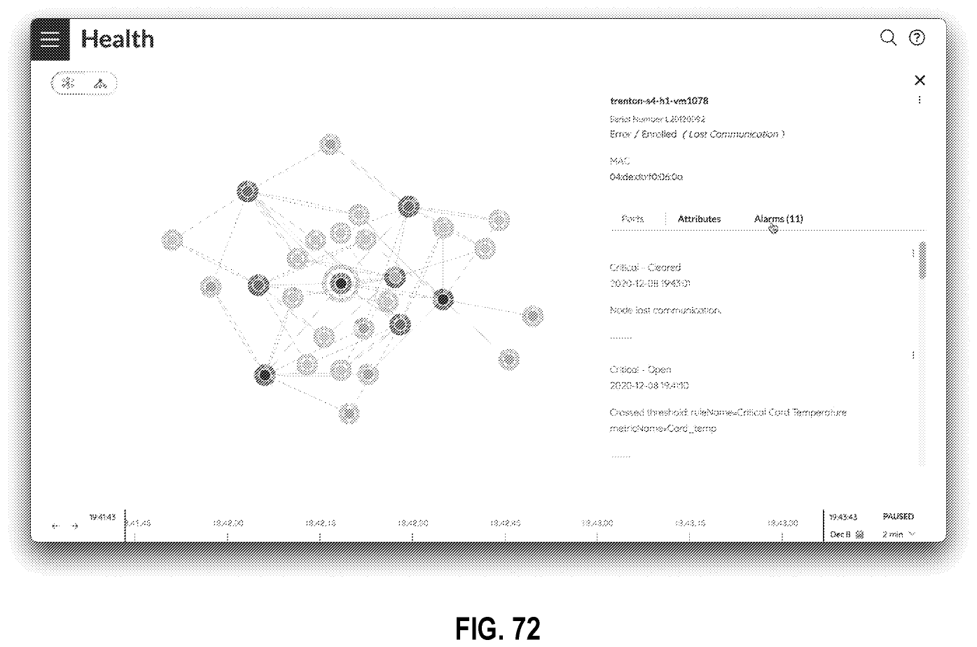

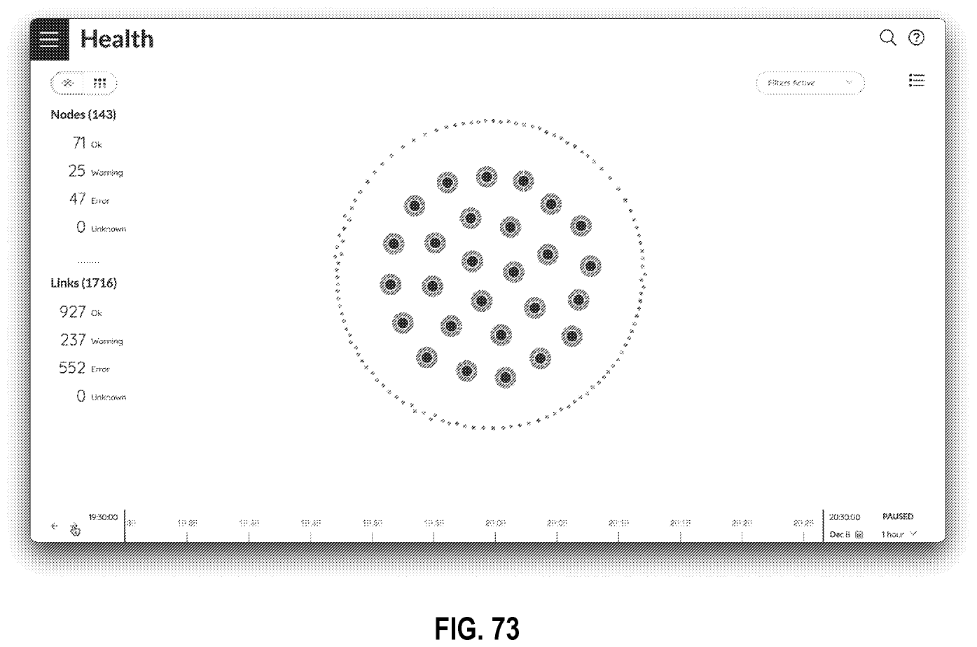

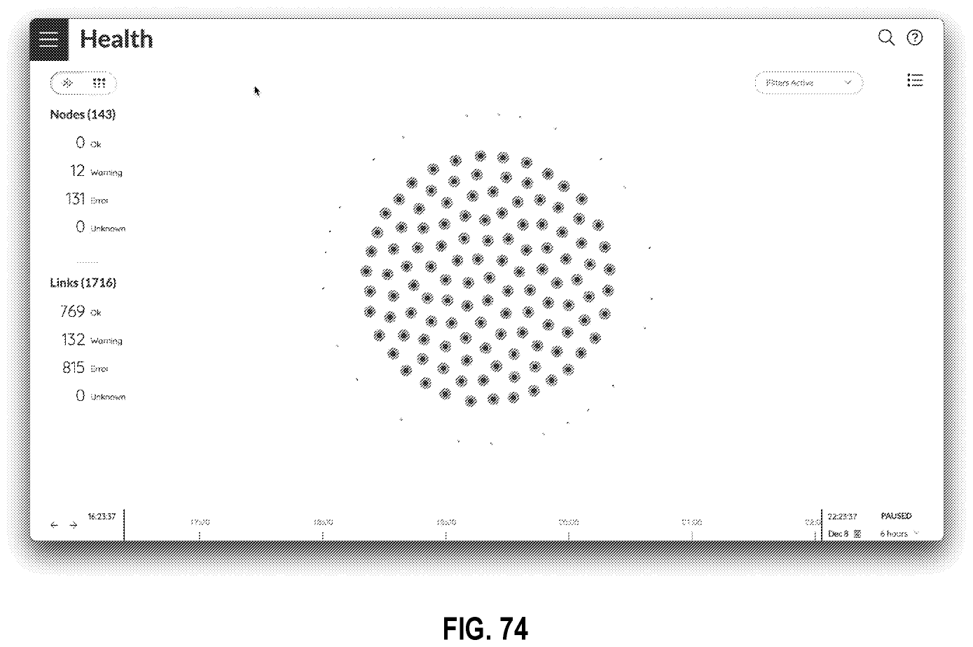

By the end of the workday on Dec. 8, 2020, 143 of the nodes had been installed and enrolled. As of 7:28 p.m., ANM was showing that 122 of the nodes were running without issue, 1 node was in a warning state, and 20 nodes were in an error state relating to minor issues (see FIG. 70). All nodes were otherwise fully operational. However, a first node failed (lost communication) just before 7:42 p.m. (see FIG. 71), and this occurred shortly after a critical card temperature threshold was passed (see FIG. 72). By 8:30 p.m., numerous nodes had lost communication due to cards passing critical temperature thresholds (see FIG. 73), and it was apparent that the data center was experiencing environmental issues, so service personnel were alerted to check on and fix the air conditioning system as needed. By 10:23 p.m., almost the entire network of nodes had failed (see FIG. 74).

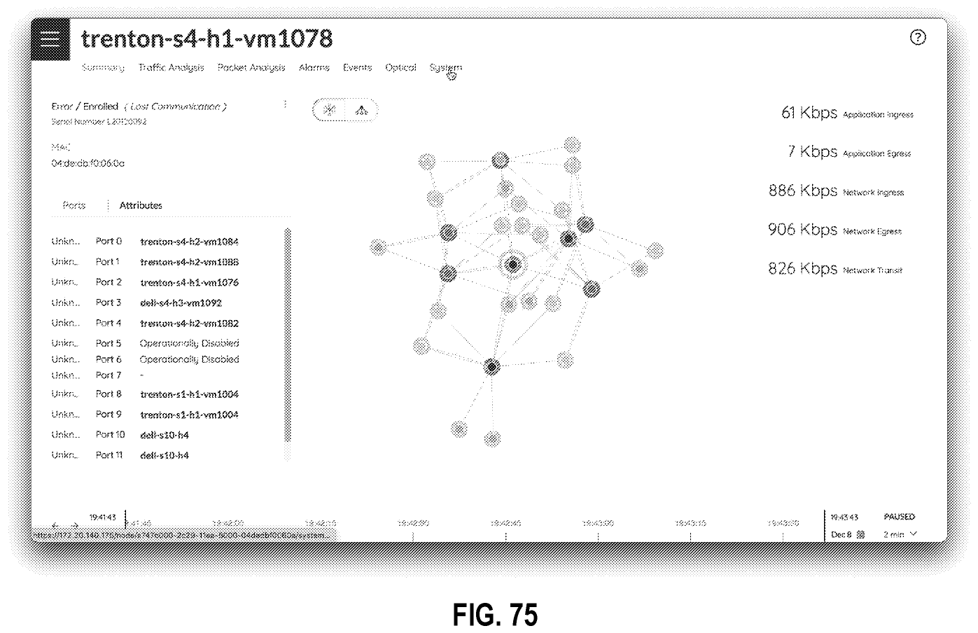

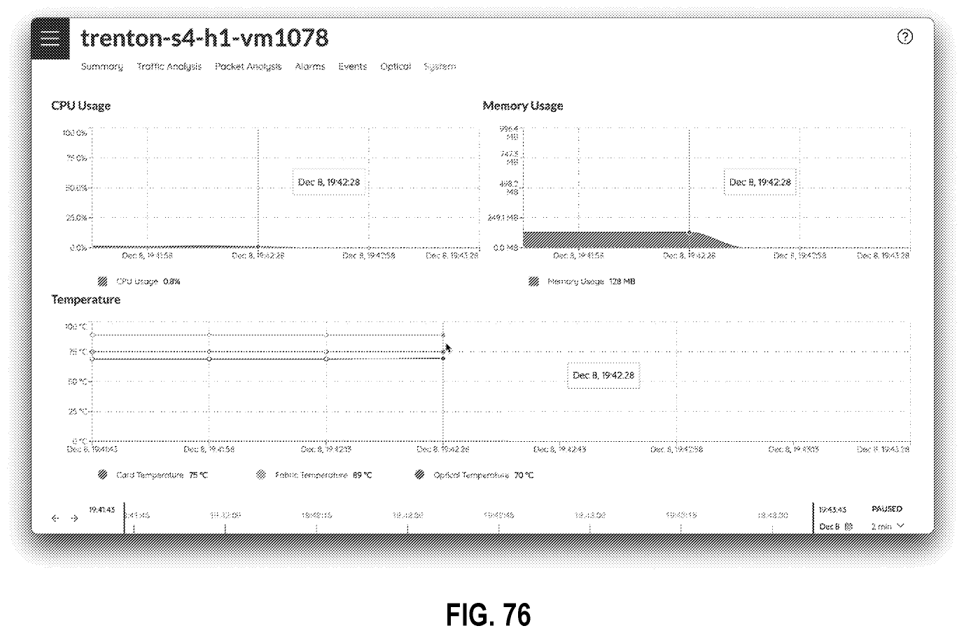

Later, due to the quality of temporal data stored in ANM, the administrator was able to critically analyze how the network of nodes operated during the cooling system failure. In particular, by reviewing information using the timeline, the administrator was able to see which nodes and node ports were affected first and how connected neighbours were affected, how node shutdowns progressed, whether nodes attempted to restart after shutdown, whether the problem was the card, fabric, or optical temperature, etc. (see e.g. FIGS. 75 and 76). Using this information, the administrator could determine hotspots in the physical environment (those server locations most prone to heat from a cooling system failure), and therefore how cool air could perhaps be better circulated when the cooling system is otherwise functional in order to promote node health over time.

We claim:

1. A method for the temporal monitoring and visualization of the health of a direct interconnect network comprising the steps of:
(i) discovering and configuring nodes interconnected in the direct interconnect network;
(ii) determining network topology of the nodes and maintaining and updating a topology database as necessary;
(iii) receiving node telemetry data from each of the nodes or every port on each of the nodes at a time interval and storing said node telemetry data in association with a timestamp in a temporal datastore;
(iv) raising an alarm if applicable against at least one node or at least one port of said at least one node if any such node telemetry data in respect of the at least one node or the at least one port of said at least one node crosses a node metrics threshold or if there is a change to the network topology in respect of the at least one node or the at least one port of said at least one node during the time interval;
(v) assigning an individual health status to each of the nodes or every port on each of the nodes, wherein such health status is commensurate with any alarm raised against the at least one node or the at least one port of said at least one node during the time interval and storing or updating said individual health status for each of the nodes or every port on each of the nodes in association with the timestamp in the temporal datastore;
(vi) displaying on a graphical user interface a visual representation of the health of the direct interconnect network for the time interval, said visual representation including,
a color representation of nodes or every port on such nodes to reflect the health status of such nodes or ports and to convey a health condition to a network administrator, and
wherein such nodes or ports are further scaled in size relative to the health condition to allow for easy identification of nodes that are in a poor health condition and that require attention by the network administrator;
(vii) repeating steps (i) to (vi) for further time intervals, and allowing the network administrator to display the visual representation of the health of the direct interconnect network for any time interval in the temporal database.

2. The method of claim 1 wherein the step of receiving and storing node telemetry data from each of the nodes or every port on each of the nodes further comprises preprocessing and aggregating the node telemetry data, and storing said preprocessed and aggregated node telemetry data in association with the timestamp in the temporal datastore.

3. The method of claim 1 wherein the step of assigning an individual health status to each of the nodes or every port on each of the nodes further comprises calculating a health score for each of the nodes or every port on each of the nodes based on the assigned individual health status for the time interval and storing such health score with the timestamp in the temporal database, and wherein the step of displaying a color representation of nodes or every port on such nodes instead reflects the health score of such nodes or ports.

4. A method for the temporal monitoring and visualization of the health of a direct interconnect network comprising:
discovering and configuring each node in a plurality of nodes interconnected in the direct interconnect network;
determining network topology of the plurality of nodes comprising link information to neighbor nodes for each node in the plurality of nodes;
querying status information of each node in the plurality of nodes at a first time interval, and storing and updating the status information of each node in the plurality of nodes in a database at each first time interval;
receiving node telemetry data from each node or every port on each node in the plurality of nodes at a second time interval, and storing the node telemetry data for each node or every port on each node in a temporal datastore at each second time interval with a timestamp for a retention period, such that the temporal datastore contains a temporal history of node telemetry data from each node or every port on each node during the retention period;
analyzing the node telemetry data received from each node or every port on each node in the plurality of nodes and assigning a health status commensurate with the severity of the node telemetry data as analyzed for each node or every port on each node in the plurality of nodes;
calculating a health score for each node or every port on each node based on the assigned health status for each node or every port on each node in the plurality of nodes;
displaying a visual representation of the health of at least one node or every port on the at least one node in the plurality of nodes on a user interface based on the calculated health score for the at least one node or every port on the at least one node in the plurality of nodes, said visual representation depicting a health state of the at least one node or every port on the at least one node in the plurality of nodes at a specific time during the retention period.

5. The method of claim 4 wherein the link information for each node in the plurality of nodes is maintained and updated in the database such that the database contains only up to date link information, and wherein the link information is also stored with a timestamp in the temporal datastore such that the temporal datastore contains a temporal history of recorded changes to such link information for the retention period.

6. The method of claim 4 wherein the first time interval is user configurable.

7. The method of claim 4 wherein storing and updating the status information in the database at each first time interval comprises updating the database in accordance with any changes to the status information such that the database contains only up to date status information for each node in the plurality of nodes.

8. The method of claim 4 wherein receiving node telemetry data comprises receiving node telemetry data from a message bus.

9. The method of claim 4 wherein the second time interval is user configurable.

10. The method of claim 9 wherein the second time interval is the same as the first time interval.

11. The method of claim 4 wherein node telemetry data received from each node or every port on each node in the plurality of nodes is also pre-processed, aggregated, and stored in the temporal datastore at each second time interval with the timestamp for the retention period.

12. The method of claim 11 wherein the node telemetry data is also published on a message bus so the visual representation can be updated in near real-time.

13. The method of claim 4 wherein analyzing the node telemetry data comprises raising an alarm if the node telemetry data from at least one node or a port on the at least one node in the plurality of nodes crosses a node metrics threshold, there is a node event, or there is a change to the network topology during the second time interval.

14. The method of claim 13 wherein assigning a health status comprises assigning a health status commensurate with the severity of any alarm raised against at least one node or a port on the at least one node during the second time interval, and storing such health status in the temporal database.

15. The method of claim 4 wherein calculating a health score comprises mapping the health status to a numerical value, wherein the larger the numerical value the worse the health of the at least one node or port on the at least one node.

16. The method of claim 4 wherein displaying a visual representation of the health of at least one node or every port on the at least one node in the plurality of nodes on a user interface comprises including a color representation of the at least one node or every port on the at least one node to convey a health condition to a network administrator.

17. The method of claim 16 wherein displaying a visual representation further comprises scaling the at least one node or every port on the at least one node in size relative to the health condition to allow for easy identification of nodes that are in a poor health condition and that require attention by the network administrator.

18. The method of claim 17 wherein displaying a visual representation further comprises including visual links between nodes to represent node connections and the network topology based on the link information to neighbor nodes.

19. A method for examining the current and historical health of a switchless direct interconnect network, the method comprising:
(a) receiving raw node telemetry data at a time interval from each node in a plurality of nodes in the direct interconnect network, wherein the raw node telemetry data is received into a messaging bus;
(b) processing the messaging bus, wherein processing the messaging bus comprises:
(i) accumulating raw node telemetry data into accumulated node telemetry data,
(ii) preprocessing the accumulated node telemetry data into preprocessed node telemetry data,
(iii) aggregating the preprocessed node telemetry data into aggregate node telemetry data, and
(iv) storing the aggregate node telemetry data into a temporal database;
(c) deriving a health status for each node or every port on each node for each time interval, wherein the health status is based at least in part on the stored aggregate node telemetry data;
(d) storing the derived health status for each node or every port on each node for each time interval in the temporal database; and
(e) upon request, providing one or both of the aggregate node telemetry data and the derived health status of a particular node for any time interval in the temporal database.

20. The method of claim 19, further comprising:
(a) prompting a user to select a time interval; and
(b) displaying, on a graphical display, the derived health status for each node at the selected time interval.

21. The method of claim 19, further comprising:
(a) determining whether the health status for each node for each time interval is outside of a metric range; and
(b) in response to determining the health status for a particular node for a particular time interval is outside of the metric range, generating an alarm.

22. A method for examining the current and historical health of a switchless direct interconnect network, the method comprising:
(a) receiving raw node telemetry data at a time interval from each node in a plurality of nodes in the direct interconnect network, wherein each node comprises a plurality of ports, wherein the raw telemetry data includes telemetry data associated with at least one port in the plurality of ports for the associated node, and wherein the raw node telemetry data is received into a messaging bus;
(b) processing the messaging bus, wherein processing the messaging bus comprises:
(i) accumulating related raw node telemetry data into accumulated node telemetry data,
(ii) removing the accumulated node telemetry data from the messaging bus,
(iii) aggregating the accumulated node telemetry data into aggregate node telemetry data, and
(iv) storing the aggregate node telemetry data into a temporal database;
(c) deriving a health status for each port on each of the nodes for each time interval, wherein the health status is based at least in part on the stored aggregate node telemetry data;
(d) storing the derived health status for each port of each node for each time interval in the temporal database; and
(e) upon request, providing one or both of the aggregate node telemetry data and the derived health status of a particular node for any time interval in the temporal database.

23. The method of claim 22, further comprising:
(a) selecting a time interval; and
(b) displaying, on a graphical display, the derived health status for each port of each node for the selected time interval.

24. The method of claim 22, further comprising:
(a) determining whether the health status for each port of each node for each time interval is outside of a metric range; and
(b) in response to determining the health status for a particular port of a particular node for a particular time interval is outside of the metric range, generating an alarm.

25. A method for examining the current and historical health of a switchless direct interconnect network, the method comprising:
(a) receiving raw node telemetry data at a time interval from each node in a plurality of nodes in a direct interconnect network, wherein the raw node telemetry data is received into a messaging bus;
(b) processing the messaging bus, wherein processing the messaging bus comprises:
(i) accumulating raw node telemetry data into accumulated node telemetry data,
(ii) storing the accumulated raw node telemetry data in a temporal database;
(iii) aggregating the accumulated node telemetry data into aggregate node telemetry data,
(iv) storing the aggregate node telemetry data in the temporal database, and
(v) publishing the aggregate node telemetry data on the messaging bus;
(c) deriving a health status for each node for each time interval, wherein the health status is based at least in part on the aggregate node telemetry data stored in the temporal database or the aggregate node telemetry data published on the messaging bus;
(d) storing the derived health status for each node for each time interval in the temporal database; and
(e) displaying, on a graphical display, the derived health status for each port of each node for a selected time interval.

26. A system for examining the current and historical health of a switchless direct interconnect network, the system comprising:
(a) a direct interconnect network, wherein the switchless direct interconnect network is comprised of a plurality of nodes;
(b) a message bus, wherein the message bus is configured to receive raw node telemetry data from each of the plurality of nodes at a time interval;
(c) a temporal database; and
(d) a network manager, wherein the network manager is configured to:
(i) process the message bus and convert raw node telemetry data into aggregate node telemetry data and store the aggregate node telemetry data in the temporal database,
(ii) derive a health status for each node for each time interval and store the health status in the temporal database, wherein the health status is based at least in part on aggregate node telemetry data, and
(iii) upon request, provide the health status of a particular node for any time interval in the temporal database.

27. The system of claim 26, further comprising a user interface, wherein the user interface is configured to convey a visual representation of the health status of a particular node for any time interval in the temporal database.
